(19) United States
(12) Patent Application Publication
(10) Pub. No.: US 2024/0009067 A1
(43) Pub. Date: Jan. 11, 2024

(54) COMPRESSION APPARATUS AND SYSTEMS FOR CIRCULATORY-RELATED DISORDERS

(71) Applicant: Inova Labs, Inc., San Diego, CA (US)

(72) Inventors: Dinesh Ramanan, Sydney (AU); Blythe Guy Rees-Jones, Papamoa (NZ); Tzu-Chin Yu, Sydney (AU); Matthew John Backler, Tauranga (NZ); Francis Eric Saunders, San Diego, CA (US)

(21) Appl. No.: 17/919,151

(22) PCT Filed: Apr. 15, 2021
(86) PCT No.: PCT/US2021/027569

§ 371 Date: Oct. 14, 2022

Related U.S. Application Data
(63) Continuation-in-part of application No. 16/849,932, filed on Apr. 15, 2020.

(51) Int. Cl. A61H 9/00

(52) U.S. Cl. CPC A61H 9/0092; A61H 2209/00; A61H 2201/5097; A61H 2201/5056; A61H 2201/1409; A61H 2201/1238; A61H 2205/06; A61H 2205/10; A61H 2205/12; A61H 2201/165

(57) ABSTRACT

A compression garment for circulatory-related disorder therapy includes a skin contacting layer, a second layer coupled to the skin contacting layer, and connectors disposed on the second layer. The skin contacting layer and the second layer form one or more macro-chambers. Each macro-chamber is partitioned into a plurality of micro-chambers. Each of the micro-chambers is in direct fluid communication with at least one other of the micro-chambers. Each of the connectors is configured to supply pressurized air directly into at least a corresponding one of the macro-chambers such that the pressurized air is delivered to at least one of the micro-chambers within the macro-chamber. The coupling of the skin contacting layer and the second layer is along a layer attachment profile that defines the macro-chambers and the micro-chambers. At least one of the micro-chambers is linked to another of the micro-chambers by way of a plurality of openings.

### 1. CROSS-REFERENCE TO RELATED APPLICATIONS

This application is a continuation-in-part of U.S. application Ser. No. 16/849,932, filed on Apr. 15, 2020, the disclosure of which is hereby incorporated by reference herein in its entirety.

### 2. FIELD OF THE PRESENT DISCLOSURE

The present technology relates to devices for the diagnosis, treatment and/or amelioration of circulatory-related disorders, such as a disorder of the lymphatic system. In particular, the present technology relates to medical devices, and their components, such as for Lymphedema therapy or monitoring. Such technology may relate to components, for example, control apparatus, systems, and devices, for compression therapy such as for monitoring and/or treating the condition of a circulatory-related disorder.

### 3. BACKGROUND

The lymphatic system is crucial to keeping a body healthy. The system circulates lymph fluid throughout the body. This circulation collects bacteria, viruses, and waste products. The lymphatic system carries this fluid and the collected undesirable substances through the lymph vessels, to the lymph nodes. These wastes are then filtered out by lymphocytes existing in the lymph nodes. The filtered waste is then excreted from the body.

Lymphedema concerns swelling that may occur in the extremities, in particular, any of the arms, legs, feet, etc. The swelling of one or more limbs can result in significant physical and psychological morbidity. Lymphedema is typically caused by damage to, or removal of, lymph nodes such as in relation to a cancer therapy. The condition may result from a blockage in the lymphatic system, a part of the immune system. The blockage prevents lymph fluid from draining. Lymph fluid build-up leads to the swelling of the related extremity.

Thus, Lymphedema occurs when lymph vessels are unable to adequately drain lymph fluid, typically from an arm or leg. Lymphedema can be characterized as either primary or secondary. When it occurs independently from other conditions it is considered primary Lymphedema. Primary Lymphedema is thought to result from congenital malformation. When it is caused by another disease or condition, it is considered secondary Lymphedema. Secondary Lymphedema is more common than primary Lymphedema and typically results from damage to lymphatic vessels and/or lymph nodes.

Lymphedema is a chronic and incurable disease. If untreated, Lymphedema leads to serious and permanent consequences that are costly to treat. Many of the high-cost health consequences from Lymphedema might be prevented by early detection and access to appropriate remedial services. As there is no presently known cure for lymphedema, improvement in treating this and other circulatory-related conditions, such as, for example, deep vein thrombosis, chronic venous insufficiency, and restless leg syndrome, is desired. The present disclosure is directed to solving these and other problems.

### 4. SUMMARY OF THE PRESENT DISCLOSURE

The present disclosure is directed towards providing medical devices, or the components thereof, for use in the management, monitoring, detection, diagnosis, amelioration, treatment, and/or prevention of circulatory-related conditions having one or more of improved comfort, cost, efficacy, ease of use and manufacturability.

According to some implementations of the present disclosure, a smart, connected platform and/or system for compression therapy for treating circulatory disorders such as lymphedema, is provided. The system includes a compression garment with multiple pneumatic chambers, a valve interface, a pneumatic/electrical conduit, a compression device, a control device running a patient app, and a remote clinician portal. According to some implementations of the present disclosure, the chambers in the compression garment can be dynamically pressurised to compress a limb of interest (e.g., leg, arm, torso, foot, ankle, etc. or any combination thereof) in controlled therapeutic patterns over a therapy session. According to some implementations of the present disclosure, the chambers are high-resolution partitions and/or micro-chambers of a conventional chamber. According to some implementations of the present disclosure, the micro-chambers are interconnected by one or more channels, gaps, and/or openings that define one or more predetermined sequence(s) of air pressurization. When a chamber is pressurised, the micro-chambers of that chamber pressurise in the predetermined sequence(s) so as to create a micro-massage effect on the user wearing the compression garment of the system. The micro-massage can aid in stretching the skin of the user in a way that simulates natural movement of the limb and thereby assists drainage. According to some implementations of the present disclosure, sensors may be used (e.g., imbedded in the compression garment) to determine patient characteristics, such as limb girth, during a testing period and set up therapy mode and parameters before therapy (personalization or customization). According to some implementations of the present disclosure, sensors can be used in a control loop during therapy to dynamically adjust therapy parameters. According to some implementations of the present disclosure, therapy can be controlled and/or monitored using a patient application executing on a control device of the system. According to some implementations of the present disclosure, therapy data from multiple patients can be communicated to a clinician portal for population management.

According to some implementations of the present disclosure, a compression garment for circulatory-related disorder therapy includes a skin contacting layer, a second layer coupled to the skin contacting layer, and one or more connectors disposed on the second layer. The skin contacting layer and the second layer form one or more macro-chambers. Each macro-chamber is partitioned into a plurality of micro-chambers. Each of the plurality of micro-chambers is in direct fluid communication with at least one other of the plurality of micro-chambers. Each of the one or more connectors is configured to supply pressurized air directly into at least a corresponding one of the one or more macro-chambers such that the pressurized air is delivered to at least one of the plurality of micro-chambers within the macro chamber. The coupling of the skin contacting layer and the second layer is along a layer attachment profile that defines the one or more macro-chambers and the plurality of micro-chambers. At least one of the plurality of micro-chambers is linked to another of the plurality of micro-chambers by way of a plurality of openings.

According to some implementations of the present disclosure, a method of fabricating a compression garment for circulatory-related disorder therapy includes forming a fabric first layer having a first geometric shape generally defining at least a portion of the overall shape of the compression garment. A skin contacting layer is formed having a second geometric shape generally conformable to the first geometric shape. The skin contacting layer is welded to the fabric first layer according to a connection profile. The connection profile defines a plurality of macro-chambers between the skin contacting layer and the fabric first layer and a plurality of interconnected micro-chambers within one or more of the plurality of macro-chambers. A plurality of connectors is disposed in the fabric first layer. Each of the plurality of connectors allows pressurized air to be supplied directly into one or more micro-chambers of a respective one of the plurality of macro-chambers.

According to some implementations of the present disclosure, a valve arrangement includes a plurality of valves for a compression garment having a plurality of independent air chambers connectable to a pressure generator for implementing circulatory-related disorder therapy. The plurality of valves is configured to be pneumatically and electrically connected to the compression pressure generator. Each valve is connectable to one of the plurality of independent air chambers and is in a fluid connection with a primary connecting line to allow pressurization of each of the plurality of independent air chambers. Each of the plurality of valves are located on the compression garment.

According to some implementations of the present disclosure, a pneumatic spine for a compression garment includes the above valve arrangement implementation. The compression garment includes a plurality of independent air chambers connectable to a pressure generator for implementing circulatory-related disorder therapy. The plurality of valves of the valve arrangement are located in proximity to each other. A cover assembly with an interior space includes the plurality of valves.

According to some implementations of the present disclosure, a compression garment includes the above valve arrangement implementations.

The subject headings used in the detailed description are included only for the ease of reference of the reader and should not be used to limit the subject matter found throughout the disclosure or the claims. The subject headings should not be used in construing the scope of the claims or the claim limitations.

Various aspects of the described example embodiments may be combined with aspects of certain other example embodiments to realize yet further embodiments. It is to be understood that one or more features of any one example may be combinable with one or more features of the other examples. In addition, any single feature or combination of features in any example or examples may constitute patentable subject matter.

Other features of the technology will be apparent from consideration of the information contained in the following detailed description.

### 5. BRIEF DESCRIPTION OF THE DRAWINGS

The present technology is illustrated by way of example, and not by way of limitation, in the figures of the accompanying drawings, in which like reference numerals refer to similar elements including:

FIG. 1 is a perspective view of a compression therapy system for a compression therapy and/or circulatory-related disorder monitoring including a compression pressure generator (CPG device) with a link to a compression garment and/or an optional control device, according to some implementations of the present disclosure.

FIG. 2 is a block diagram of a compression therapy system including the components of the system of FIG. 1, according to some implementations of the present disclosure.

FIG. 3 is a front view of a compression pressure generator (CPG) device suitable for use in a compression therapy system, according to some implementations of the present disclosure.

FIG. 4 is a flow chart of a pneumatic circuit of the CPG device of FIG. 3.

FIG. 5 is a schematic diagram of some electrical components of the CPG device of FIG. 3.

FIG. 6 is a schematic diagram of an interface for control valves for a compression garment, according to some implementations of the present disclosure.

FIG. 7 illustrates a compression garment with a set of controllable compression chambers and pneumatic lines, according to some implementations of the present disclosure.

FIG. 8A is a perspective view of a compression garment with pockets holding valve interfaces for controllable compression chambers, according to some implementations of the present disclosure.

FIG. 8B is a partial perspective view of a compression garment with clips for holding a valve interface for controllable compression chambers, according to some implementations of the present disclosure.

FIG. 9A is a partial perspective view of an interface-garment attachment mechanism, according to some implementations of the present disclosure.

FIG. 9B is a partial perspective view of an interface-garment attachment mechanism, according to some implementations of the present disclosure.

FIG. 10A is partial perspective view of an interface caddy with clips, according to some implementations of the present disclosure.

FIG. 10B is partial perspective view of a bundle sleeve, according to some implementations of the present disclosure.

FIG. 11A is a partial perspective view of an interface with an anatomical housing, according to some implementations of the present disclosure.

FIG. 11B is a partial perspective view of valves of the interface of FIG. 11A, according to some implementations of the present disclosure.

FIG. 12A is a partial perspective view of an arm compression garment for a compression therapy system, according to some implementations of the present disclosure.

FIG. 12B is a partial perspective view of an arm compression garment for a compression therapy system, according to some implementations of the present disclosure.

FIG. 12C is a plan view of a ring configuration of chambers, according to some implementations of the present disclosure.

FIG. 12D is a partial perspective view of chambers with passive valves, according to some implementations of the present disclosure.

FIG. 12E is a perspective view of a compression garment with distributed valves, according to some implementations of the present disclosure.

FIG. 13A is a perspective view of an arm compression garment system, according to some implementations of the present disclosure.

FIG. 13B is a plan view of a ring configuration of chambers, according to some implementations of the present disclosure.

FIG. 13C is a plan view of a ring configuration of chambers, according to some implementations of the present disclosure.

FIG. 13D is a plan view of a ring configuration of chambers, according to some implementations of the present disclosure.

FIG. 14 is a perspective view of an arm compression garment prior to being fully assembled (e.g., unwrapped), according to some implementations of the present disclosure.

FIG. 15 is a perspective view of the arm compression garment of FIG. 14 fully assembled (e.g., wrapped up).

FIG. 16 is a perspective view of a compression therapy system including a leg compression garment, according to some implementations of the present disclosure.

FIG. 17 is a perspective view of a compression therapy system including a leg compression garment, according to some implementations of the present disclosure.

FIG. 18 is a perspective view of a compression therapy system including a leg compression garment, according to some implementations of the present disclosure.

FIG. 19 is a perspective view of an arm compression garment with anatomically shaped chambers, according to some implementations of the present disclosure.

FIG. 20 is a perspective view of a leg compression garment with anatomically shaped chambers, according to some implementations of the present disclosure.

FIG. 21 is a perspective view of modular compression garments for an arm and torso of a user, according to some implementations of the present disclosure.

FIG. 22 is a perspective view of a compression therapy system including a modular compression garment for a leg and foot of a user, according to some implementations of the present disclosure.

FIG. 23A illustrates leg compression garment configurations and operations, according to some implementations of the present disclosure.

FIG. 23B illustrates leg compression garment configurations and operations, according to some implementations of the present disclosure.

FIG. 23C illustrates leg compression garment configurations and operations, according to some implementations of the present disclosure.

FIG. 23D illustrates leg compression garment configurations and operations, according to some implementations of the present disclosure.

FIG. 24 is a perspective view of a control device configured to communicate (e.g., wirelessly) with sensors of an arm compression garment, according to some implementations of the present disclosure.

FIG. 25 is a perspective view of a control device configured to communicate (e.g., wirelessly) with a leg compression garment, according to some implementations of the present disclosure.

FIG. 26 is a perspective view of a compression therapy system including a control device configured to display information, according to some implementations of the present disclosure.

FIG. 27 is a perspective view of a compression therapy system including a control device configured to display instruction videos, according to some implementations of the present disclosure.

FIG. 28 is a perspective view of control devices configured to provide an interface for adjusting settings of a compression garment and/or CPG device, according to some implementations of the present disclosure.

FIG. 29 is a perspective view of a control device configured to virtually illustrate one or more components of a compression therapy system, according to some implementations of the present disclosure.

FIG. 30 is a perspective view of a control device configured to aid in wirelessly pairing components of a compression therapy system, according to some implementations of the present disclosure.

FIG. 31 is a perspective view of a control device configured to graphically illustrate data, according to some implementations of the present disclosure.

FIG. 32 is a plan view of a control device configured to graphically illustrate exercise information, according to some implementations of the present disclosure.

FIG. 33 is a plan view of a control device configured to graphically illustrate circulation information, according to some implementations of the present disclosure.

FIG. 34 is a plan view of a control device configured to aid in tracking moods of a user, according to some implementations of the present disclosure.

FIG. 35 is a plan view of a control device configured to aid a user in ordering components of a compression therapy system online, according to some implementations of the present disclosure.

FIG. 36 is a plan view of a control device configured to graphically illustrate compression therapy scoring information, according to some implementations of the present disclosure.

FIG. 37 is a plan view of a control device configured to provide compression pressure slider controls, according to some implementations of the present disclosure.

FIG. 38 is a plan view of a control device configured to provide compression pressure slider controls for various zones of a compression garment, according to some implementations of the present disclosure.

FIG. 39 is a plan view of a control device configured to permit tagging of usage data, according to some implementations of the present disclosure.

FIG. 40 is a plan view of a control device configured to permit communication with a community of user of compression therapy systems, according to some implementations of the present disclosure.

FIG. 41 is a plan view of a control device configured to permit a user to receive coaching and educational resources, according to some implementations of the present disclosure.

FIG. 42 is a plan view of a control device configured to permit direct-chat communication with professionals, according to some implementations of the present disclosure.

FIG. 43 is a plan view of a control device configured to provide a notification center, according to some implementations of the present disclosure.

FIG. 44 is a perspective view of a portal system for managing a number of users of compression therapy systems, according to some implementations of the present disclosure.

FIG. 45 is a front view of a portal system for aiding clinicians with a diagnosis, according to some implementations of the present disclosure.

FIG. 46 is a front view of a portal system for aiding clinicians with monitoring circulation data for multiple users/patients, according to some implementations of the present disclosure.

FIG. 47 is a front view of a portal system for monitoring and/or adjusting customized user settings for a plurality of user/patients of compression therapy systems, according to some implementations of the present disclosure.

FIG. 48 is a front view of a portal system for providing analytics of a population of users/patients of compression therapy systems, according to some implementations of the present disclosure.

FIG. 49 is a front view of a portal system for aiding clinicians with symptom tracking of multiple users/patients, according to some implementations of the present disclosure.

FIG. 50 is a front view of a portal system for providing clinicians with an overview of health data for multiple users/patients, according to some implementations of the present disclosure.

FIG. 51 is a front view of a portal system for aiding clinicians with risk management for multiple users/patients, according to some implementations of the present disclosure.

FIG. 52 is a front view of a portal system configured to display results of diagnostic trend information, according to some implementations of the present disclosure.

FIG. 53 is a front view of a portal system configured to optionally visually track user/patient incident costs, according to some implementations of the present disclosure.

FIG. 54 is a front view of a portal system configured to show user/patient data body metrics, according to some implementations of the present disclosure.

FIG. 55 is a schematic illustration of a Hydraulic/Electroactive Polymer Hybrid compression garment, according to some implementations of the present disclosure.

FIG. 56A is a schematic illustration of a compression garment with four discrete sections, with each section having a number of air chambers, and a first section of air chambers being activated, according to some implementations of the present disclosure.

FIG. 56B is a schematic illustration of the compression garment of FIG. 56A having a different section of air chambers activated.

FIG. 57A is an assembled perspective view of a toroidal chamber with micro-chambers, according to some implementations of the present disclosure.

FIG. 57B is a flattened perspective view of the toroidal chamber of FIG. 57A.

FIG. 58 is a flattened perspective view of a toroidal chamber with micro-chambers, according to some implementations of the present disclosure.

FIG. 59 is an exploded perspective view of the toroidal chamber of FIG. 58.

FIG. 60 is a perspective view of thermoformed micro-chambers of a chamber.

FIG. 61 is a perspective view of a compression garment including leg and foot sections, according to some implementations of the present disclosure.

FIG. 62A is an exploded perspective view of the leg section of the compression garment of FIG. 61, according to some implementations of the present disclosure.

FIG. 62B is an exploded perspective view of the foot section of the compression garment of FIG. 61, according to some implementations of the present disclosure.

FIG. 63A is a flattened top view of generally toroidal macro-chambers with generally toroidal micro-chambers, according to some implementations of the present disclosure.

FIG. 63B is a planar view of a section through generally toroidal macro-chambers with generally toroidal micro-chambers including longitudinal welds defining micro-cells within the micro-chambers, according to some implementations of the present disclosure.

FIGS. 64A and 64B are flattened top views of sections through a generally toroidal macro-chamber with generally toroidal micro-chambers with varying exemplary weld patterns depicting exemplary air flow patterns, according to some implementations of the present disclosure.

FIG. 65 is a perspective view of an inflated section of a generally toroidal macro-chamber with generally toroidal micro-chambers depicting exemplary air flow patterns, according to some implementations of the present disclosure.

FIG. 66 is an exemplary longitudinal cross-section through a portion of a compression garment depicting weld details for forming chambers, according to some implementation of the present disclosure.

FIGS. 67A and 67B are exemplary longitudinal cross-sections through a portion of a compression garment depicting inflated and deflated profiles of a macro-chamber and a plurality of micro-chambers, according to some implementation of the present disclosure.

FIGS. 68A and 68B are other exemplary longitudinal cross-sections through a portion of a compression garment depicting inflated and deflated profiles of a macro-chamber and a plurality of micro-chambers, according to some implementation of the present disclosure.

FIG. 69 is a flattened perspective view of a compression therapy system including a pneumatic spine for insertion into a fully welded garment, according to some implementations of the present disclosure.

FIG. 70 is a partially exploded perspective view of the pneumatic spine in FIG. 69, according to some implementations of the present disclosure.

FIG. 71 is a top flattened view of the compression therapy system of FIG. 69 with the pneumatic spine inserted into the fully welded compression garment, according to some implementations of the present disclosure.

FIG. 72 is a flattened top view of a section through a macro-chamber of a compression garment that is subdivided into micro-chambers with openings connecting adjacent micro-chambers, according to some implementations of the present disclosure.

FIG. 73 is a flattened top view of a section through multiple adjacent macro-chambers of a compression garment that are connected to each other by border openings of different sizes with each macro-chamber subdivided into micro-chambers with openings further connecting adjacent micro-chambers, according to some implementations of the present disclosure.

FIG. 74 is a flattened top view of a section through a macro-chamber of a compression garment that is subdivided into micro-chambers with openings progressively decreasing in size, according to some implementations of the present disclosure.

### 6. DETAILED DESCRIPTION

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting. In particular, while the condition being monitored or treated is usually referred to below as Lymphedema, it is to be understood that the described technologies are also applicable to treatment and monitoring of other circulatory-related disorders.

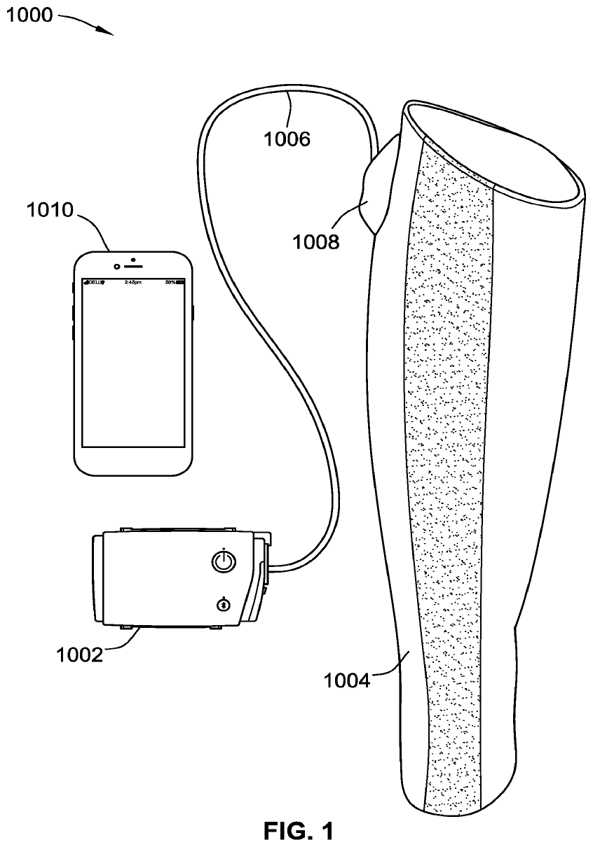

Referring to FIG. 1, a compression therapy system 1000 for compression therapy and/or lymphedema monitoring is shown. The system 1000 includes a compression pressure generator (CPG) device 1002 and a compression garment 1004. A link 1006, such as to provide pneumatic and/or electrical coupling for control and/or operation of the compression garment 1004, connects the CPG device 1002 and the compression garment 1004. The link 1006 may connect with a conduit and/or valve interface 1008, such as one that is integrated with or separate from the compression garment 1004. The compression therapy system 1000 optionally includes a control device 1010, such as a mobile phone, tablet, laptop or other computing or computer device, executing an application to provide for setting the operational parameters (e.g., mode, type of therapy, pressure settings, valves, etc.) of the CPG device 1002 and/or monitoring operations and detected parameters of the CPG device 1002 and/or compression garment 1004.

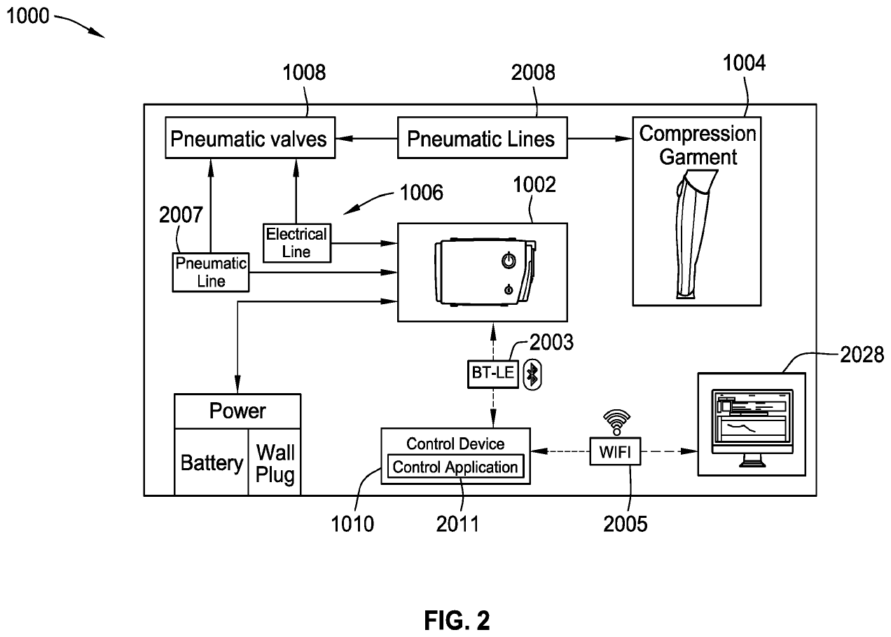

Referring to FIG. 2, various interactions of components of the system 1000 are shown. The system 1000 includes a portal system 2028, such as one with one or more servers, for managing a population of CPG devices. The CPG device 1002 conducts control device related communications 2003, such as wireless communications, with the control device 1010, running a control application 2011. Such communications may involve an exchange of data collected by the CPG device 1002, such as testing measurements and/or usage time, and sent to the control device 1010. Such communications may involve an exchange of control parameters for setting operations of the CPG device 1002, such as valve subset identifiers (zone) for controlling particular valves of the set of valves of the compression garment 1004, a pressure setting for the CPG device 1002, a therapy mode identifier, therapy times, a number of cycles etc. to the CPG device 1002. The wireless communications 2003 may employ a low energy wireless communications protocol such as Bluetooth LE or other.

As discussed in more detail herein, the application 2011 of the control device 1010 can be configured to provide limb, pressure, and usage feedback information to a user. The application 2011 can serve as a virtual coach such as by employing an artificial intelligence chat program. The application 2011 can serve as a social networking tool to other patients receiving similar care with a CPG device. The application 2011 can provide information to the user in relation to troubleshooting operations with the system 1000. The application 2011 can serve as a symptom tracker such as with input from the user and from the CPG device. The application 2011 can permit customization (personalization) with respect to the parameters controlling the therapy pressure waveform provided with the compression garment and the CPG device. The application 2011 can serve as an electronic store for ordering resupply components of the system (e.g., conduits, interfaces 1008, and compression garments). The application 2011 can provide informative/educational messages about disease condition (e.g., lymphedema). The application 2011 can provide user controls to start, stop and set up compression therapy sessions with the CPG device 1002 as well as run diagnostic processes with the CPG device 1002 and compression garment 1004. The application 2011 can simplify use and setup workflow with the CPG device 1002.

The control device 1010 can be configured for portal related communications 2005, such as wireless communications (e.g., wireless protocol communications WiFi), with the portal system 2028. The portal system 2028 can receive, from the control device 1010, testing measurements, therapy parameters, and/or usage time, and may communicate to the control device 1010, parameters for setting operations of the CPG device 1002, such as valve subset identifiers (zone) for controlling particular valves of the set of valves of the compression garment 1004, a pressure setting for the CPG device 1002, a therapy mode protocol, therapy times, a number of cycles, etc. Such a portal system 2028 can be managed by a clinician organization to provide actionable insights to patient condition for a population of CPG devices and their users.

For example, a clinician may provide prescriptive parameters for use of the CPG device 1002 (e.g., therapy control parameters) that may in turn be communicated to a control device 1010 and/or a CPG device 1002. Such communications, such as in relation to receiving testing measurements from the CPG device 1002 via the control device 1010, can permit therapy customization, such as by setting the prescriptive parameters based on the testing measurements. The portal system 2028 may similarly be implemented for compliance management in relation to received usage information from the CPG device 1002. The portal system 2028 may then serve as an integrated part of electronic medical records for a patient's lymphedema therapy.

The CPG device 1002 communicates with an interface 1008 via link 1006. The CPG device 1002 may generate electrical valve control signals on electric lines of a bus to the interface 1008 and receive electrical valve operation signals from the valves of the interface 1008 on the electric lines of the bus of the link 1006. The CPG device 1002 may also generate air flow such as a controlled pressure and/or flow of air to/from the interface 1008 via one or more pneumatic conduits 2007 of the link 1006. The interface 1008 may then selectively direct the pressure and/or flow to/from the chambers of the garment 1004 via any of the pneumatic lines 2008 between the interface 1008 and the compression garment 2004. Optionally, the valves of the interface 1008 and/or the pneumatic lines 2008 may be integrated (partially and/or fully) with the compression garment 1004.

### 6.1 CPG Device

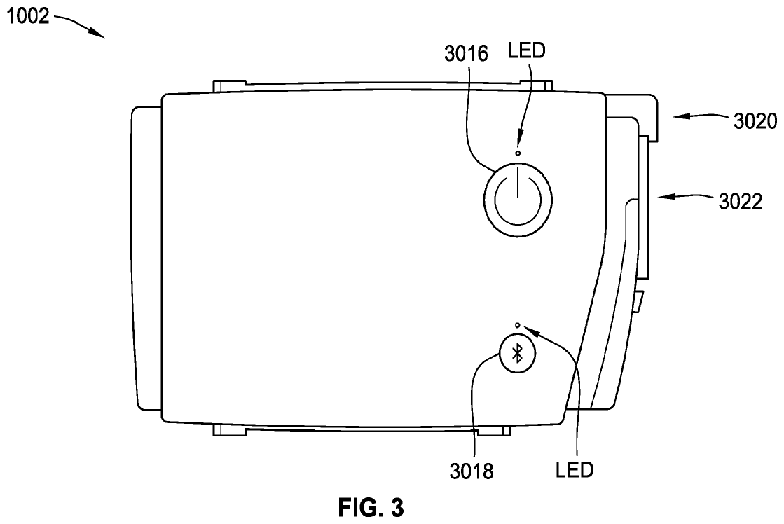

The CPG device 1002 is illustrated in FIG. 3. The CPG device 1002 may have a compact and/or portable design to simplify use with a compression garment (e.g., compression garment 1004). The CPG device 1002 includes a start/stop button 3016. The CPG device 1002 also has a communications link button 3018 to aid in establishing a communications link (e.g., wireless communications) with the control device 1010 (FIG. 1). The CPG device 1002 also includes an electrical interface 3020 for electrically coupling with an interface 1008 or valves of the garment 1004. The CPG device 1002 also includes a pneumatic interface 3022 (inlet/outlet) for pneumatic coupling with the compression garment 1004, such as via a set of valves.

As discussed in more detail herein, the CPG device 1002 may have a programmable controller to provide operations for compression therapies described herein and diagnostic operations. Such therapies may be provided by control of a blower of the CPG device 1002 that may produce positive pressure and/or negative pressure operations via one or more pneumatic conduits coupled to the compression garment 1004. For example, the CPG device 1002 may be configured to generate varied positive pressure for compression up to a maximum of about 50 mmHg into one or more chambers of the compression garment 1004. Similarly, the CPG device 1002 may produce negative pressure, such as to evacuate one or more pneumatic chambers of the compression garment 1004. Such a generation of positive and/or negative pressure (e.g., sub-ambient pressure, vacuum, etc.) may be controlled to provide compression therapy, including massage therapy, with the compression garment 1004 in relation to a set of pneumatic chambers within the compression garment 1004 that are pneumatically coupled to the blower of the CPG device 1002, such as via one or more valves and/or hoses that may be implemented with the interface 1008 (FIG. 2).

In alternative implementations, the pneumatic chambers may be passively evacuated (depressurized or deflated) without the application of negative pressure to the pneumatic chambers. In such implementations, the pneumatic chambers may be selectively pneumatically coupled to atmosphere via one or more active exhaust valves. When pneumatically coupled to atmosphere via an actuated exhaust valve, a pneumatic chamber deflates to ambient pressure. Such implementations allow the use of CPG devices that do not generate negative pressure. An exhaust valve may be located on the CPG device 1002 itself. Alternatively, or additionally, one or more exhaust valves may be located in the interface 1008 or distributed over the compression garment 1004 itself. In the latter implementations, the CPG device 1002 may generate exhaust valve control signals on electric lines of a bus forming part of the link 1006 to actuate the one or more active exhaust valves.

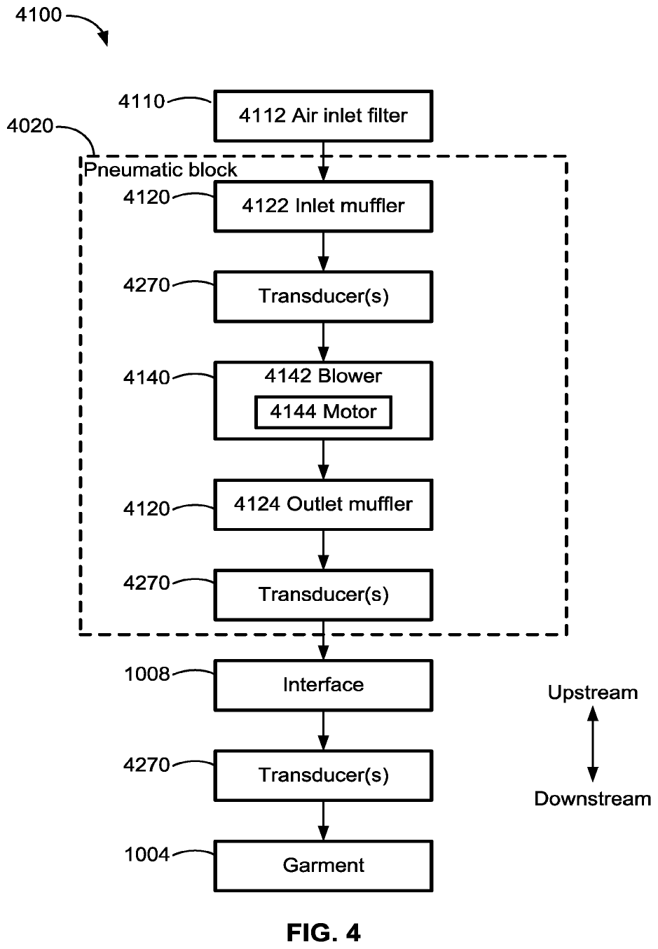

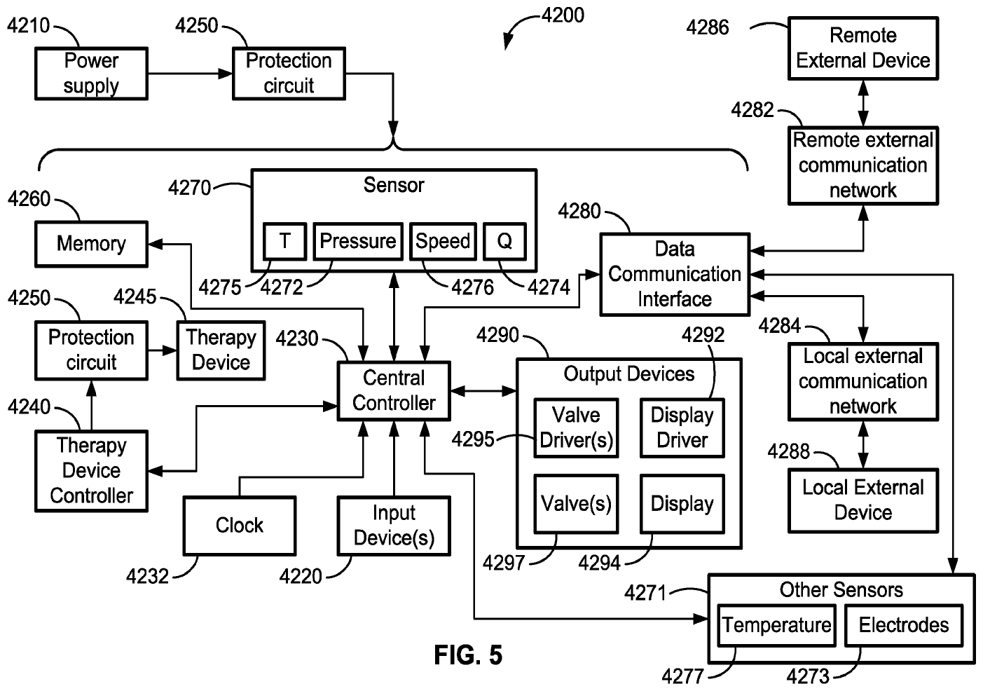

Referring to FIGS. 4 and 5, a compression pressure generator such as the CPG device 1002 may include mechanical and pneumatic components 4100 (FIG. 4), electrical components 4200 (FIG. 5) and may be programmed to execute one or more compression control algorithms. The CPG device 1002 has an external housing (see FIG. 3) that may be formed in two parts, an upper portion and a lower portion. In alternative forms, the external housing may include one or more panel(s). The CPG device 1002 may typically include a chassis that supports one or more internal components of the CPG device 1002. In one form a pneumatic block 4020 (FIG. 4) is supported by, or formed as part of the chassis. The CPG device 1002 may optionally include a handle.

Referring to FIG. 4, a pneumatic path of the CPG device 1002 may comprise any of an inlet air filter 4112, an inlet muffler 4122, a controllable flow or pressure device 4140 capable of supplying air at positive pressure (preferably a blower 4142) and/or evacuating air at negative pressure such as by reversing operation of the blower, and an outlet muffler 4124. One or more pressure sensors and flow rate sensors, such as transducers 4270, may be included in the pneumatic path.

The pneumatic block 4020 may include a portion of the pneumatic path that is located within the external housing. The pneumatic path may then lead to an optional conduit and/or valve interface 1008, such as for controlled/selective directing of the pressurized air from the compression pressure generator to different pneumatic chambers of a compression garment 1004.

Referring to FIG. 5, electrical components 4200 of the CPG device 1002 may include an electrical power supply 4210, such as a battery power supply and/or AC main power supply converter (e.g., alternating current AC to direct current DC), one or more input devices 4220 (e.g., buttons), a central controller 4230, a therapy device controller 4240, a therapy device 4245 (e.g., blower with impeller and motor), one or more optional protection circuits 4250, memory 4260, transducers 4270, data communication interface 4280 and one or more output devices 4290 (e.g., lights, valve control). Electrical components 4200 may be mounted on a single Printed Circuit Board Assembly (PCBA). In an alternative form, the CPG device 1002 may include more than one PCBA.

The central controller 4230 of the CPG device 1002 is programmed to execute one or more compression mode control algorithms, and may include a detection module (e.g., sine wave generation control and evaluation).

### 6.1.1 CPG Device Mechanical & Pneumatic Components

6.1.1.1 Air filter(s)

Referring back to FIG. 4, the CPG device 1002 may include an air filter 4110, or a plurality of air filters 4110 (e.g., filter 4112). Such air filters may keep passages of the compression garment clean of air debris.

### 6.1.1.2 Muffler(s)

The CPG device 1002 may include an inlet muffler 4122 that is located in the pneumatic path upstream of a blower 4142.

The CPG device 1002 may include an outlet muffler 4124 that is located in the pneumatic path between the blower 4142 and the compression garment 1004.

### 6.1.1.3 Pressure Device

Referring to FIGS. 4 and 5, a flow or pressure device 4140 for producing a flow of air at positive pressure is a controllable blower 4142. For example, the blower 4142 may include a brushless DC electric motor 4144 with one or more impellers housed in a volute. The blower 4142 is capable of delivering a supply of air and/or drawing (e.g., evacuating) a supply of air. The flow or pressure device 4140 is under the control of the therapy device controller 4240 (FIG. 5).

### 6.1.1.4 Transducer(s)

With continued reference to FIGS. 4 and 5, the CPG device 1002 may include one or more transducers 4270 (e.g., pressure, flow rate, temperature) that are located upstream of the pressure device 4140. The one or more transducers 4270 are constructed and arranged to measure properties of the air at that point in the pneumatic path.

Alternatively or additionally, one or more transducers 4270 are located downstream of the pressure device 4140, and upstream of the interface 1008. The one or more transducers 4270 are constructed and arranged to measure properties of the air at that point in the pneumatic path.

Alternatively or additionally, one or more transducers 4270 are located downstream of the interface 1008, and proximate to and/or within the compression garment 1004.

6.1.1.5 Air Conduit and/or Valve Interface

As shown in FIGS. 1 and 4, an air conduit, such as via an optional conduit and/or valve interface 1008, in accordance with an aspect of the present technology is constructed and arranged to allow a flow of air between the pneumatic block 4020 and the compression garment 1004.

### 6.1.2 CPG Device Electrical Components

### 6.1.2.1 CPG Device

### 6.1.2.1.1 Power Supply

Referring to FIG. 5, a power supply 4210 supplies power to the other components of the CPG device 1002, such as, the input device 4220, the central controller 4230, the therapy device 4245, and the output device 4290, valves, etc. Such a power supply may provide a DC voltage, such as 24 volts.

The power supply 4210 can be internal to the external housing of the CPG device 1002, such as in the case of a battery (e.g., a rechargeable battery). Alternatively, the power supply 4210 can be external of the external housing of the CPG device 1002. The internal or external power supply may optionally include a converter such as to provide a DC voltage converted from an AC supply (e.g., a main supply).

### 6.1.2.1.2 Input Device(s)

Input devices 4220 (shown in FIG. 5) may include one or more of buttons, switches or dials to allow a person to interact with the CPG device 1002. The buttons, switches or dials may be physical devices, or software devices accessible via an optional touch screen of the CPG device 1002. The buttons, switches or dials may, in one form, be physically connected to the external housing, or may, in another form, be in wireless communication with a receiver that is in electrical connection to the central controller 4230.

The input device 4220 may be constructed and arranged to allow a person to select a value and/or a menu option. Alternatively, the input device 4220 may simply be configured to turn the CPG device 1002 on and/or off

### 6.1.2.1.3 Central Controller

The central controller 4230 (shown in FIG. 5) is a dedicated electronic circuit configured to receive input signal(s) from the input device 4220, and to provide output signal(s) to the output device 4290 and/or the therapy device controller 4240 and/or the data communication interface 4280.

The central controller 4230 can be an application-specific integrated circuit. Alternatively, the central controller 4230 can be formed with discrete electronic components.

The central controller 4230 can be a processor 4230 or a microprocessor, suitable to control the CPG device 1002 such as an x86 INTEL processor.

The central controller 4230 suitable to control the CPG device 1002 in accordance with another form of the present technology includes a processor based on ARM Cortex-M processor from ARM Holdings. For example, an STM32 series microcontroller from ST MICROELECTRONICS may be used.

In a further alternative form of the present technology, the central controller 4230 may include a member selected from the family ARMS-based 32-bit RISC CPUs. For example, an STR9 series microcontroller from ST MICROELECTRONICS may be used.

In certain alternative forms of the present technology, a 16-bit RISC CPU may be used as the central controller 4230 for the CPG device 1002. For example, a processor from the MSP430 family of microcontrollers, manufactured by TEXAS INSTRUMENTS, may be used.

The central controller 4230 is configured to receive input signal(s) from one or more transducers 4270, and one or more input devices 4220. The central controller 4230 may also be configured with one or more digital and/or analog input/output ports as previously described such as for implementing the mode of operations and detection modules in conjunction with the operations of the system. For example, such input and/or output ports may provide control over or detect position of active pneumatic valves controlled by the central controller for directing compression related pressure to pneumatic chambers of the compression garment 1004.

Thus, the central controller 4230 is configured to provide output signal(s) to one or more of an output device 4290 (e.g., one or more valves of a set of valve(s)), a therapy device controller 4240, and a data communication interface 4280. Thus, the central controller 4230 may also be configured with one or more digital and/or analog output ports as previously described such as for implementing the mode of operations or detection module in conjunction with the operations of the CPG device 1002.

The central controller 4230, or multiple processors, is configured to implement the one or more methodologies described herein such as the one or more algorithms, as described in more detail herein, expressed as computer programs stored in a computer readable storage medium, such as memory 4260. In some cases, as previously discussed, such processor(s) may be integrated with the CPG device 1002. However, in some devices the processor(s) may be implemented discretely from the pressure generation components of the CPG device 1002, such as for purpose of performing any of the methodologies described herein without directly controlling delivery of a compression therapy. For example, such a processor may perform any of the methodologies described herein for purposes of determining control settings for the compression garment 1004 and/or monitoring of a circulatory-related disorder by analysis of stored data such as from any of the sensors described herein. Such a processor may also perform any of the methodologies relating to the different mode of operations as described in more detail herein.

### 6.1.2.1.4 Therapy Device

In one form of the present technology, the therapy device 4245 (shown in FIG. 5) is configured to deliver compression therapy to a user wearing the compression garment 1004 under the control of the central controller 4230. The therapy device 4245 may be the controllable flow or pressure device 4140, such as a positive and/or negative air pressure device 4140. Such a device may be implemented with a blower, such as a servo-controlled blower. Such a blower may be implemented with a motor having an impeller in a volute.

### 6.1.2.1.5 Therapy Device Controller

In one form of the present technology, therapy device controller 4240 (shown in FIG. is a therapy control module that may implement features of the compression related algorithms executed by or in conjunction with the central controller 4230. In some cases, the therapy device controller 4240 may be implemented with a motor drive. It may also optionally be implemented with a valve controller. Thus, such algorithms may generate motor control signals to operate a motor of blower to control generation of compression related pressure/flow. Such algorithms may also generate valve control signals to control operation of a set of valves for directing location of such compression related pressure/flow via one or more valves of the set of valves coupled with pneumatic chambers of the compression garment 1004.

In one form of the present technology, therapy device controller 4240 includes a dedicated motor control integrated circuit. For example, in one form a MC33035 brushless DC motor controller, manufactured by ONSEMI is used.

### 6.1.2.1.6 Protection Circuits

The CPG device 1002 in accordance with the present technology optionally includes one or more protection circuits 4250 such as shown in FIG. 5.

One form of protection circuit 4250 in accordance with the present technology is an electrical protection circuit. Another form of protection circuit 4250 in accordance with the present technology is a temperature or pressure safety circuit.

In some versions of the present technology, a protection circuit 4250 may include a transient absorption diode circuit configured to absorb energy generated or converted from rotational kinetic energy, such as from the blower motor, which may be applied to charging a battery of the CPG device. According to another aspect of the present technology, a protection circuit 4250 may include a fault mitigation integrated circuit.

### 6.1.2.1.7 Memory

In accordance with one form of the present technology the CPG device 1002 includes memory 4260 (shown in FIG. 5), preferably non-volatile memory. The memory 4260 may include battery powered static RANI memory, volatile RAM memory, EEPROM memory, NAND flash memory, or any combination thereof. The memory 4260 can be located on a PCBA (not shown).

Additionally or alternatively, the CPG device 1002 can include a removable form of memory 4260, for example, a memory card made in accordance with the Secure Digital (SD) standard.

The memory 4260 can act as a computer readable storage medium on which is stored computer program instructions expressing the one or more methodologies described herein, such as the one or more algorithms discussed herein.

### 6.1.2.1.8 Transducers

Transducers 4270 (schematically shown in FIGS. 4 and 5) may be internal to the CPG device 1002, or external to the CPG device 1002. External transducers may be located on or form part of, for example, the CPG device 1002, the conduit and/or valve interface 1008, and/or the compression garment 1004.

### 6.1.2.1.8.1 Flow Rate

A flow rate transducer 4274 (shown in FIG. 5) in accordance with the present technology may be based on a differential pressure transducer, for example, an SDP600 Series differential pressure transducer from SENSIRION. The differential pressure transducer is in fluid communication with the pneumatic circuit, with one of each of the pressure transducers connected to respective first and second points in a flow restricting element.

In use, a signal representing a total flow rate Q from the flow rate transducer 4274 is received by the central controller 4230. However, other sensors for producing such a flow rate signal or estimating flow rate may be implemented. For example, a mass flow sensor, such as a hot wire mass flow sensor, may be implemented to generate a flow rate signal in some embodiments. Optionally, flow rate may be estimated from one or more signals of other sensors described herein (e.g., speed and pressure sensor).

### 6.1.2.1.8.2 Pressure

A pressure transducer 4272 (shown in FIG. 5) in accordance with the present technology is located in fluid communication with the pneumatic circuit. An example of a suitable pressure transducer is a sensor from the HONEYWELL ASDX series. An alternative suitable pressure transducer is a sensor from the NPA Series from GENERAL ELECTRIC.

In use, a signal from the pressure transducer 4272 is received by the central controller 4230. In one form, the signal from the pressure transducer 4272 is filtered prior to being received by the central controller 4230.

### 6.1.2.1.8.3 Motor Speed

In one form of the present technology a motor speed signal from a motor speed transducer 4276 (shown in FIG. 5) is generated. A motor speed signal is preferably provided by therapy device controller 4240. Motor speed may, for example, be generated by a speed sensor, such as a Hall Effect sensor.

### 6.1.2.1.8.4 Temperature

The temperature transducer(s) 4275 (shown in FIG. 5) may measure temperature of the gas in the pneumatic circuit. One example of the temperature transducer 4275 is a thermocouple or a resistance temperature detector (RTD).

### 6.1.2.1.9 Other Sensors

With continued reference to FIG. 5, in one form of the present technology, additional sensors 4271 may be coupled (e.g., wirelessly or wired) to the CPG device 1002 (e.g., via link 1006 or data communication interface 4280) such as for detection of bio-related conditions within the compression garment 1004. For example, as discussed in more detail herein, one or more sets of electrodes 4273 may be contained within the compression garment and provide measurements to the CPG device 1002 (e.g., central controller 4230). Such electrodes may be implemented to measure biopotential from the skin or skin impedance of the user in one or more zones of the compression garment 1004. Such electrode-based measurements may be evaluated, such as by the central controller 4230 or control device or other portal system, to determine body composition as an indication of condition of Lymphedema. Similarly, as previously mentioned, one or more temperature sensors 4277 may be located in zones of the compression garment 1004 to measure a temperature associated with the zone to provide an indication of a skin temperature of the user in the particular zone. Such measurements may be provided, such as via a bus to the central controller 4230, such as for creating a log of measurements and/or providing an adjustment to a compression protocol based on the measurements such as for the particular zone. The central controller 4230 or control device may also generate warnings (e.g., communications) to report a temperature, such as one exceeding a threshold, to inform a user or clinician (e.g., via a portal system) of a need for treatment (e.g., antibiotic for an infection). As discussed in more detail herein, in some versions, tension or strain sensor(s) may also be implemented for measurement of compression strain within the compression garment 1004, such as for detecting limb girth or volume.

### 6.1.2.1.10 Data Communication Interface

A data communication interface 4280 (shown in FIG. 5) can be provided and connected to the central controller 4230. The data communication interface 4280 may be connectable to remote external communication network 4282. The data communication interface 4280 can be connectable to a local external communication network 4284. The remote external communication network 4282 is connectable to a remote external device 4286, such as a population management server communicating with multiple CPG devices. The local external communication network 4284 is connectable to the local external device 4288, such as control device 1010. The data communications interface 4280 may optionally include a wireless communications interface (e.g., a transceiver using a wireless protocol such as Bluetooth, WiFi, Bluetooth LE etc.), such as for communications with the control device 1010, such as when it serves as the local external device 4288. Optionally, such a data communications interface 4280 may communicate, e.g., wirelessly, with one or more sensors of the compression garment 1004 and/or one or more active valves of, or coupled to, the compression garment 1004.

In one form, data communication interface 4280 is part of the central controller 4230. In another form, data communication interface 4280 is an integrated circuit that is separate from the central controller 4230.

In one form, the remote external communication network 4282 is a wide area network such as the Internet. The data communication interface 4280 may use wired communication (e.g. via Ethernet, or optical fibre) or a wireless protocol to connect to the Internet.

In one form, local external communication network 4284 utilises one or more communication standards, such as Bluetooth, or a consumer infrared protocol.

In one form, the remote external device 4286 is one or more computers, for example a cluster of networked computers. In one form, the remote external device 4286 may be virtual computers, rather than physical computers. In either case, such remote external device 4286 may be accessible to an appropriately authorised person such as a clinician.

The local external device 4288 can be a personal computer, mobile phone, tablet or remote control.

### 6.1.2.1.11 Output Devices Including Optional Display, Alarms, Active Valves

An output device 4290 (shown in FIG. 5) in accordance with an example of present technology may optionally take the form of one or more of a visual, audio, haptic unit(s) and/or a valve driver for a set of active valves such as the pneumatic valves of the interface 1008, which may be integrated with the CPG device 1002, the compression garment 1004 and/or a discrete device board serving as the interface 1008. Each of such active valves may be a pneumatic valve configured to receive a control signal to directionally gate and/or proportionally permit transfer of air selectively through the valve.

For example, as discussed in more detail herein, the output device 4290 may include one or more valve driver(s) 4295 for one or more active valves or one or more active valve(s) 4297. Such output devices 4290 may receive signals from the central controller 4230 for driving operation of the valves 4297. Such valve driver(s) 4295 or valves 4297 may be discrete from the CPG device 1002 external housing and coupled to the CPG device 1002 via a bus, such as a Controller Area Network (CAN) bus such as where the central controller 4230 includes a CAN bus controller. A suitable electrical coupler portion of link 1006 may serve to couple the bus with the valve driver 4295 and/or valves 4297. The active valves may be any suitable pneumatic valve for directing air flow, such as a gate valve, a multi-port valve, or a proportional valve, any of which may be operated by an included solenoid. In some implementations, the active valves 4297 and valve drivers 4295 may be within the CPG device 1002 housing or in a discrete housing of an interface (e.g., conduit and/or valve interface 1008) or in the compression garment 1004.

An optional visual display 4294 may be a Liquid Crystal Display (LCD) or Light Emitting Diode (LED) display. An optional display driver 4292 (shown in FIG. 5) may receive as an input the characters, symbols, or images intended for display on the display 4294, and converts them to commands that cause the display 4294 to display those characters, symbols, or images.

The display 4294 (shown in FIG. 5) may optionally be configured to visually display characters, symbols, or images in response to commands received from the display driver 4292. For example, the display 4294 may be an eight-segment display, in which case the display driver 4292 converts each character or symbol, such as the figure “0”, to eight logical signals indicating whether the eight respective segments are to be activated to display a particular character or symbol.

### 6.1.2.2 Therapy Device

In a preferred form of the present technology, the therapy device 4245 (FIG. 5) is under the control of the therapy device controller 4240 (e.g., a therapy control module) to generate therapy to the compression garment 1004 worn by a user (e.g., a patient). In some implementations, the therapy device 4245 is an air pressure device 4140 (FIG. 4), such as a positive pressure device that can generate negative pressure.

6.2 Conduit and/or Valve Interface

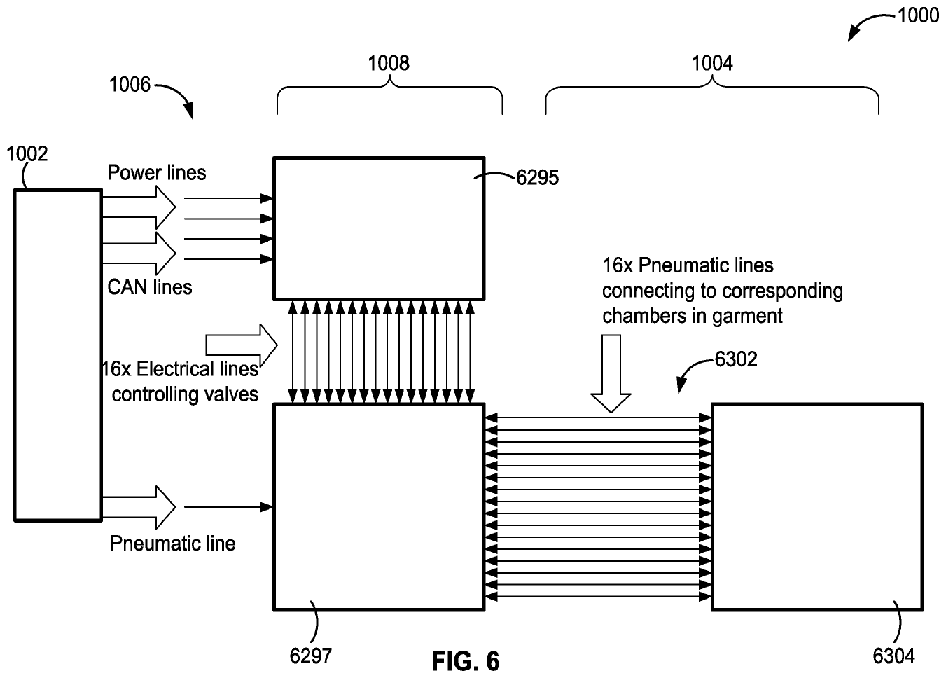

Referring to FIG. 6, when implemented with active valves 6297, the conduit and/or valve interface 1008 may be implemented to control multiple valves for selective setting of the pneumatic condition of chambers of the compression garment 1004. The link 1006 between the CPG device 1002 and the compression garment 1004 includes a plurality of electrical lines, such as for providing power and signals from a CAN bus of the CPG device 1002. The link 1006 also provides a pneumatic line for fluid communication between the CPG device 1002 and the interface 1008. In this example, an active valve driver board 6295 is configured to communicate with the central controller 4230 (FIG. 5) via the CAN bus lines. Similarly, the active valve driver board 6295 has electrical lines permitting the active valve driver board 6295 to control (e.g., open, close or partially open) the pneumatic path of each of a set of active valves 6297. In this regard, the set of active valves 6297 may be configured with a manifold that fluidly couples one side of a pneumatic path of each valve with the pneumatic line of the link 1006. Similarly, each valve 6297 may be fluidly coupled to an additional pneumatic line. The additional pneumatic line may be integrated with, or lead to, a pneumatic path of the compression garment 1004 that may be uniquely associated with one or more pneumatic chamber(s) of the compression garment 1004. As shown in FIG. 6, sixteen valves provide sixteen pneumatic connecting lines 6302, which may be implemented by conduits or tubes, leading to the pneumatic chambers 6304 of the compression garment 1004.

The interface 1008 is shown as including sixteen active valves 6297; however, such an interface may have fewer or more of such active valves 6297 depending on the desired configuration of a compression garment and the type and number of chambers in the compression garment to be pressurized by the CPG device 1002.

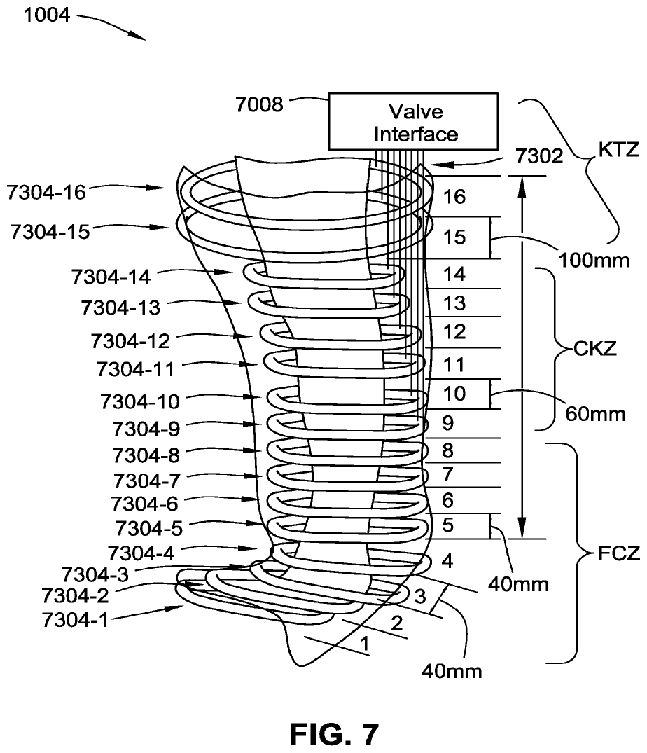

The connection from the sixteen valves via the sixteen pneumatic connecting lines 6302 is further illustrated in relation to the interface shown in FIG. 7. The interface 7008, which is illustrated on a compression garment 1004 suitable for use on a lower leg and foot, has leads to connecting lines 7302 each in turn providing a pneumatic path to one of sixteen chambers 7304-1 through 7304-16 of the compression garment 1004.

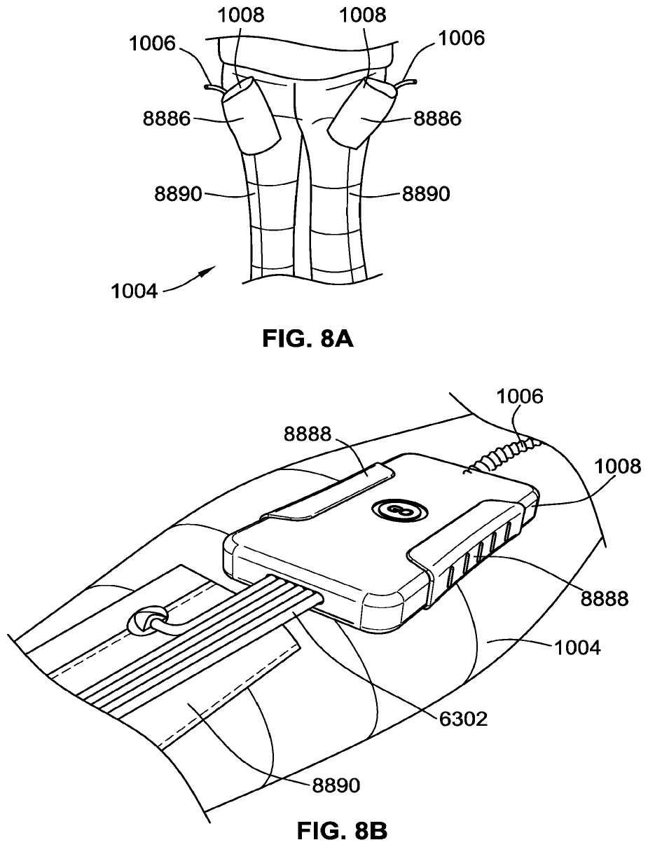

Use of the conduit and/or valve interface 1008 with the system 1000 may be further considered in reference to FIGS. 8 to 11. In several versions, the interface 1008 may be a discrete component or unit that is removable or disconnectable from the CPG device 1002 and the compression garment 1004. In some versions, the compression garment 1004 may be configured to couple to and retain the discrete component of the interface 1008, such when it includes the set of active valves 6297 for the operation of the compression garment 1004. For example, as illustrated in FIG. 8A, a compression garment 1004 (e.g., in the shape of a pair of pants) may be configured with a pocket 8886, such as a fabric pocket, to carry the interface 1008 when pneumatically and/or electrically coupled to the compression garment 1004. For example, a coupler opening in the base of the pocket may serve as a seat with pneumatic couplings that facilitate appropriate interfacing/coupling of the pneumatic connections from interface 1008 to the pneumatic pathways of the compression garment 1004. For another example, as illustrated in FIG. 8B, the compression garment 1004 includes a clip 8888 sized to hold the interface 1008 when coupled to the compression garment 1004. The clip 8888 may be proximate to a fabric channel 8890 or hem of the compression garment 1004, such as an added (sewn on) layer, within which the pneumatic connecting lines 6302 may run to their respective chamber connections.

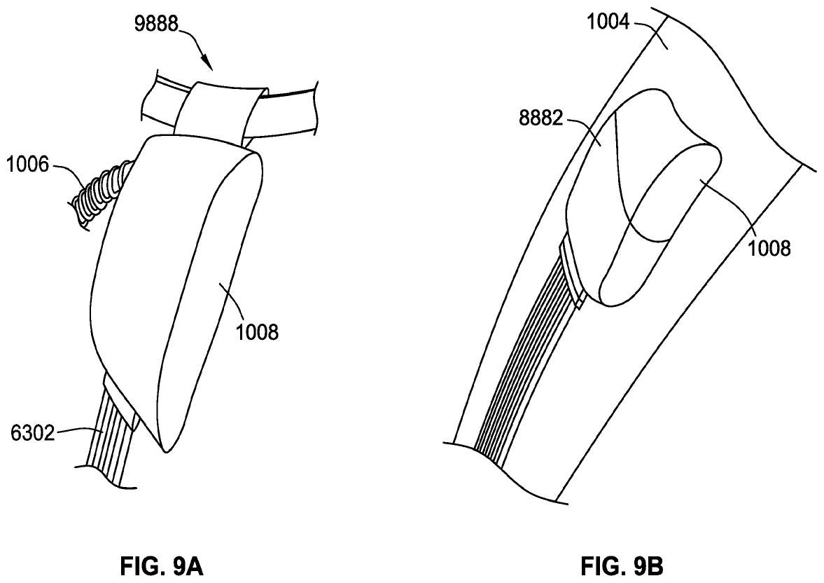

Referring to FIG. 9A, a belt mount 9888, serves as a mechanism for carrying the interface 1008 when coupled to the compression garment 1004. Referring to FIG. 9B, a pocket 8882 of the compression garment 1004 (e.g., in the shape of a sleeve) serves as a mechanism for carrying the interface 1008.

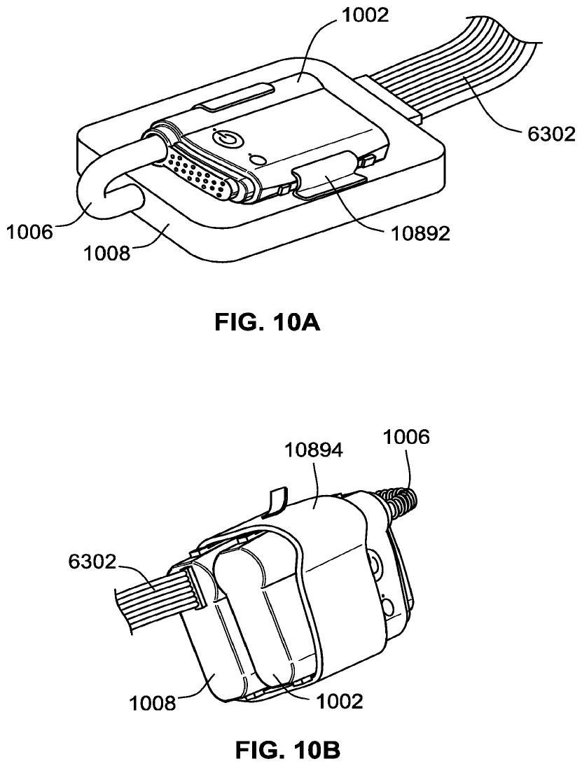

Referring to FIG. 10A, the interface 1008 unit can include a clip 10892 for mounting the CPG device 1002 thereon. Referring to FIG. 10B, a bundle sleeve 10894 can be applied to the interface 1008 unit and the CPG device 1002 when they are pneumatically and electrically coupled to aid in keeping them joined together by the bundle sleeve 10894 as a common bundle.

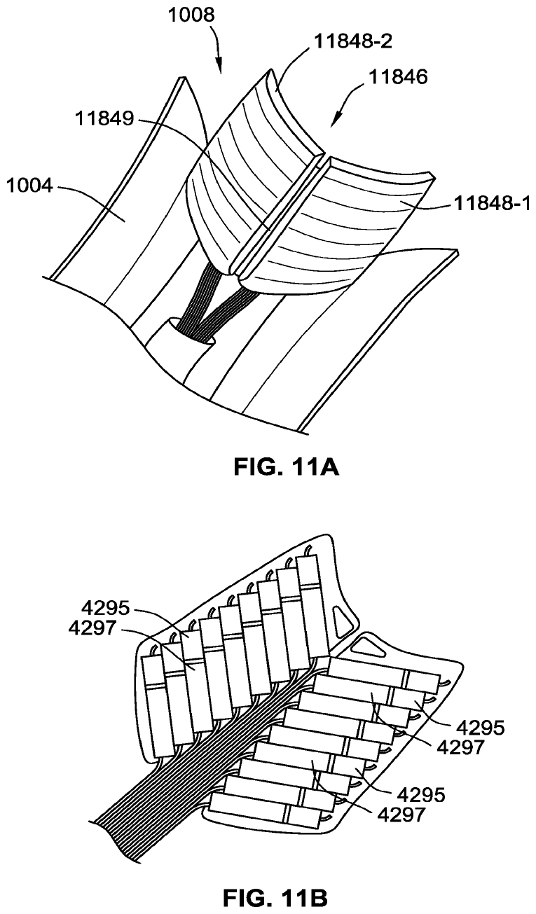

Referring to FIG. 11A, the interface 1008 unit can have a housing with an anatomical surface curvature 11846 to promote comfortable wearing when combined with the compression garment 1004. The interface 1008 unit may be formed with two wings 11848-1, 11848-2 that are joined by a flexible hinge 11849. Such a butterfly configuration can permit the interface 1008 unit to more readily conform to the shape of, by flexing around, the limb being treated with the joined compression garment 1004. Such a hinged structure 11849 also more readily permits movement of the interface 1008 with movement of the user for user comfort. Referring to FIG. 11B, in some such versions, the valves 4297 and valve drivers 4295 of the interface 1008 unit may be divided within the housing structure of each wing 11848-1, 11848-2 of the interface 1008 unit.

6.3 Passive Valve(s)

Although some versions of the valves interfacing with the CPG device 1002 may be active valves as controlled by the interface 1008, as discussed in more detail herein, some compression garments of the present disclosure can be implemented with passive valves. One or more passive valves may serve to complement the pneumatic operations of the chambers with the active valves and/or as an alternative to active valve implementation. Thus, in some cases, the interface 1008 may direct a pneumatic line to a chamber of the compression garment via a passive valve. Such a passive valve may serve as an inlet to or an outlet from a chamber of the compression garment. Such a passive valve may open depending on a pressure condition applied to one side of the passive valve. In an example, such a passive valve may be implemented, for example, by a flexible flap having a chosen rigidity that is responsive to a desired pressure threshold condition. Such a valve may be a duckbill valve. Thus, when a desired pressure differential is achieved across the mechanism of the passive valve, the passive valve opens to permit air movement across the passive valve. Such a passive valve may be implemented as an aperture (or two or three or more apertures) with a flow restriction(s) to delay flow through the aperture(s) to permit different inflation timings between neighbouring chambers that are separated by the flow restricted aperture(s).

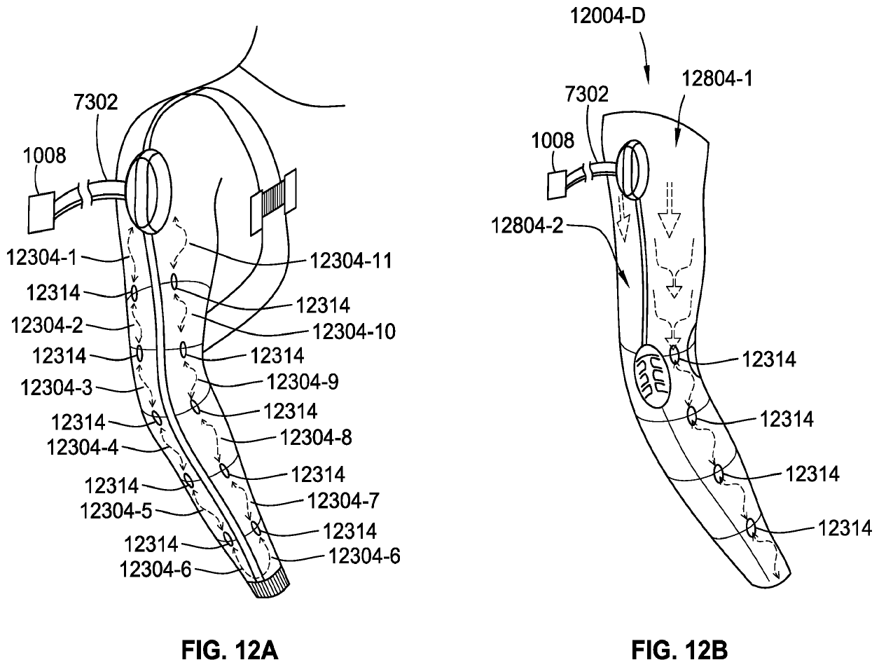

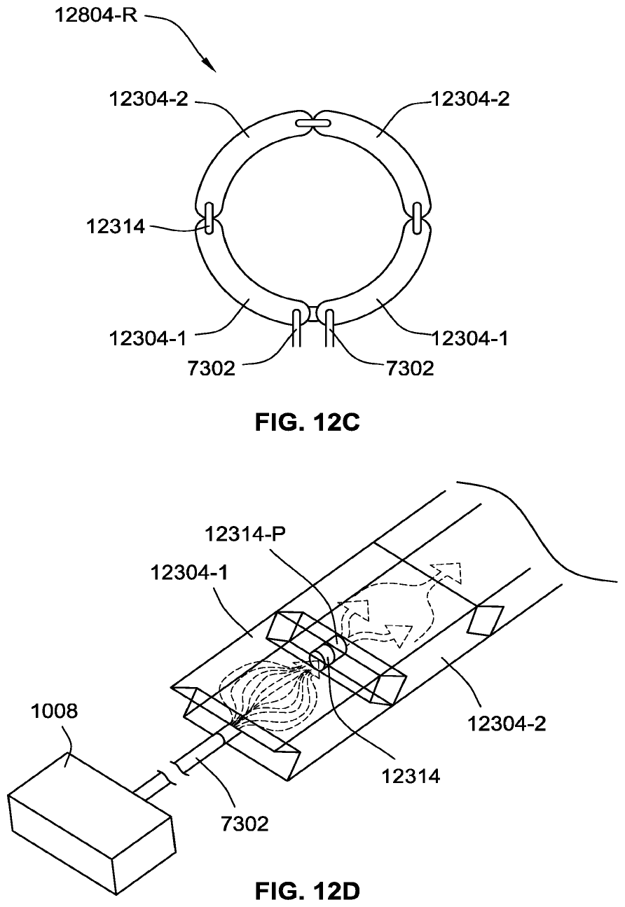

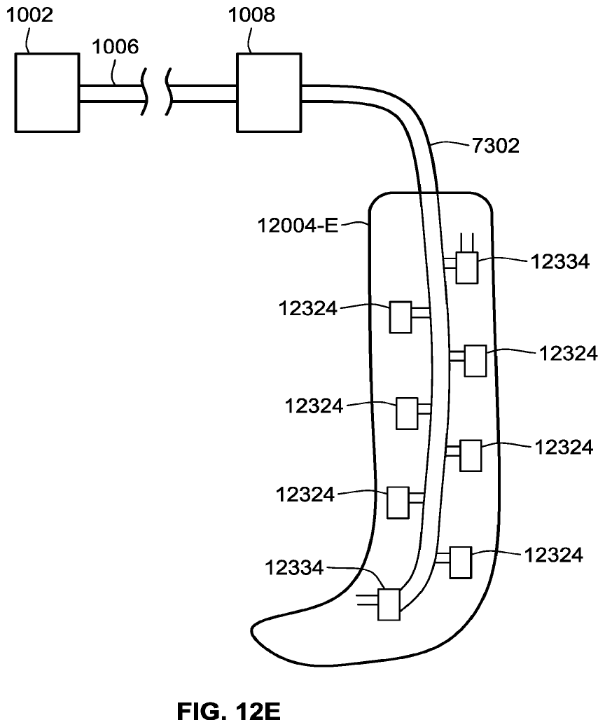

For example, as illustrated in FIG. 12A, an active valve may be controlled to permit pneumatic inflation of a first chamber 12304-1 that is coupled to a single pneumatic connecting line 7302 from the interface 1008. By operation of the CPG device 1002, air may be pumped into first chamber 12304-1. Upon achieving a pressure condition in the first chamber (which may provide initial compression in the vicinity of the first chamber), the flexibility threshold of the passive valve 12314 may be overcome so as to thereby open the passive valve 12314. The opening of the passive valve 12314 may then permit pneumatic inflation of a second chamber 12304-2 via the passive valve 12314 such that compression may be later (delayed in time) applied in the vicinity of the second chamber. Similarly, in other forms, a flow restriction of the passive valve 12314 may delay pressurization of the second chamber 12304-2 until after the first chamber 12304-1 has achieved a compressive pressure condition.

As shown in FIG. 12A, a series of such chambers 12304-1 to 12304-11 separated by such passive valves can permit a sequential inflation of the series of chambers. Such a sequential inflation can provide a sequential shifting of the leading edge of the compression force along the compression garment so that it has a directional vector in the direction of the series of chambers of the garment. In this way, a directional vector of compression (tangentially along the user's skin surface of the limb receiving therapy) proximate to each of the sequentially inflated chambers, can be provided with the passive valves. Such passive valves may, for example, be implemented with an applicator manipulation therapy as described in more detail herein, and may provide such a therapy with fewer active valves. By using such a series of passive valve(s) 12314 with interceding chambers, it can potentially reduce size of the garment as fewer active valves may be necessary.

Referring to FIG. 12B, an arm compression garment 12004-D includes a first series of chambers 12804-1, a second series of chambers 12804-2, and passive valves 12314 formed to provide a compression vector along an arm. The series 12804 of chambers and passive valves 12314 in the arm compression garment 12004-D provides a directional compression force vector that progresses towards the wrist from the upper arm. Alternatively, such chambers may be configured to provide the series of chambers 12804-1, 12804-2 and passive valves 12314 so that the directional compression force vector progresses towards the upper arm from the wrist. In some versions, different series of chambers and passive valves may be isolated so that different directional compression force vectors can be achieved in different parts of the compression garment. For example, one series may be configured to provide the directional compression force vector in a progression towards the elbow from the wrist and a different series may be configured to provide the directional compression force vector in a progression towards the upper arm from the elbow. Of course, additional series may provide for additional localization of the directional compression force vector.

In a further example illustrated in FIG. 12C, a circular directional compression force may be achieved, such as by a series 12804-R of passive valves 12314 and chambers 12304-1, 12304-2 in a ring configuration, such as about all or a portion of a periphery of a sleeve compression garment. As shown in relation to the series 12804-R, two first chambers 12304-1 may be inflated by respective connecting lines 7302. The connecting lines may optionally be coupled to one or two active valves and/or a manifold from a CPG device (e.g., CPG device 1002). Two second chambers 12304-2 may then inflate when a desired pressure differential is achieved across the passive valves 12314.

Another example of such a passive valve is illustrated in FIG. 12D. The passive valve 12314 may be implemented with an inter-chamber passage 12314-P that forms a small opening, such as a tubular opening, between neighbouring chambers 12304-1, 12304-2. The passage 12314-P becomes obstructed upon collapse of the chambers 12304-1, 12304-2 when air is drawn from the chambers 12304-1, 12304-2. Such a collapse is facilitated by a baffle design of the chambers 12304-1, 12304-2 and/or of the passive valve that enables collapse of the inter-chamber passage 12314-P. The collapse of the chambers 12304-1, 12304-2 collapses the passage 12314-P that is formed in the baffle. Expansion of the baffle upon sufficient inflation of the chamber permits opening of the passage for the sequential inflation described herein.

6.4 Compression Garment

As described herein, a compression garment 1004 includes a set of pneumatic chambers that may be inflated and/or deflated by operation of the CPG device 1002 via one or more pneumatic lines leading to the pneumatic chambers of the compression garment 1004. Such activation may be implemented with one or more active valves and/or passive valves. The garment may typically be lightweight, flexible and washable and may employ a compression fabric.

In some implementations, the garment is formed with layers, such as an inner layer (e.g., inner sleeve) and an outer later (e.g., outer sleeve). The garment may be manufactured with a breathable fabric, serving as an inner skin contact interface. Such a material may serve as a barrier to direct user contact with a less permeable material that forms a set of pneumatic chambers of the garment. In some implementations, one or more layers of the garment (e.g., the skin contacting layer) includes polyester, elastane, nylon, and thermoplastic polyurethane (TPU). In some such implementations, the TPU is used as a backing to aid in making the garment airtight or near airtight. The proportion of polyester, elastane, and nylon can be adjusted to modify the elasticity of the garment (e.g., the skin contacting layer). In some implementations, a weave technique of one or more layers of the garment can be adjusted to modify the elasticity of the garment.

The chambers and pneumatic pathways may be formed between the layers. In some forms, the outer layer may be made of a three-dimensional knitted fabric. The outer layer may include one or more moulded portions, such as in a form of a brace, to more rigidly support certain anatomical regions of the limb (e.g., a forearm brace or leg brace) such as along one side of the sleeve. Some areas of the garment may include stretchable or flexible regions to permit movement (e.g., elbow, wrist, ankle or knee regions). Moreover, moulded portions may include pneumatic couplings and/or pneumatic pathways. Such component regions (e.g., of thermoplastic elastomer TPE such as Santoprene) may be sewn into the fabric of the garment, co-moulded, or ultrasonically welded to the fabric.

The garment may be generally formed as a sleeve that can be applied around the bodily area of therapy. For example, it may be an arm sleeve, a partial arm sleeve, an above-the-knee leg sleeve, a full leg sleeve, a foot sleeve, a toe-to-thigh sleeve, an ankle-to-knee sleeve, etc.

As previously discussed and as illustrated in FIG. 7, the compression garment 1004 can include a set of pneumatic chambers 7304-1 to 7304-16 positioned about the compression garment 1004 that are sized and located to promote a desired compression therapy. As shown, the compression garment 1004 is a lower leg type compression garment with a partial upper foot portion and a leg portion that each provides different sets of chambers or cells for separately compressing discrete portions of the foot and/or leg that are covered by the compression garment 1004. Each chamber forms a semi- or fully-peripheral ring about a tubular portion of the sleeve. The chamber rings are located along the length of the sleeve, resulting in sixteen controllable chambers. These chambers may be activated in zones. As shown, the compression garment 1004 includes a set of chambers in a knee-thigh zone KTZ (e.g., chambers 15 and 16), a set of chambers in a calf-knee zone CKZ (e.g., chambers 10, 11, 12, 13 and 14), and a set of chambers in a foot-calf zone FCZ (e.g., chambers 1, 2, 3, 4, 5, 6, 7, 8 and 9).

The pneumatic chambers 1-16 may be formed with a material having baffles (e.g., chamber material folds) to more readily permit a vertical expansion of the chamber, where the baffles are the same or similar to that shown in FIG. 12D and described above. The pneumatic chamber 12304-1 (FIG. 12D) may be box shaped with one or more edge folds, such as at each of an inlet end and an outlet end. Such folds may also be at sides of the chamber (not illustrated). Such folds can permit a more uniform rising of the user side surface of the box to provide a more evenly applied compression surface area such as when compared to a more rounded, balloon-shaped type of chamber. Each chamber can provide an isolated compressive force at the surface of the chamber in contact with a user from inflation of the pneumatic chamber, such as in relation to activation of an active valve and/or passive valve, in the location of the inflation. Multiple chambers can be activated to distribute the compressive force. They may also be sequentially activated to move the location of the compressive force.

The compression garment(s) of the present disclosure may also include, or be configured to retain, pneumatic pathways (such as in moulded portions) or conduits inserted therein to fluidically couple pneumatic connecting lines 6302/7302 (FIGS. 6 and 7), such as from the interface 1008 and/or the CPG device 1002 for pneumatic purposes, to the pneumatic chambers of the compression garment. Such pathways may also couple discrete pneumatic chambers together, such as when the chambers are separated by a passive valve (FIG. 12A). In some versions, one active valve may direct gas flow via such a conduit or pathway in relation to one pneumatic chamber or in relation to a group of pneumatic chambers. Thus, a pathway of the compression garment may couple a group of pneumatic chambers or a single pneumatic chamber. Thus, in some cases different active valves may be coupled to different pneumatic chambers or different groups of pneumatic chambers via the pathways of the compression garment. In some versions, the compression garment may include integrated active valves distributed throughout the compression garment. In some versions, the compression garment may include couplers for attachment of pneumatic conduits and/or electrical lines such as to the integrated active valves.

Distributed valving confers a number of advantages on a compression garment. With distributed valving, the interface 1008 is a conduit interface with a single pneumatic connection to the link 1006 and a single pneumatic connection to the garment 1004, along with electrical connections to each of the distributed active valves. This enables the garment to be lighter and less bulky. Referring to FIG. 12E, a compression garment 12004-E containing multiple active valves 12324 is shown. Each of the valves 12324 is pneumatically connected to a pneumatic chamber (not shown). The valves 12324 are distributed throughout the compression garment 12004-E. The compression garment 12004-E also contains multiple exhaust valves 12334, each pneumatically connected to atmosphere, distributed over the garment 12004-E. Each valve 12324 and 12334 is also connected to the conduit interface 1008 via a single common pneumatic connecting line 7302 which runs along the length of the garment 12004-E. Each valve 12324 and 12334 is also electrically connected to the conduit interface 1008 via a corresponding electrical control line (not shown). The conduit interface is pneumatically and electrically connected to the CPG device 1002 via the link 1006.

In addition, the narrow-gauge conduit between each valve and its connected pneumatic chamber is shorter with distributed valving than in compression garments with a valve interface 1008. Since narrow-gauge conduits have higher pneumatic impedance per unit length, there is less pneumatic impedance between the CPG device and each pneumatic chamber with distributed valving. This enables a smaller CPG device to be used to achieve the same pressure in each pneumatic chamber. Furthermore, a shorter conduit between valve and chamber has less compliance than a longer conduit. This enables a faster pressurisation/depressurization response in the chamber to valve actuation. In turn this means oscillatory (vibratory) compression waveforms (described below) may be delivered relatively more efficiently.

In such cases, a controlled compression zone may be considered a set of one or more pneumatic chambers that may be operated by one or more active valve sets by a controller of the CPG device. Such a zone of chambers may also employ passive valves.

The compression garment(s) of the present disclosure may also include sensors, such as pressure, strain, flow rate, temperature, electrodes, or any combination thereof. When measuring skin characteristics, such sensors may be located on a layer of the compression garment to permit skin contact. For example, a temperature sensor, strain sensor and/or a set of electrodes may be in one or more of the zones of the compression garment such as at an inner layer of the garment. Integrated pressure, flow rate, and/or temperature sensors may be located to measure a characteristic of the pneumatic pathway(s) of the garment. In some versions, strain sensors may be implemented in the garment to measure compression strain of the garment in one or more different zones of the garment. Measurements from such sensors may be used by the CPG device 1002.

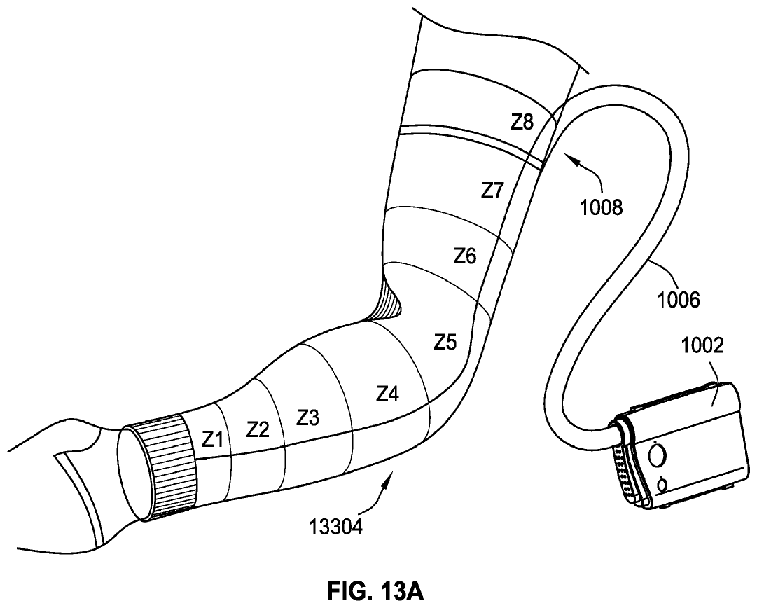

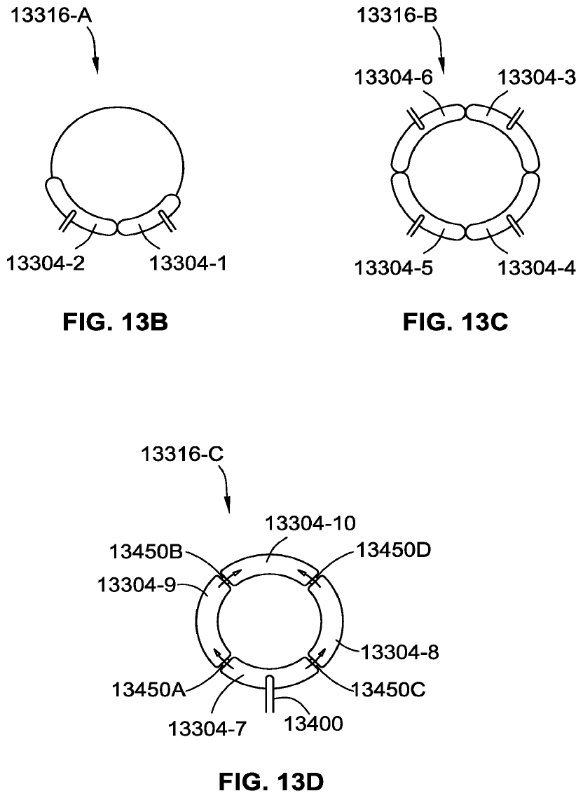

Various configurations of the compression garment(s) of the present disclosure can be provided based on the type of compression therapy and target portion of the body of the user (e.g., patient). Additional examples of compression garments of the present disclosure are shown in FIGS. 13 to 22, which are discussed in detail herein.

Referring to FIG. 13A, an arm type compression garment 13304 is shown. The compression garment 13304 has multiple controlled compression zones Z1-Z8. The compressive garment 13304 can implement compressive areas (e.g., areas 13316-A, 13316-B, 13316-C) about the periphery of the sleeve with different chamber configurations. For example, as shown in FIG. 13B, a peripheral compressive area 13316-A (shown in a plan view of a cross section of the sleeve 13304) may be formed with a semi-peripheral chamber configuration. In this configuration, peripheral compression is achieved by inflation of one or more chambers 13304-1, 13304-2, which are positioned on only a portion of the periphery of the sleeve 13304. In such a peripheral compressive area 13316-A, inflation of chambers along one side of the periphery of the sleeve 13304 effects a tightening of the sleeve with a material on the opposing peripheral side of the sleeve 13304. Such a configuration may have one or more pneumatic chambers that may employ one or more active valves and one or more passive valves.

Referring to FIG. 13C, another peripheral compressive area 13316-B (also shown in a plan view of a cross section of the sleeve) may be implemented by locating chambers substantially about the entire periphery of the sleeve 13304. For example, as shown in the peripheral compressive area 13316-B, four pneumatic chambers 13304-3, 13304-4, 13304-5, 13304-6 encircle the periphery of the sleeve. Each may be independently controlled by an active valve.

Referring to FIG. 13D, a peripheral compressive area 13316-C includes four pneumatic chambers 13304-7, 13304-8, 13304-9, 13304-10 that encircle the periphery of the sleeve 13304. In this area, one of the pneumatic chambers is controlled by an active valve via conduit 13400 and the remaining series of chambers are inflated by interceding passive valves 13450A-D. Although these peripheral area sections show four chambers, fewer or more such chambers (e.g., 2, 5, 6, 7, 10, 20, 50, 100, 1000, etc. or any number in-between, less, or more) may be implemented to encircle the sleeve 13304 as desired. As illustrated in the grid on the compression garment 13304 of FIG. 13A, each discrete zone Z1, Z2, Z3, Z4, Z5, Z6, Z7, and Z8 along the length of the sleeve 13304 may have one peripheral compressive area (e.g., areas 13316-A, 13316-B, 13316-C) in any of the configurations discussed in relation to FIGS. 13B-13D. Fewer or more such zones (e.g., 2, 4, 10, 20, 50 etc.) may be provided, which may depend, for example, on the number of active valves provided in the system 1000 (FIG. 1).

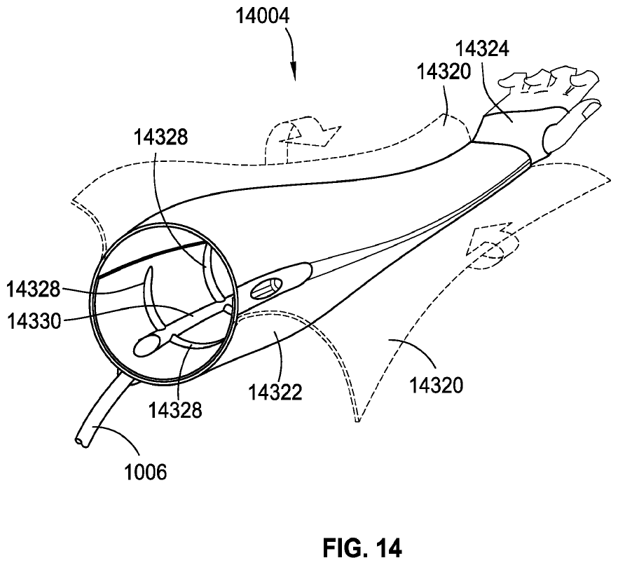

Referring to FIG. 14, an arm compression garment 14004 includes a compression fabric (e.g. spandex and/or nylon) outer layer 14320, which may be applied to a moulded TPE (e.g., Santoprene) that forms an inner layer 14322 exo-skeleton of the limb. An inner skin contact membrane 14324 may be applied under the exo-skeleton layer 14322. As shown, a portion of an optional membrane 14324 is shown as extending onto a hand portion of the user. The moulded exo-skeleton structure may be formed (moulded) with pathways that serve as a flexible pneumatic manifold to direct airflow about the compression garment 14004 to the localized chambers of the garment 14004. Such a pathway may be provided with one or more trunk paths 14330 extending along the length of the sleeve 14004 and the pathway may have multiple semi-peripheral branch paths 14328 leading to discrete chambers that are formed between the moulded exo-skeleton layer 14322 and the inner skin contact layer and/or between the outer layer 14320 and the moulded exo-skeleton layer 14322. An end of the trunk path 14330 may be moulded as, or to, a pneumatic coupling for removable connectability of a pneumatic line 1006 from the interface 1008 and/or the CPG device 1002 (FIG. 1).

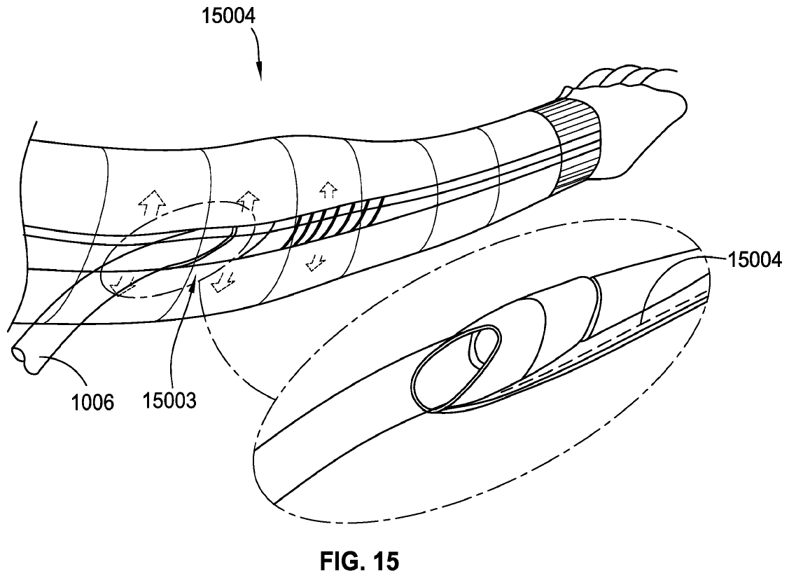

Referring to FIG. 15, a pneumatic coupling 15003 is shown as being sewn or stitched, for example, into a compression garment 15004, which is the same as, or similar to, the compression garment 14004.

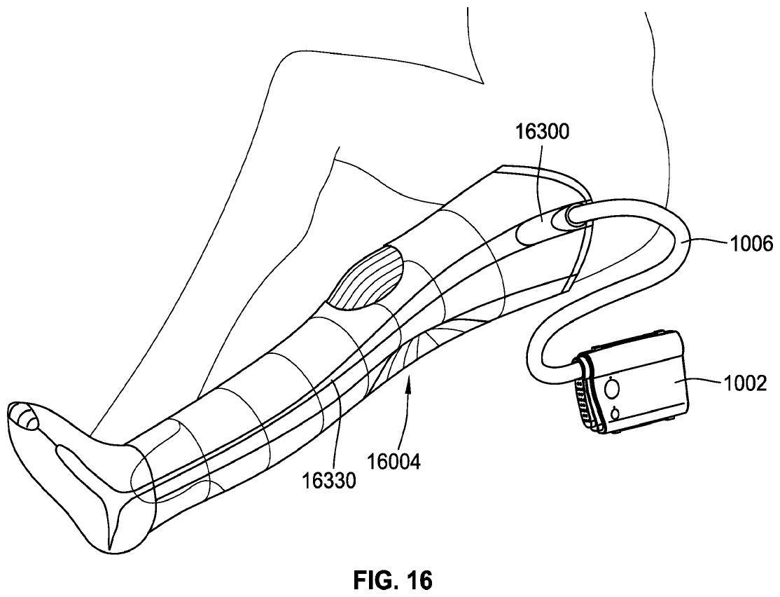

Some versions of the compression garments of the present disclosure are designed for leg and/or foot therapies/compression. Examples of such leg and/or foot/boot compression garments are illustrated in FIGS. 16, 17 and 18. Referring to FIG. 16, a pneumatic coupling 16300 is moulded to a compression garment 16004 to lead to directly to a trunk line 16330 (and indirectly to the branch lines) of the integrated pneumatic path of an exo-skeleton.

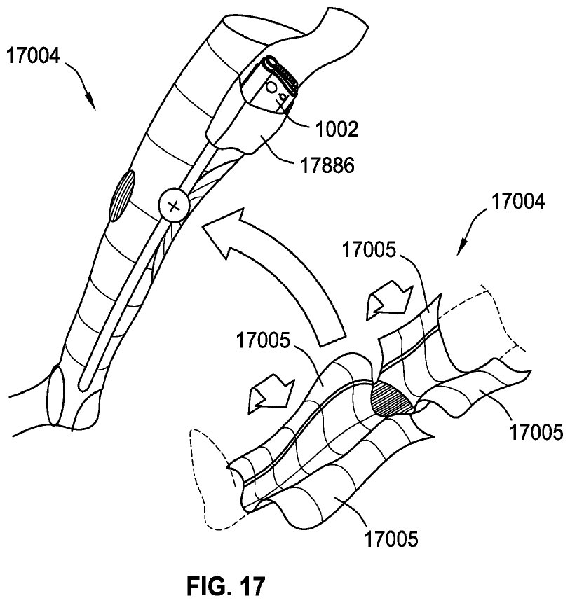

Referring to FIG. 17, a compression garment 17004 includes an integrated pocket 17886 (such as with an internal pneumatic seat to couple to an outlet of the CPG device 1002 and/or interface 1008 as previously described) for holding the CPG device 1002 and/or interface 1008. The compression garment 17004 may be applied by wrapping one or more portions/flaps 17005 of the garment 17004 onto a leg of a user. Such a wrapping may employ hook and loop material fasteners (e.g., Velcro) along the wrap edges so that the wrapped edges form a sleeve to provide the compression during use. Such a wrapping design may be implemented with any other of the compression garments of the present disclosure (e.g., arm, foot, etc.).

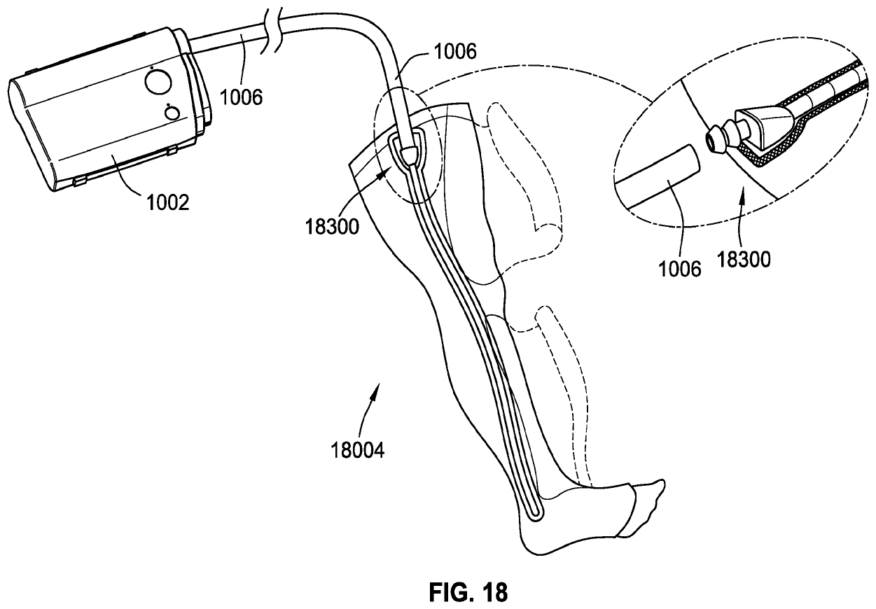

Referring to FIG. 18, a compression garment 18004 includes a barbed-type pneumatic coupling 18300 (shown connected and exploded) for establishing a pneumatic connection between the compression garment 18004 and the CPG device 1002 via the link 1006. Such a pneumatic coupling 18300 may be co-moulded with the exo-skeleton structure, sewn/stitched into the fabric or ultrasonically welded to the fabric.

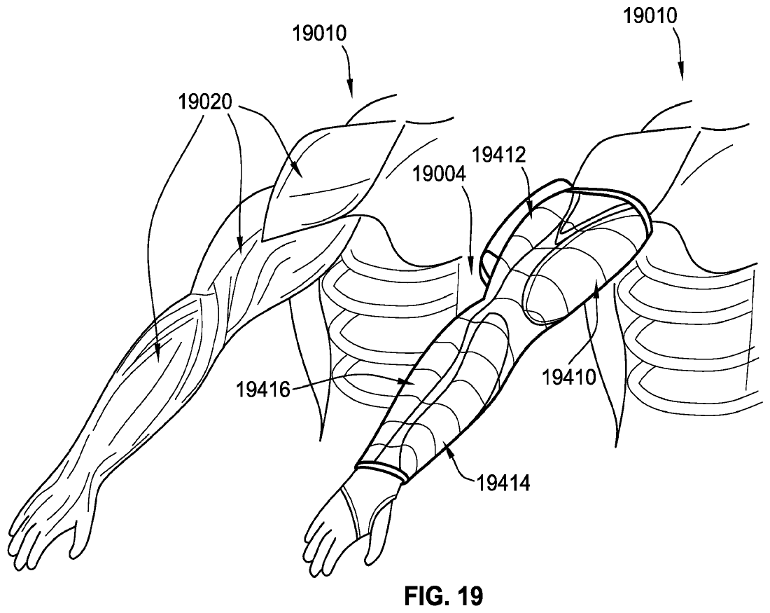

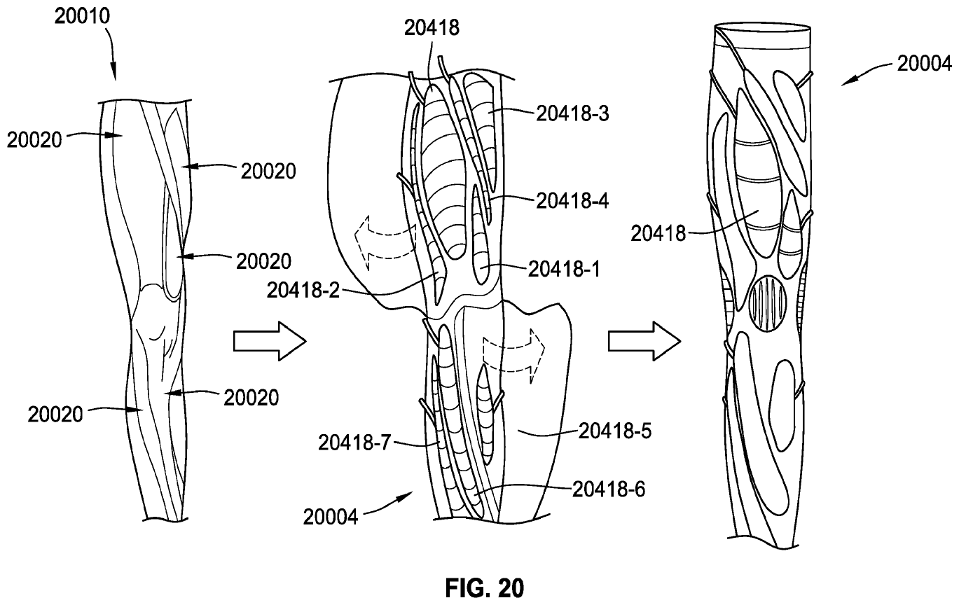

In some versions of the compression garment, one or more anatomically shaped pneumatic chambers may provide muscular based zones (anatomically shaped surfaces of the pneumatic chambers) for focused compression therapy. Examples of such compression garments are illustrated in FIGS. 19 and 20. Such muscular based zones, such as for location at the major muscle groups of the arms or legs, can provide targeted manipulation of each muscle area to support lymphatic function and blood flow. In some versions, knitted fabric can separate the set of pneumatic chambers (one or more) in each muscle zone from other muscle zones.

Referring to FIG. 19, an arm compression garment 19004 has one or more chambers in a zone, anatomically shaped to target one or more muscles or groups of muscles 19020 of an arm of a user 19010, such as, for example, triceps brachii, biceps brachii, brachialis, brachioradialis, extensor carpi ulnaris, extensor digiti minimi, extensor digitorum, flexor carpi radialis, flexor carpi ulnaris, etc., or any combination thereof. In one such example, a bicep zone 19410 may have a set of chambers (e.g., one to four) that can be controlled to target the bicep zone such that activation of the chambers provides a compression therapy to an area limited to the bicep muscle. Similarly, a tricep zone 19412 may have a set of chambers (e.g., one to four) that can be controlled to target the tricep zone such that activation of the chambers provides a compression therapy to an area limited to the tricep muscle. Similarly, a brachioradialis zone 19414 may have a set of chambers (e.g., one to four) that can be controlled to target the brachioradialis zone such that activation of the chambers provides a compression therapy to an area limited to the brachioradialis muscle. Similarly, a flexor carpi ulnaris zone 19416 may have a set of chambers (e.g., one to four) that can be controlled to target the flexor carpi ulnaris zone such that activation of the chambers provides a compression therapy to an area limited to the flexor carpi ulnaris muscle.

Referring to FIG. 20, a bare leg (left side of FIG. 20) of user 20010 is shown being wrapped (middle of FIG. 20) with a compression garment 20004 (fully installed on the right side of FIG. 20) for supplying targeted leg muscle compression therapy. Similar to the arm compression garment 19004, a leg muscle zone 20418 (e.g., rectus femoris) may have a set of chambers (e.g., one to four) that can be controlled to target the leg muscle zone such that activation of the chambers provides a compression therapy to a surface area limited to the targeted leg muscle 20020. Such zones of the compression garment 20004 as a vastus medialis zone 20418-1, a vastus latoralis zone 20418-2, adductor magnus zone 20418-3, sartorius zone 20418-4, gastrocnemius (medial head) zone 20418-5, tibialis anterior zone 20418-6, extensor digitorum longus zone 20418-7, etc., or any combination thereof, may target respective leg muscles 20020.

In some versions, the compression garments of the present disclosure comprise anatomically shaped chambers based on the key points which a physical therapist focuses on when performing Manual Lymphatic Drainage (MLD). As an example, for Lower Limb lymphedema, these points may be inner to outer thigh, behind the knee, the sides of the calf, around the ankle and extremities. This enables the system 1000 to emulate MLD accurately. Such points may each be implemented as one or more zones and may be configured with active and/or passive valves to produce the desired directional manipulation of the points as previously discussed.

In some versions, the compression garments of the present disclosure may be implemented with a modular configuration to permit use of multiple garments with a common CPG device 1002. Referring to FIG. 21, an arm and shoulder compression garment 21004-A is worn over the arm and shoulder for receiving a compression therapy in various zones of the shoulder and arm. A conduit and valve interface 21008-A is configured with a coupler for connecting to the CPG device 1002 by the link 21006. The user may also use torso compression sleeve 21004-B, such as with wrapped edges as previously discussed. The torso compression sleeve 21004-B is formed to complement the arm and shoulder compression garment 21004-A. In this regard, a region of the conduit and valve interface 21008-A on the garment 21004-A may be located at a region of a chaining interface 21422 on the garment 21004-B. Thus, when both garments are worn, the chaining interface 21422 and the conduit and valve interface 21008-A may connect to permit pneumatic and/or electrical communication between the components of the garments 21004-A and 21004-B. In such a case, a separate conduit and valve interface for the garment 21004-B is not necessary to be coupled to the CPG device 1002. Thus, air pressure and control signals for the activation of the compression of the second garment (e.g., torso garment 21004-B) may be delivered from the CPG device 1002 through the pathways and wires of the first garment (arm and shoulder garment 21004-A).

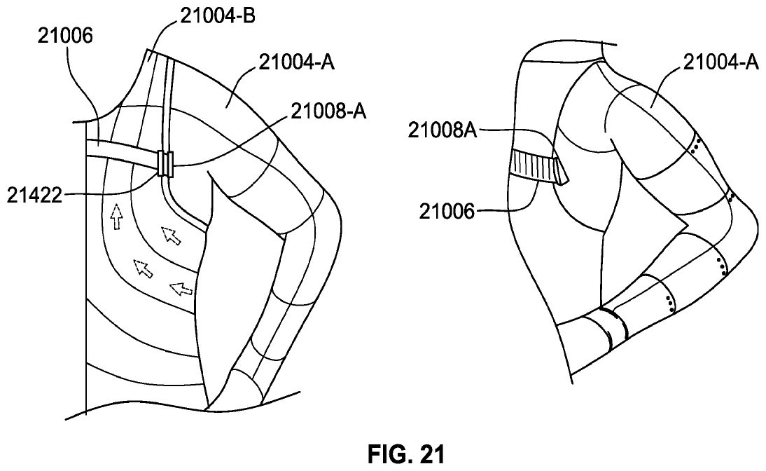

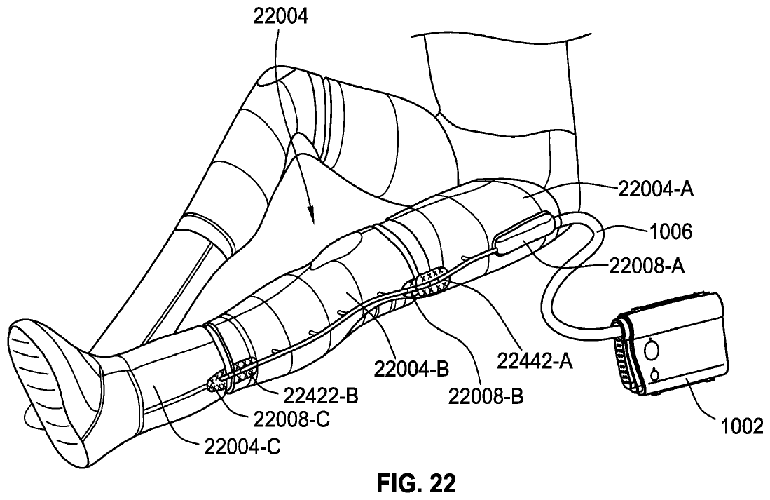

Referring to FIG. 22, another modular compression garment 22004 is shown as including an upper leg compression garment 22004-A, a lower leg compression garment 22004-B, and a boot compression garment 22004-C. As shown, the upper leg compression garment 22004-A and lower leg compression garment 22004-B each have a chaining interface (22422-A and 22422-B respective) located in a region of the respective garments for direct coupling to a conduit and valve interface (22008-B and 22008-C respectively) of a neighbouring garment. Thus, compression therapy of the several garments may be implemented by bussing signals (pneumatic and electrical) through the respectively coupled garments with a single CPG device 1002 connected to the modular compression garment 22004 via interface 22008-A.

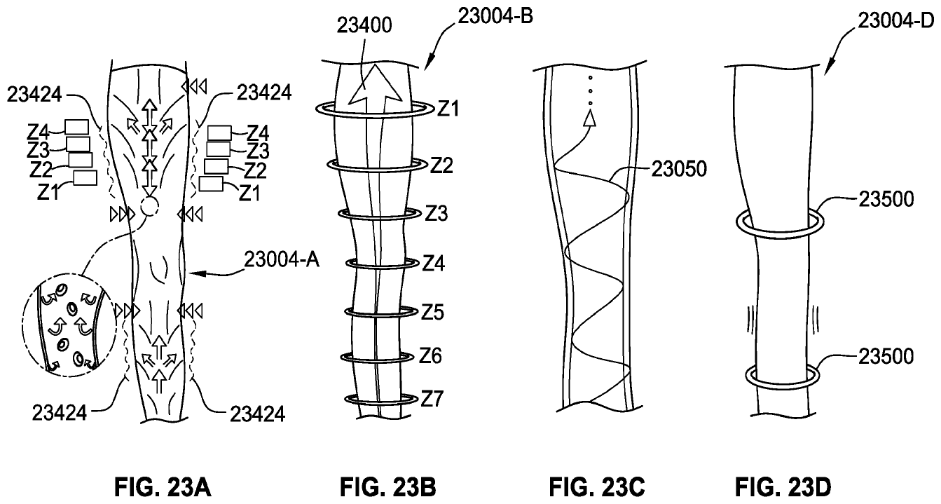

In some versions, the compression garment, such as at its inner surface, may include, or form, one or more applicator(s). Such applicator(s) may be in contact (directly or indirectly) with the user's skin. Such applicator(s) may be a flexible rigid structure (e.g., a ridge(s), rib(s) or bump(s)) that may extend along the length of, or portions of, the compression garment. Such a rigid structure will typically be more rigid than a user's skin. Such a structure(s) can provide a focused manipulative force when mechanically pressed into the user's skin by the inflation of one or more particular pneumatic chambers of the compression garment that reside next to or above where the applicator is located. Some versions of the applicator have a curving or wavy configuration along the length of the applicator. An applicator may have a contact surface profile that includes hills and valleys relative to the user's skin. An applicator may have a contact surface profile that snakes or curves along the length of the user's limb at the contact surface of the user's skin (such as without hills and/or valleys relative to the skin surface). An applicator, or a series of applicators, may extend over several pneumatic chambers (e.g., two or more, such as three, four, five, six, etc.) of the compression garment. Thus, a sequential activation of the pneumatic chambers can urge the applicator to apply an advancing manipulative force, at the skin-applicator contact area, that advances the manipulative force in a direction of the sequential activation of the pneumatic chambers and along the profile or shape (e.g., curved) of the applicator. An example of such an applicator 23424 is illustrated in FIG. 23A and the operation of which is discussed in more detail herein.

In some implementations, the compression garments of the present disclosure include air chambers with micro-holes (perforations), which allows air to be diffused out at a controlled rate to provide a cooling and drying effect on the skin. The micro-holes may be evenly distributed throughout the compression garment. Alternatively, the micro-holes may be concentrated in areas where skin temperature sensors are denser, such as at the back of the knee, and/or in areas prone to sweating, such as, for example, skin folds.

In some implementations, the compression garments of the present disclosure include an open or perforated conduit along the inner layer, such that air flow from the CPG device 1002 and/or exhaust air flow from the pneumatic chambers to atmosphere can be directed through this cooling conduit with the aim of providing a cooling and drying impact on the skin. As with the distribution of micro-holes, the cooling conduit perforations may be evenly distributed throughout the garment. Alternatively, the cooling conduit perforations may be concentrated in areas where skin temperature sensors are denser, such as at the back of the knee, and/or in areas prone to sweating, such as, for example, skin folds.

6.5 Micro-Pumped System

An alternative implementation of the system 1000 has micro-pumps embedded into the air chambers enclosed within the garment 1004. When electrically activated by the CPG device 1002 via control lines in the link 1006, the micro-pumps fill the chambers with air and compress the limb. In such an implementation the link 1006 needs no pneumatic conduit between the CPG device 1002 and the garment 1004.

6.6 Non-Pneumatic Systems

In alternative implementations, a compression therapy system may be driven by non-pneumatic methods and/or a hybrid of non-pneumatic and pneumatic methods. The main advantage of such implementations is a high resolution on where the compression is applied, without the need for valves and pneumatic blocks. Some examples of non-pneumatic systems are given below.

### 6.6.1 Hydraulic/Electroactive Polymer Hybrid Device

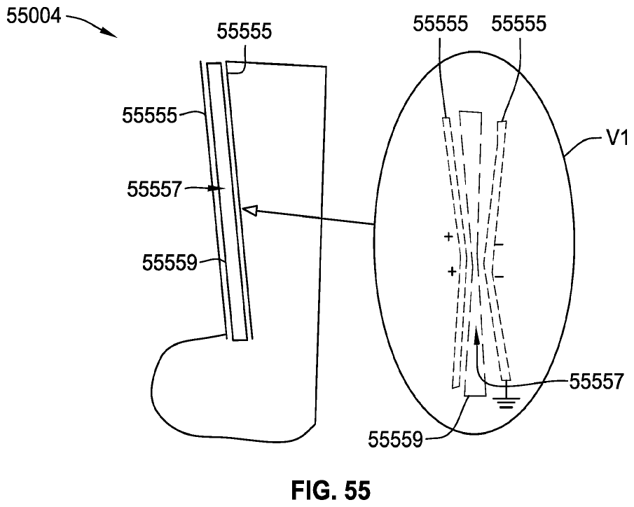

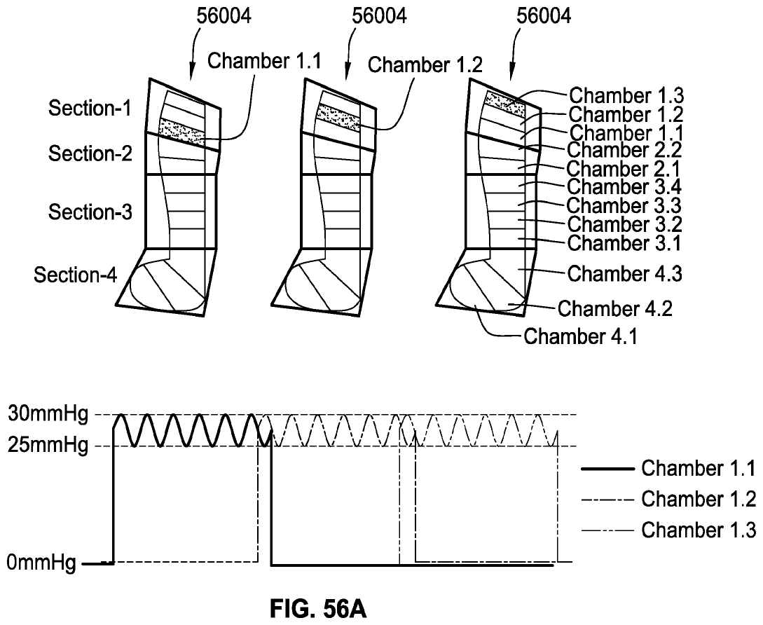

Referring to FIG. 55, a Hydraulic/Electroactive Polymer Hybrid compression garment 55004 is shown. The Hydraulic/Electroactive Polymer Hybrid garment 55004 comprises a fluid 55557 (water, gel etc.), such as in an elastomeric shell 55559, enclosed within and/or between two layers of electroactive polymer. The layers of electroactive polymer form electrodes 55555. Electroactive polymers (EAPs) are a type of flexible, elastic polymers (elastomer) that change size or shape when stimulated by an electric field. As illustrated in exploded view VI in FIG. 55, two arrays of EAPs of the electrodes 55555 enclose a viscous fluid. When electric forces (voltage differences) are applied by a CPG to opposed sections of the respective arrays, the elastomer changes shape and displaces the viscous fluid to compress a corresponding segment of the limb.

### 6.6.2 Acoustic Device

Another non-pneumatic implementation of a compression therapy system comprises a garment enclosed with a viscous fluid and a speaker. Sound waves generated through the speaker can displace the fluid such that a smooth compression waveform is created (similar to a wave pool).

6.7 CPG Device Algorithms (Diagnostic and Therapy Control)

The central controller 4230 (FIG. 5) of the CPG device 1002 may be implemented with algorithms in processes or modules to implement the functions of a therapy, diagnostics, and/or monitoring device such as for providing compression as part of a therapy or a diagnostics procedure with one or more of the compression garments. Such methodologies of the controller may implement Lymphedema therapy and/or Lymphedema monitoring. Any one or more of the following example process modules may be included.

### 6.7.1 Diagnostics Sensing/Monitoring Module(s)

Using the data from any of the sensors previously described, and optionally other user input from the control device, the central controller may be configured, such as with one or more detection or sensing module(s), to determine characteristics related to Lymphedema condition. For example, the controller may determine pneumatic impedance, pneumatic resistance, skin/body composition (e.g., fluid versus fat), skin density, skin temperature, bioimpedance, compression garment related volume (limb volume) and compression garment related strain (limb girth) in one or more monitoring sessions. Such measures may be determined and recorded over days, weeks, months, years, etc. As discussed in more detail herein, such determined characteristics may then serve as input to a therapy module to determine control parameters for setting and controlling a compression therapy session (e.g., type of therapy and settings of therapy). Such measures may also be communicated to a clinician and/or user via the control device and/or portal system for further evaluation.

6.7.1.1 Diagnostics Waveform (Pneumatic Impedance and/or Resistance)

In one example, the central controller may control operation of the blower of the CPG device in a diagnostic process for detection of swelling. The controller may also control operation(s) of one or more active valves when present such as to localize the diagnostic process to a particular zone of the compression garment. In such a process, the controller may generate a compression waveform (pneumatic) by operating the motor of the blower to pneumatically inflate one or more pneumatic chambers of the garment. Such a waveform may be a pressure waveform or a flow rate waveform that varies over a testing period, such as the waveform 23050 illustrated in FIG. 23C. For example, a controlled pressure waveform may be sinusoidal (e.g., a sine wave of a predetermined frequency and amplitude). Alternatively, a controlled flow rate waveform may be sinusoidal (e.g., a sine wave of a predetermined frequency and amplitude). Other waveform functions of frequency and amplitude may also be implemented (e.g., square wave, cosine wave, etc.) Such waveforms may be achieved by flow rate control or pressure control such as with any suitable closed loop control operation.

During, or immediately after, generation of such a waveform within a predetermined testing period, the controller may measure pneumatic pressure and/or flow rate over time with the sensors of the system. The system may use at least one set frequency, but optionally could use a range of frequencies. A typical frequency range may be 0.1 Hz to 20 Hz. The sensors sense the pneumatic characteristics of the air supplied to and/or received from the compression garment such as the compression garment's response to the generated waveform. Thus, these pneumatic characteristics concern the pressure garment and the condition of the user's limb within the garment. Discrete values for measured pressure and measured flow rate at a given instant in time may be evaluated, such as to determine a pneumatic impedance or pneumatic resistance from the pressure and flow rate values. For example, resistance may be determined by dividing instantaneous pressure by instantaneous flow rate. Impedance may be similarly determined along with considering phase difference between the pressure and flow rate. The impedance and/or resistance over the predetermined time period of the pneumatic test may then provide a signal that may be useful for assessing a swelling condition of the user's limb within the compression garment. Moreover, if the testing process has been localized to a particular zone of the garment, such as by activating, for example, valves to pressurize a lower portion of a compression garment, then the resulting signal concerns a particular portion of the user's limb. For example, if a compression garment has three zones (e.g., lower, middle and upper) that may be isolated by the controller setting the actives valves of the compression garment accordingly, the controller may conduct three testing processes to assess swelling in each zone (by determining the resistance or impedance signal). The determined signal(s) may be evaluated from multiple sessions to detect changes in swelling condition of the user. For example, the CPG device 1002 may be configured to perform such a diagnostic assessment of the particular zone(s) of a compression garment on a daily basis or each time the compression garment is used or several times during compression garment use. With such a signal(s), a display can provide information to a user (via a display such as of the CPG device 1002, control device or portal system) showing an amount of swelling as represented by, or as a function of, the impedance or resistance information as well as the localized areas of the swelling. For example, minor, average, or significant levels of swelling may be associated with various ranges of values of impedance or resistance. By assessing whether a determined value is in a particular range or has a particular value (such as by comparison with one or more thresholds), the associated level of swelling may be identified.

In some versions, an average from the signal (e.g., average resistance) may be recorded. The controller may be configured to evaluate such a value (or other value of resistance or impedance) over time to detect changes. For example, an increase in the signal (or value therefrom) over multiple sessions (such as determined by a comparison of a current value with a previous value or other such threshold), may be taken as an indication of an increase in swelling and a problem with the patient's condition. Such a comparison may trigger, in the controller, a warning to the user or clinician. In some versions, such a comparison may serve as a basis for the controller to increase or change a compression therapy parameter (e.g., higher pressure, a different therapy protocol, or a longer therapy). In this way the controller may implement a compression therapy that is adaptive to changing patient conditions. By way of further example, a decrease in the signal (or value therefrom) over multiple sessions (such as determined by a comparison of a current value with a previous value or other such threshold), may be taken as an indication of a decrease in swelling and an improvement with the patient's condition. Such a comparison may trigger, in the controller, an update or warning to the user or clinician. In some versions, such a comparison may serve as a basis for the controller to decrease or change a compression therapy parameter (e.g., decrease pressure, a different therapy protocol, or a shorter therapy).

In some such versions, the diagnostic process may be performed before providing a compression therapy session, during and/or after providing the compression therapy session. A change in the determined impedance or resistance from before and after, or within, the session, such as a decrease or increase, may be taken, respectively, as an indication that no further compression therapy is necessary or that additional compression therapy is necessary. Thus, the controller may apply the diagnostic periodically during a therapy session to assess when the therapy can be discontinued. The controller may continue therapy if an evaluation of the determined resistance or impedance suggests that further therapy is needed. Alternatively, the controller may discontinue therapy if the evaluation of the determined resistance or impedance suggests that no further therapy is needed.

In some versions, an initial assessment of the determined resistance or impedance may be evaluated to determine the time (duration) or number of repetitions of therapy to be provided. For example, the determined resistance or impedance may be part of a function of the controller to assess therapy time (duration) or repetitions for a particular zone associated with the determined resistance or impedance, which may then serve as a control parameter for the controller to control the therapy for such a determined duration or number of cycles. For example, the function may indicate a shorter therapy time for a certain resistance or impedance associated with a lesser swelling. The function of the controller may indicate a longer therapy time for a certain resistance or impedance associated with a greater swelling. Similarly, in some versions, depending on the level of resistance or impedance, the controller may select a different therapy protocol from the different available therapy protocols provided by the CPG device or repeat a therapy protocol cycle.

In some versions, the pneumatic related impedance or resistance measurement may serve in a function of the controller to derive a girth or volume estimate of the patient's limb. For example, with a known dimension (e.g., volume) of a compression garment (e.g., a cylindrical sleeve) or a zone thereof, the pneumatic related impedance or resistance measurement may provide a proportional indication of how the patient's swelling limb is occupying the volume of the compression garment, or portions of the compression garment on a zone by zone basis. For example, a level of resistance or impedance may serve to functionally scale the known volume of the compression garment. For example, a higher level of resistance or impedance may be taken as a higher level of occupation of the known volume and a lower level of resistance or impedance may be taken as a lower level of occupation of the known volume. Such a relationship may be derived empirically and be adjusted on a garment-by-garment basis. Thus, with the measured resistance or impedance, such as on a zone by zone basis in the compression garment, the controller may provide a girth or volume estimate (e.g., on a zone by zone basis) as an output measure for different portions of a limb, such as on a display of the CPG device 1002, control device or portal system, that can inform the user or clinician, of the nature of the patient's Lymphedema condition, and progression of the Lymphedema condition when determined over a number of sessions or even a given session. Optionally, such a functional determination of volume or girth may also or alternatively be implemented by the controller with a measurement(s) from a tension sensor or a strain gauge or other similar strain sensor when the compression garment includes such sensor(s).

### 6.7.1.2 Diagnostics Waveform (Bioimpedance)

Although the aforementioned processes by the controller are based on a determination and/or assessment of pneumatic impedance or resistance from pneumatic sensing, the controller may alternatively, or in addition thereto, evaluate the patient's condition, and may additionally respond with therapeutic changes and/or information messages, by assessment of skin or body composition such as by measurements from a set of electrodes 23500 of a compression garment 23004-D as shown in FIG. 23D. Such responses of the controller may be similar to the processes previously described. For example, by measuring and evaluating skin impedance (electrical bioimpedance that may depend on body/skin composition) using the electrodes 23500, the controller may determine a measure indicating condition of a user's Lymphedema. For example, such measurements may vary depending on the nature of fluid retention in a limb zone of the compression garment. Thus, such measurements may serve as a marker of disease progression, such as an indication of tissue fibrosis, hardening and fluid retention.

Thus, the controller may have a control module for such a process to make such measurements to provide an indication of swelling. For example, electrical bioimpedance of a particular part of a body may be estimated by measuring the voltage signal developed across a body part by applying a current signal (e.g., a low amplitude low frequency alternating current which may be sinusoidal or pulsed) to the body part via a set of electrodes (e.g., two or more of the compression garment). The bioimpedance may be measured by dividing the measured voltage signal (V) by the applied current signal (I). Bioimpedance (Z) can be a complex quantity and it may have a particular phase angle depending on the tissue properties. Thus, evaluation of the bioimpedance (e.g., magnitude and/or phase angle) may involve the controller comparing measured bioimpedance to one or more thresholds for detection of condition of the skin/body composition in relation to the potential for swelling. Such measurements may be made periodically and provide, through their evaluation by the controller (e.g., threshold comparison(s)), a diagnostic parameter for the controller to generate information characterizing the nature of swelling (e.g., high, medium or low) or Lymphedema (e.g., displayed information and warnings) and/or to control therapy changes. Thus, such an evaluation (e.g., an indication of increased fluid content or swelling) may serve as a basis for the controller to increase or change a compression therapy parameter (e.g., higher pressure, a different therapy protocol, or a longer therapy). Similarly, such an evaluation (e.g., an indication of decreased fluid content or swelling) may serve as a basis for the controller to decrease or change a compression therapy parameter (e.g., lower pressure, a different therapy protocol, or a shorter therapy). Such a process may be similar to the process previously described in relation to the assessment of pneumatic impedance/resistance.

For example, the controller may be configured to evaluate such a bioimpedance value (or values) over time to detect changes. For example, an increase in the values over multiple sessions (such as determined by a comparison of a current value with a previous value or other such threshold), may be taken as an indication of an increase in swelling and a problem with the patient's condition. Such a comparison may trigger, in the controller, a warning to the user or clinician. In some versions, such a comparison may serve as a basis for the controller to change or increase a compression therapy parameter (e.g., higher pressure, a different therapy protocol, or a longer therapy). Similarly, a decrease in the values over multiple sessions (such as determined by a comparison of a current value with a previous value or other such threshold), may be taken as an indication of a decrease in swelling and an improvement with the patient's condition. Such a comparison may trigger, in the controller, an update or warning to the user or clinician. In some versions, such a comparison may serve as a basis for the controller to change or decrease a compression therapy parameter (e.g., lower pressure, a different therapy protocol, or a shorter therapy).

In some such versions, the diagnostic process may be performed before providing a compression therapy session during and/or after providing the compression therapy session. A change in the determined bioimpedance from before, during and/or after the session, such as a reduction or increase, may be taken respectively as an indication that no further compression therapy is necessary or that additional compression therapy is necessary. Thus, the controller may apply the diagnostic periodically during a therapy session to assess when the therapy can be discontinued. The controller may continue therapy (e.g., repeat a cycle of therapy) if an evaluation of the determined bioimpedance suggests that further therapy is needed. Alternatively, the controller may discontinue therapy if the evaluation of the determined impedance suggests that no further therapy is needed.

In some versions, an initial assessment of the determined bioimpedance may be evaluated to determine the time (duration) of therapy or number of cycles to be provided. For example, the determined bioimpedance may be part of a function of the controller to assess therapy time for a particular zone associated with the determined bioimpedance, which may then serve as a control parameter for the controller to control the therapy for such a determined duration or a number of cycles that may achieve the therapy time. For example, the function may indicate a shorter therapy time or fewer cycles for a certain bioimpedance associated with a less swelling. The function of the controller may indicate a longer therapy time or more cycles for a certain bioimpedance associated with a greater swelling. Similarly, in some versions, depending on the level of bioimpedance, the controller may select a different therapy protocol from the different available therapy protocols provided by the CPG device 1002 or repeat a therapy protocol cycle.

### 6.7.1.3 Diagnostics (Temperature)

The CPG device 1002 and/or any of the compression garments of the present disclosure may include one or more temperature sensors. One or more measurements from any of such temperature sensors may inform the controller about the Lymphedema condition of a user. Thus, the controller may be configured to evaluate temperature measure(s), such as in comparison to one or more thresholds, in providing information to the user or clinician, via a monitor of the CPG device 1002, the control device, and/or the portal system. Similarly, the controller may evaluate temperature measure(s), such as in comparison to one or more thresholds, for adjusting one or more therapy control parameters based on the determined temperature. For example, the controller may be configured to evaluate temperature associated with the condition of the user's skin from any of the sensor measures or zones of the compression garment. The controller, based on the evaluation, may be configured to suspend a therapy, reduce a therapy time, increase a therapy time, increase or reduce a therapy pressure, change a compression protocol or type of therapy, such as in the particular zone of the temperature measure or for all zones of the compression garment. For example, an increase or decrease in temperature (such as determined by comparison between one or more measurements from the temperature sensor and one or more thresholds) may be taken as an indication of a bacterial infection or elimination of a bacterial infection. Such a detection may trigger the controller to send a warning to the user or clinician. Such a detection may also trigger the controller to suspend or reduce a compression therapy, such as in the particular zone of detection, or initiate a compression therapy (e.g., of a lesser or higher than usual pressure in the zone of detection) or initiate a compression therapy so as to control the compression therapy in zones of the compression garment(s) that are not associated with the detected temperature increase or decrease. Other adjustments to the control of the compression therapy based on detected temperature may also be implemented by the controller.

### 6.7.1.4 Diagnostics (Limb Circumference)

As previously mentioned, the CPG device 1002 and/or any of the compression garments of the present disclosure may include one or more tension sensors (e.g. dielectric elastomer sensors) and/or strain sensors. One or more measurements from any of such sensors may inform the controller about the limb circumference (e.g., girth). Thus, the controller may be configured to evaluate limb circumference measure(s), such as in comparison to one or more thresholds, in providing information to the user or clinician, via a monitor of the CPG device 1002, the control device, and/or the portal system. Similarly, the controller may evaluate limb circumference measure(s), such as in comparison to one or more thresholds, for adjusting one or more therapy control parameters based on the determined circumference. For example, the controller may be configured to evaluate limb circumference from any of the sensor measures or zones of the compression garment. The controller, based on the evaluation, may be configured to suspend a therapy, reduce a therapy time, increase a therapy time, increase or reduce a therapy pressure, change a compression protocol or type of therapy, such as in the particular zone of the limb circumference measure or for all zones of the compression garment.

### 6.7.1.5 Diagnostics (Ultrasound)

One or more of the compression garments of the present disclosure may be configured with ultrasound transducers that are connected to the CPG device 1002 via electrical lines of the link 1006. One or more measurements from any such transducers may inform the controller about the Lymphedema condition of a user. Ultrasound sensing is capable of providing deep tissue information such as deeper lymphatic structures and how well fluid is draining.

### 6.7.2 Therapy Modes Module(s)

The controller of the CPG device 1002, such as central controller 4230, may be configured to select between different therapy operations modes depending on which compression garment(s) of the present disclosure is/are connected to the CPG device 1002 and/or based on the conditions detected by the sensor. Such modes may depend on the number of zones of active valves coupled to the system. Such mode selections may be implemented by the controller in conjunction with clinician or user input (e.g., manual settings of the user interface of the CPG device and/or control device and/or transmitted from a portal system) and measurements from the sensors as previously described. Example control parameters of the controller that may be adjusted include, for example, the type (protocol) of compression therapy, pressure setting parameters, pressure waveform parameters, valve activation parameters such as for activation of zones at different times, and therapy time parameters. Examples of types of compression therapy are described in more detail herein.

### 6.7.2.1 Applicator Manipulation Therapy

In some versions, the CPG device 1002 may be configured with a control protocol for control of one or more compression garments to provide an applicator manipulation therapy. Such a Lymphedema therapy may be considered in relation to FIG. 23A. As illustrated, a compression garment 23004-A is configured with multiple zones Z1, Z2, Z3, Z4 (e.g., active valve and/or passive valve areas) that may be separately activated by the controller of the CPG device 1002 (electrically and/or pneumatically). These zones Z1, Z2, Z3, Z4 may include one or more applicator(s) 23424 as previously discussed. The compression garment 23004-A can include fewer or more such zones and fewer or more such applicators 23424.

To provide the applicator manipulation therapy, the controller may selectively activate the blower and/or valves to produce compression (e.g., vibrations) in a desired directional manner so as to induce a desired movement of the applicator on the patient's skin with sequential pressurization of the pneumatic chambers. One example of applicator manipulation provides a massage therapy that emulates the manual massage performed by physical therapists on lymphedema patients. In such an example, the controller may set the motor of the blower so that the CPG device 1002 produces a positive pressure according to a pressure setting (e.g., a predetermined pressure or a pressure determined based on a previous evaluation of sensor data). The controller may then actively inflate a first zone (e.g., Z1) by activating its valve(s) (open) to direct the pressurized air to the pneumatic chamber(s) of the zone. Such a pressure may optionally be varied by the controller according to a pressure waveform (e.g., sinusoidal or other) to induce a vibratory pressure inflation/deflation wave in the first zone. Such a pressure waveform may optionally be achieved by increasing and decreasing motor current of the blower and/or by opening and closing of the first zone active valve(s). This inflation/deflation permits the applicator to move to provide a localized force into the patient's skin responsive to the inflation/deflation. During this time, the controller may refrain from adjusting the active valves of other zones of the compression garment. Such control operations with the first zone may operate for a predetermined time (such as a fraction of the total desired therapy time.)

After the predetermined time, such a pressure control of the first zone may cease, such as by closing the active valves of the zone to maintain pressure in the zone or allowing the zone to deflate (e.g., partially to a second but lower positive pressure or completely to ambient pressure). The controller may then begin a similar pressurization routine with another zone, such as the next neighbouring zone (Z2) of the first zone. This may repeat the control as described with reference to the first zone but controlling the valves of the neighbouring zone over a second predetermined time, which may be approximately equal to the first predetermined time. In this manner, the controller may sequentially activate the zones of the compression garment 23004-A in a predetermined order (e.g., first Z1, then Z2, then Z3, then Z4 etc.) Preferably, such an ordering of control by the controller of the different zones of the compression garment 23004-A provides a sequential progression applying the applicator along the limb of the patient toward the trunk of the patient as a therapy. Thus, the zones may be sequentially activated toward a trunk end (e.g., closer to the patient's trunk) of the compression garment (e.g., away from an extremity end (further from the patient's trunk) of the compression garment).

This process may be repeated by the controller so that the therapy may cycle through each of the zones any number of times. Such a number of repetitions may be set as a control parameter for the therapy such as by a manual input to the CPG device 1002. Optionally, such repetition of a cycle of the applicator manipulation therapy may be based on the controller determining the presence of a certain level of swelling such as with any of the previously described diagnostic processes. For example, any one or more of the resistance, impedance, bioimpedance, girth, volume, skin/body composition, etc. sensing measures may be determined and evaluated by the controller after a cycle of therapy and the evaluation may trigger a repeat of the cycle or a termination of the therapy session. Similarly, the controller may determine whether to adjust the applied compression pressure level(s), such as to be higher, lower, or the same pressure level(s) depending on the evaluation of the sensor measurements. As previously mentioned, such repeated cycles may be controlled to be repeated for one, several or all of the zones of the garment depending on the measurement results of each zone.

Optionally, such a massage therapy protocol may be provided by the controller as described with a compression garment that does not include any applicator.

### 6.7.2.2 Gradient Therapy

In some versions, the CPG device 1002 may be configured with a control protocol for control of one or more compression garments to provide a gradient therapy such as by controlling the valves of multiple zones to provide a pressure compression gradient that may be static for a desired therapy time. Such a Lymphedema therapy may be considered in relation to FIG. 23B. As illustrated, a compression garment 23004-B is configured with multiple zones Z1, Z2, Z3, Z4, Z5, Z6, Z7 (e.g., active valve and/or passive valve areas) that can be separately activated by the controller of the CPG device 1002 (electrically and/or pneumatically). These zones Z1, Z2, Z3, Z4, Z5, Z6, Z7 may optionally include one or more applicator(s) as previously discussed. The compression garment 23004-B may have fewer or more such zones. In such an exemplary therapy protocol, the controller may be configured to set the pressure of the zones to different levels, such as a different level in each zone. Thus, the controller may be configured to set a first pressure in a first zone, a second pressure in a second zone, a third pressure in a third zone, etc. These set pressures may be different pressure levels (e.g., have a different positive pressure value in some or all of the zones). Optionally, such pressures may be set so as to enforce a pressure compression gradient across a plurality of zones of a compression garment. For example, the third pressure may be greater than the second pressure, and the second pressure may be greater than the first pressure, etc. Optionally, such a gradient (increasing or decreasing) may be set in the compression garment 23004-B so that its increase or decrease extends along the length of the user's limb. Such an increase set by the controller over the different zones of the compression garment 23004-B can provide the gradient 23400 so that the pressure decreases along the limb of the patient toward the trunk of the patient or toward a trunk end of the compression garment 23004-B. Thus, the higher pressures may be in the lateral portion of the limb (further from the trunk) and the lower pressures may be in the medial portion of the limb (closer to the trunk). Alternatively, the controller may set such a gradient with a pressure decrease in the different zones of the compression garment 23004-B so that the pressure increases along the limb of the patient toward the trunk of the patient or the trunk end of the compression garment 23004-B.

In one example to provide the gradient therapy, the controller may be configured with a module or process that sets the zones to the gradient. For example, the controller may selectively activate the blower and/or valves to produce a pressure compression gradient by pressurization of the pneumatic chambers. In relation to the example compression garment illustrated in FIG. 23B, upon activation of the blower or CPG device 1002, the controller may initially control the blower motor, such as in a pressure control loop, at a first pressure setting. During this time, the controller may direct a flow of pressurized air to a first zone, such as first zone Z1, by controlling an opening of one or more active valves associated with the first zone Z1. When the measured pressure achieves the desired level associated with the first pressure setting, the controller may then control the one or more active valves associated with the first zone Z1 to close. This may permit the first pressure to be maintained in the pneumatic chamber(s) of the first zone Z1.

Next, the controller may control the blower motor, such as in a pressure control loop, at a second pressure setting that is higher than the first pressure setting. During this time, the controller may direct a flow of pressurized air to a second zone, such as second zone Z2, by controlling an opening of one or more active valves associated with the second zone Z2. When the measured pressure achieves the desired level associated with the second pressure setting, the controller may then control the one or more active valves associated with the second zone Z2 to close. This may permit the second pressure to be maintained in the pneumatic chamber(s) of the second zone Z2.

This process may be repeated to set the pressure in each succeeding zone (e.g., zone Z3 to zone Z7) to a higher pressure than the preceding zone, until the pressure is set in each zone according to the desired gradient. Optionally, the CPG device 1002 may be disengaged once the zones have been set at the desired pressure levels. The CPG device 1002 may then permit this pressure gradient therapy state to be maintained for a predetermined therapy time or some modified time in relation to the diagnostics process(es) as previously described that may optionally be engaged by the controller and the sensors to adjust the therapy time. Upon expiration of the therapy time as evaluated by an internal processing clock of the controller, the controller may then control the valves of all of the pressurized zones of the compression garment 23004-B to open to release the compression pressure in each of the zones Z1-Z7. Optionally, such a gradient therapy process may be repeated any desired number of times, with a predetermined period of rest (depressurization) between each pressurization cycle that achieves the desired gradient.

Thus, the gradient therapy cycle may be repeated by the controller so that the therapy may be provided any number of times for a therapy session. Such a number of repetitions may be set as a control parameter for the gradient therapy such as by a manual input to the CPG device 1002. Optionally, such repetition of a cycle of the gradient therapy may be based on the controller determining the presence of a certain level of swelling such as with any of the previously described diagnostic processes. For example, any one or more of the resistance, impedance, bioimpedance, girth, volume, skin/body composition, etc. sensing measures may be determined and evaluated by the controller after a cycle of gradient therapy and the evaluation may trigger a repeat of the cycle or termination of the therapy session. Similarly, the controller may determine whether to adjust the applied compression pressure gradients (e.g., the high and low and intermediate steps, such as to be higher, lower or at the same pressure level(s)) depending on the evaluation of the sensor measurements. As previously mentioned, such repeated cycles, may be controlled to be repeated for several or all of the zones of the garment depending on the measurement results of each zone.

### 6.7.2.3 Adaptive Lymphatic Drainage Therapy

In some versions, the CPG device 1002 may be configured with a control protocol for control of one or more compression garments in an Adaptive Lymphatic Drainage therapy mode. The Adaptive Lymphatic Drainage therapy mode includes two phases—a Lymph Unload Phase and a Clearance Phase—and is designed to emulate Manual Lymphatic Drainage therapy as performed by a therapist. The aim of the Lymph Unload Phase is to clear the proximal lymph vessels, such that fluid from the distal areas can be received and ultimately transported through to the circulatory system. To achieve this, the compression garment may comprise a number of sections, such as where each section may have one or more zones.

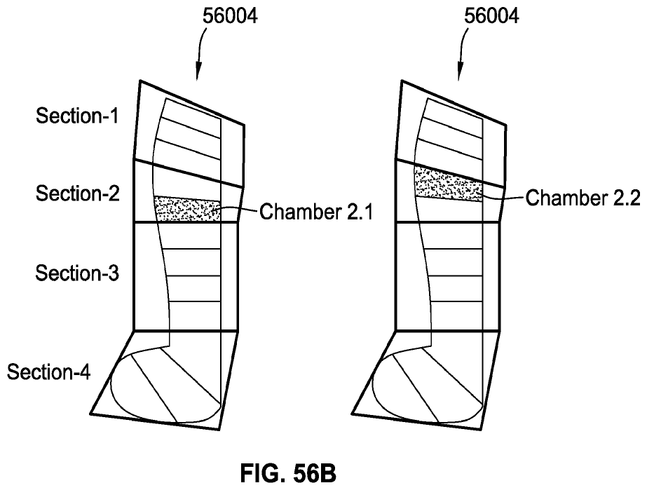

For example, referring to FIGS. 56A and 56B, a compression garment 56004 includes four discrete sections (zones), with each section comprising a grouping of air chambers. FIG. 56A illustrates activation of a one section (e.g., the first section) and FIG. 56B illustrates activation of another section (e.g., the second section). The Lymph Unload phase begins with the most proximal section (Section 1 in FIG. 56A), where an oscillatory compression waveform traverses through the chambers in the order illustrated. Chamber 1.1 will be pressurized first and then chamber 1.2 will follow. As chamber 1.2 is pressurized, chamber 1.1 will be deflated and chamber 1.3 will follow. Following Section 1, the same process is repeated on Section 2. An example oscillatory waveform being successively applied to chambers 1.1, 1.2, and 1.3 is illustrated in the bottom section of FIG. 56A. One aim of this oscillatory waveform is to maximise the level of stimulation provided to the lymph vessels, such that fluid transport can be encouraged. As illustrated, in this phase, control of each successive section advances (e.g., section-by-section) in a distal (e.g., downward) direction (e.g., section 1 to section 4), while control of each successive chamber within each section advances (e.g., chamber-by-chamber) in a proximal (e.g., upward) direction (e.g., chamber 1 to chamber 3). In such examples, a proximal direction may be a direction along a part of a user (e.g., limb) toward the user's heart and a distal direction may be a direction along a part of a user (e.g., limb) away from the user's heart.

Following the Lymph Unload phase, the Clearance phase will begin, with the same waveforms being applied, this time progressing from pressurizing distal sections to pressurizing proximal sections. Thus, in this phase, control of each successive section advances (e.g., section-by-section) in a proximal (e.g., upward) direction (e.g., section 4 to section 1), while control of each successive chamber within each section advances (e.g., chamber-by-chamber) in a distal (e.g., downward) direction (e.g., chamber 3 to chamber 1). Table 1 provides an example control protocol of how this may occur.

TABLE 1
Order of pressurization of sections and chambers
during Adaptive Lymphatic Drainage Therapy

| | | |
|---|---|---|
| Time Point | Section | Chamber |
| (Arbitrary) | Pressurized | Pressurized |

Lymph Unload Phase

| | | |
|---|---|---|
| 1 | 1 | 1.1 |
| 2 | 1 | 1.2 |
| 3 | 1 | 1.3 |
| 4 | 2 | 2.1 |
| 5 | 2 | 2.2 |
| 6 | 3 | 3.1 |
| 7 | 3 | 3.2 |
| 8 | 3 | 3.3 |
| 9 | 3 | 3.4 |
| 10 | 4 | 4.1 |
| 11 | 4 | 4.2 |
| 12 | 4 | 4.3 |

Clearance Phase

| | | |
|---|---|---|
| 13 | 4 | 4.3 |
| 14 | 4 | 4.2 |
| 15 | 4 | 4.1 |
| 16 | 3 | 3.4 |
| 17 | 3 | 3.3 |
| 18 | 3 | 3.2 |
| 19 | 3 | 3.1 |
| 20 | 2 | 2.2 |
| 21 | 2 | 2.1 |
| 22 | 1 | 1.3 |
| 23 | 1 | 1.2 |
| 24 | 1 | 1.1 |

The time spent pressurizing each section and chamber, and the number of cycles through each phase, may be determined in different ways. One method pressurizes each chamber for 10 seconds and repeats the Lymph Unload phase 5 times, before progressing to the Clearance phase. Alternatively, an adaptive and/or dynamic method receives diagnostic data on the limb condition (e.g., from sensors of the system), such as limb volume, limb girth, etc., allowing the method to adapt the pressure response as well as the timing. For example, if after the Lymph Unload phase the sensor data suggests that limb volume has gone down sufficiently, the adaptive method could immediately move to the Clearance phase. Alternatively, the adaptive method could cycle through the Lymph Unload phase several more times before progressing to the Clearance phase. In this way, the adaptive method may adapt the level of pressure required and the time spent in each chamber, section, and phase of therapy depending on the patient condition.

### 6.7.2.4 Walk Mode

Often when patients have completed their massage therapy session and/or want to disconnect from the CPG device 1002, for example, in order to resume their daily routine, they require a degree of static compression in order to ensure that lymphatic fluid doesn't come back into the extracellular space. To achieve this, a walk mode therapy pre-inflates the compression garment to allow the patient to seamlessly continue with their routine without having to remove their compression garment and change to another, passive garment. The pre-inflate pressure(s) and/or pressure gradient may be predetermined or customizable as per the patient's needs as previously described.

### 6.7.3 Control Module

In some implementations of the present disclosure, the therapy device controller 4240 (shown in FIG. 5) receives as an input a target compression pressure Pt, such as per zone, and controls the therapy device 4245 (FIG. 5) to deliver that pressure in relation to a control of one or more active valves. The pressure may be delivered to all of the zones of the compression garment simultaneously or separately according to the timing of the operations of a valve control algorithm (e.g., diagnostic sensing or therapy control protocol) of the controller as described herein.

### 6.7.4 Detection of Fault Conditions

Optionally, in one form of the present technology, the central controller 4230 (FIG. executes one or more methods for the detection of fault conditions. The fault conditions detected by the one or more methods may include at least one of the following:
Power failure (no power, or insufficient power)
Transducer fault detection
Failure to detect the presence of a compression garment component
Operating parameters outside recommended or plausible sensing ranges (e.g. pressure, flow, temperature)
Failure of a test alarm to generate a detectable alarm signal.

Upon detection of the fault condition, the corresponding algorithm signals the presence of the fault by one or more of the following:
Initiation of an audible, visual and/or kinetic (e.g. vibrating) alarm
Sending a message to an external device
Depressurizing the compression garment (e.g., opening the valves and/or evacuating the pneumatic chambers).
Logging of the incident

According to another aspect of the present technology, the central controller 4230 omits a software module for detecting fault conditions. Rather, as discussed earlier, the detection of fault conditions may be handled exclusively by the fault mitigation integrated circuit that is separate from the central controller 4230. In some cases, the fault mitigation integrated circuit may serve as a redundant backup to similar fault detection/mitigation module with algorithms processed also within the central controller.

6.8 Control Device Application

The system 1000 may include a control device 1010 (FIG. 1) (e.g., a mobile phone or tablet computer) for running an application concerning operations with the CPG device 1002 and use of one or more compression garments of the present disclosure (e.g., compression garment 1004). Thus, the control device 1010 may include integrated chips, a memory and/or other control instruction, data or information storage medium for such an application. For example, programmed instructions or processor control instructions encompassing the operation methodologies of the control device described herein may be coded on integrated chips in the memory of the device or apparatus to form an application specific integrated chip (ASIC). Such instructions may also or alternatively be loaded as software or firmware using an appropriate data storage medium. Optionally, such processing instructions may be downloaded such as from a server over a network (e.g. the Internet) to the processing device such that when the instructions are executed, the processing device serves as a screening or monitoring device. Thus, the server of the network may also have the information storage medium with such instructions programmed instructions or processor control instructions and may be configured to receive requests for downloading and transmitting such instructions to the control device. In some versions, a portal system described herein may be such a server.

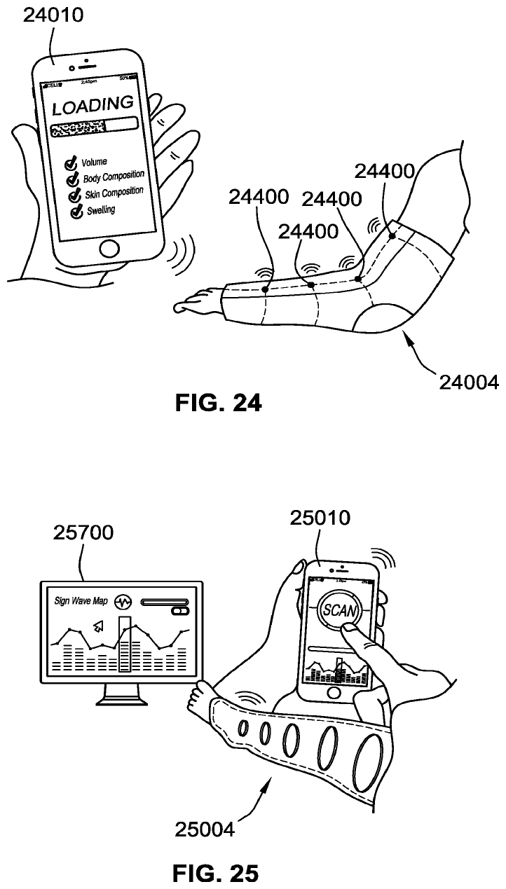

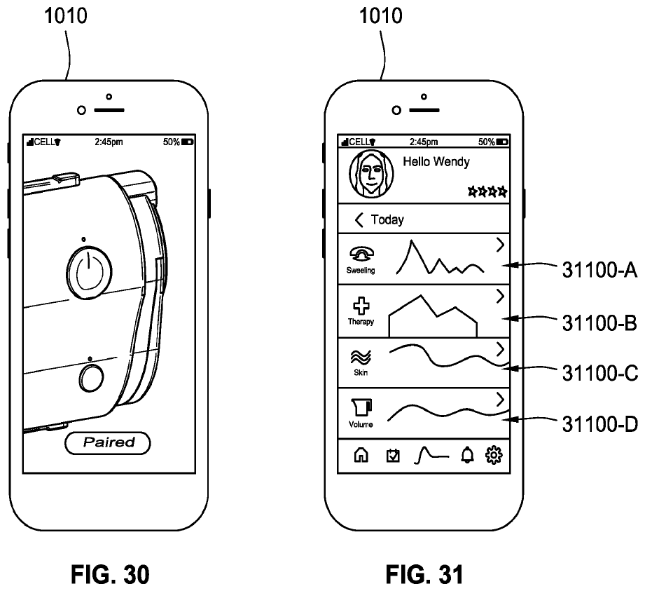

Example operations with such an application of the control device may be considered in reference to FIGS. 24 through 43. For example, as illustrated in FIG. 30, the control device 1010 may generate a pairing screen to wirelessly pair the control device for wireless communications with a CPG device and/or with sensors or other system components of a compression garment.

Referring to FIG. 24, a control device 24010 (the same as or similar to the control device 1010) may communicate (e.g., wirelessly) with one or more sensors of the system 1000 (FIG. 1), such as sensors 24400 of a compression garment 24004 or the CPG device 1002 (FIG. 1) to receive data. Such data includes pressure, body composition, skin health, girth, volume, swelling, impedance, resistance, temperature and/or bioimpedance, or any combination thereof, and such data may be displayed on the display of the control device 24010 and/or a display of the CPG device 1002.

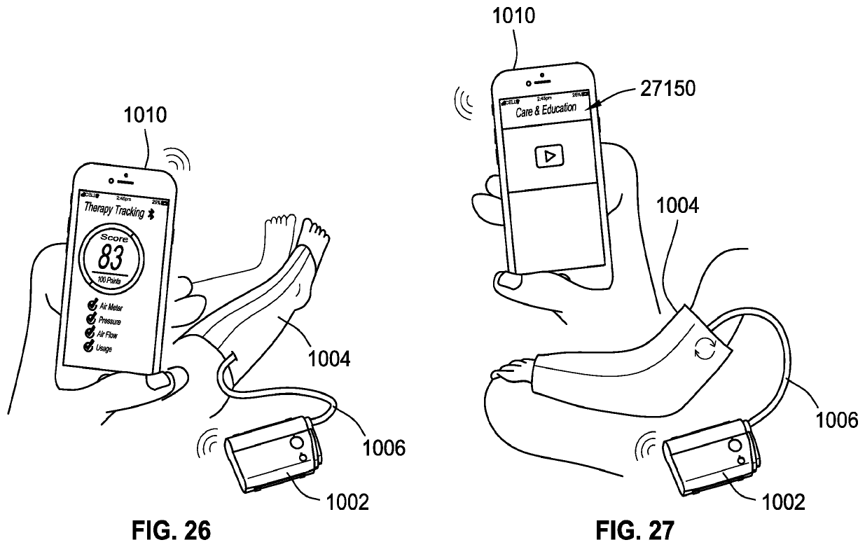

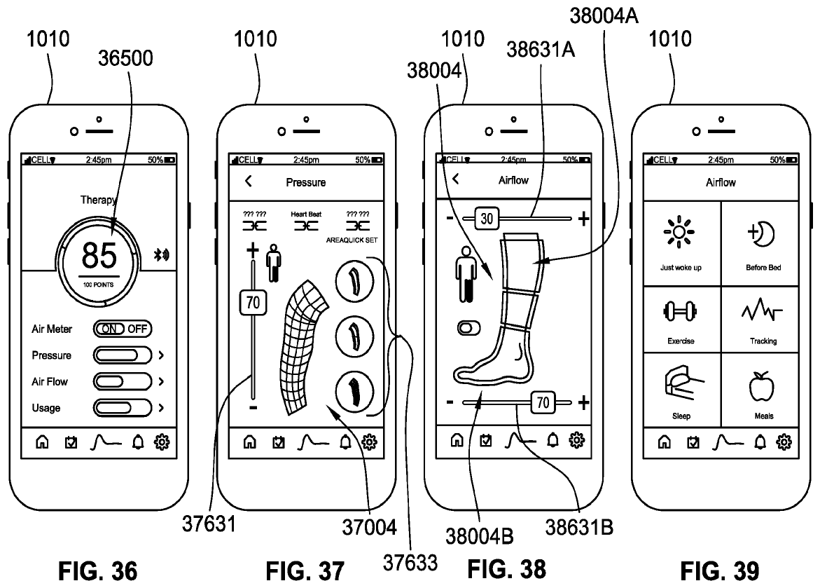

Referring to FIG. 26, data and/or information may be di splayed for each session or it may be displayed as a trend over multiple days/sessions, weeks, months etc., of use of the compression garment 1004. The data may be evaluated over time for adjustments to therapy, such as to personalize the compression therapy (e.g., therapy time, number of cycles, pressure levels, etc.), which may be input to the CPG device 1002 via the control device 1010. The control device 1010 may also display usage information such as number of compression sessions, type of therapy, time of therapy, number of cycles. Such usage information which may also be presented in a trend or diary fashion over days, weeks, months, years, etc. Usage information may also be logged with a tagging interface illustrated in FIG. 39. Another display of such information is illustrated in the example of FIG. 36 which shows a compression therapy score 36500 that can represent an evaluation of the user's therapy to provide a combined indication of compression pressure and usage time and/or one or more other metrics. For example, as illustrated in FIG. 31, the user interface of the control device 1010 can graphically present a daily display with a graph of swelling versus time data 31100-A, a graph of therapy use versus time 31100-B, a graph of skin composition (e.g., density or fluid retention) versus time 31100-C, a graph of limb volume versus time 31100-D, or any combination thereof.

Referring to FIG. 27, the control device 1010 may present Lymphedema therapy and related health information 27150 to the user, such as instruction videos for use of the system 1000 with its compression garment 1004. Another version of such a user interface of the control device 1010 is illustrated in FIG. 41 such as for accessing and receiving coaching and education resources.

Referring to FIG. 29, a virtual presentation may be presented on the control device 1010. For example, the control device 1010 may present the user with a view of the compression garment 1004-V and show the pressure settings of each of the zones of the compression garment 1004-V as they change during a compression therapy session. Similarly, the control device 1010 may provide a virtual presentation on how to set up and use the CPG device 1002-V and/or the compression garment 1004-V with the link 1006-V and the interface 1008-V.

Referring to FIG. 25, the control device 25010 may generate periodic reminders (e.g., daily, weekly, monthly) to the user to use the compression garment 25004 for any of the diagnostic assessments described herein. For example, the control device 25010 may then provide a user control (e.g., button) on the user interface (e.g., display) of the control device 25010 that, when activated, initiates a process of the CPG device 1002 (FIG. 1) with the compression garment 25004 (such as via a wirelessly communicated control signal) to perform a diagnostic process such as the waveform assessments(s) previously described or any of the measurements previously described. The measurements may then be communicated to the control device 25010, which may then evaluate the measurement(s) such as in the processor of the control device 25010, so as to generate an assessment of the Lymphedema condition of the user. Optionally, such measurements and/or assessment may be communicated to a portal system 25700 described in more detail herein. The control device 25010 may then provide the user with evaluation information and instructions or warnings indicated by the evaluation of the Lymphedema condition. The control device 25010 may then prompt the user with a further user interface control (e.g., button) on the display to initiate a compression therapy session selected by the control device. Activation of the control on the control device 25010 by the user may then communicate a control signal (e.g., wireless) to the CPG device 1002 (FIG. 1) to start a compression therapy protocol controlled by the CPG device 1002, such as the any one or more of the protocols described herein.

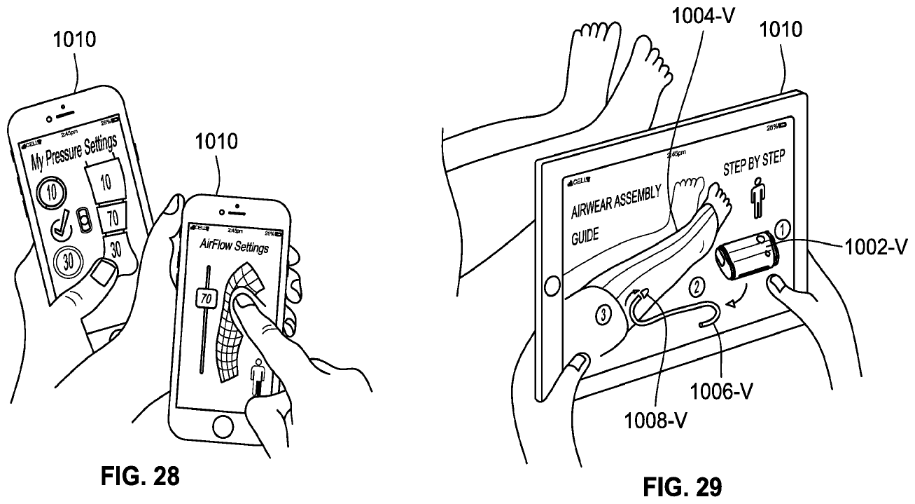

Referring to FIG. 28, the control device 1010 may also provide a user interface so that a user can adjust the settings of the CPG device 1002 (FIG. 1) and a compression garment (e.g., 1004) for therapy. For example, the user can set pressure levels (e.g., maximum and minimum comfort levels), such as on a zone by zone basis or for all of the zones of a compression garment. The user can set therapy times and cycle repetitions. Such settings may then be communicated to the CPG device 1002 from the control device 1010. The CPG device 1002 may then provide therapy in accordance with the settings provided from the control device 1010.

Another example of such a user interface control is illustrated in FIG. 37 which provides a compression pressure slider control 37631 that may operate in conjunction with one of a group of zone selection buttons 37633 corresponding to the various zones of a compression garment 37004 to set a desired compression pressure level. In the example of FIG. 38, different pressure setting sliders 38631A, 38631B are presented for different zones 38004A, 38004B, respectively, of a compression garment 38004.

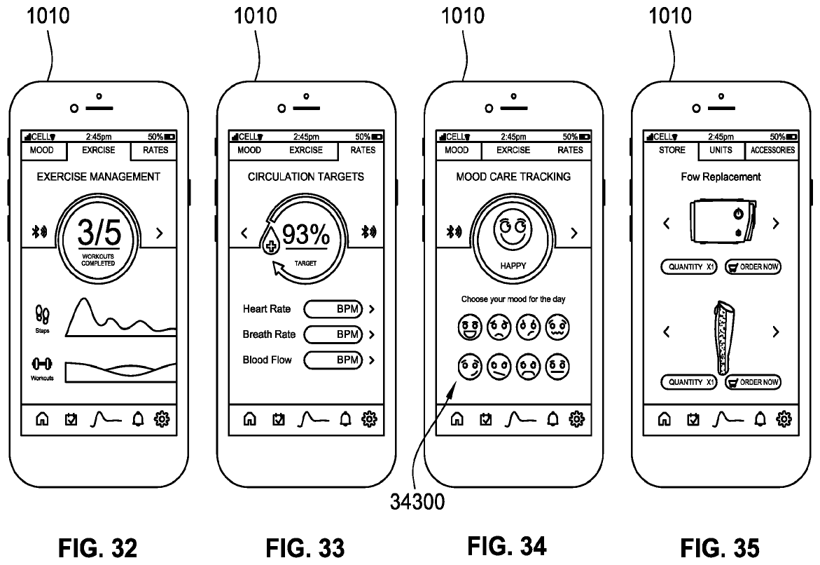

Optionally, the control device 1010 may organize information in various additional user interface presentations such as illustrated in FIGS. 32, 33, and 34. For example as shown in FIG. 32, the control device 1010 may serve as a log of exercise information, such as steps taken on a daily basis, in relation to its correspondence with therapy session information, to show improved mobility progression with provided compression therapy. The compression therapy application of the control device 1010 may similarly track circulation information, such as illustrated in FIG. 33, including, for example, achievement of targets for heart rate, breath rate and/or blood flow information that may be derived from suitable sensors that may communicate with the system. As shown in FIG. 34, the control device 1010 may also serve as a mood tracker with a mood input user interface 34300 to log mood trends. FIG. 35 illustrates a user interface of the control device 1010 application that may serve as an online store/purchasing interface for remotely ordering or purchasing additional components for the compression therapy system.

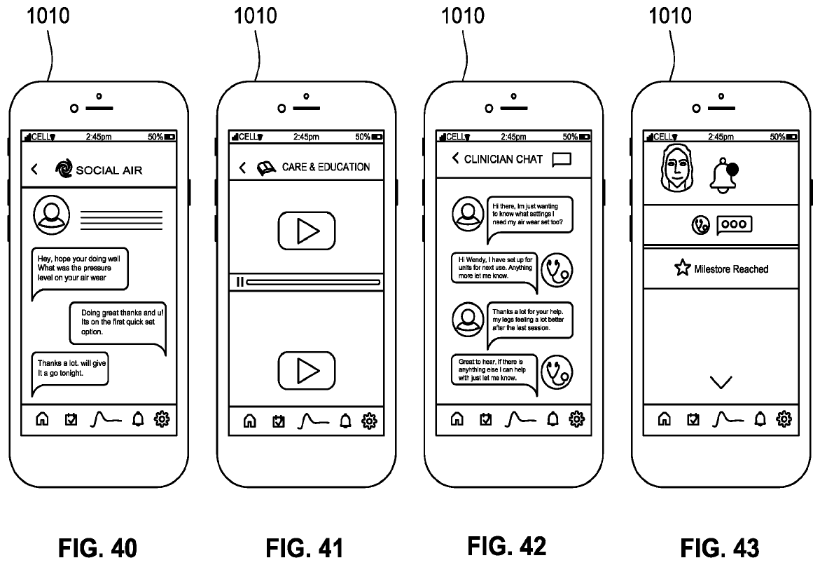

The application of the control device 1010 may also provide a communication function. Thus, the control device 1010 may present, such as illustrated in FIG. 40, a user interface for accessing and communicating with a community of users having a similar compression therapy system and Lymphedema condition such as for sharing information amongst peers. The control device 1010 may present a user interface for direct chat-based communications with Lymphedema clinical professionals as shown in FIG. 42. A notification center of the application, as shown in FIG. 43, can present status messages with information, such as goal achievement (e.g., use goals, mobility goals, etc.) messages as well update on chat conversations, etc.

6.9 Portal Management System

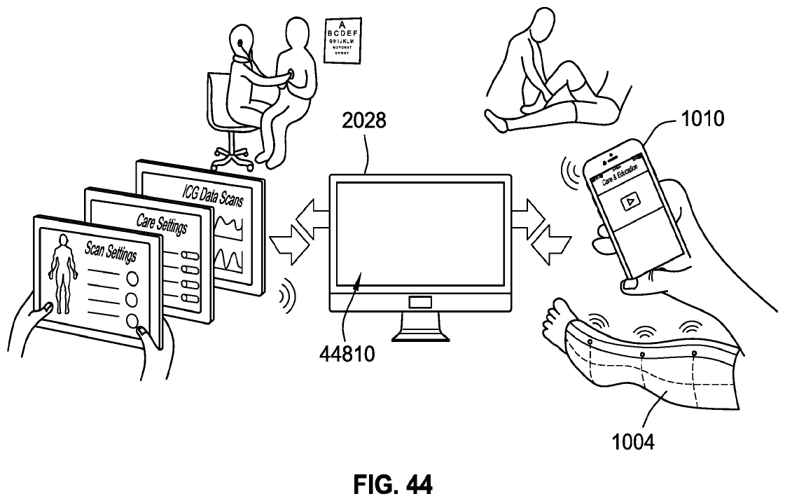

A portal system 2028 (FIG. 2) may be implemented, such under the control of a clinician or provider, to manage a population of users of compression therapy systems. Configuration and operations of such a portal system 2028 may be considered in relation to FIGS. 44-54. Referring to FIG. 44, a clinician or other provider (e.g., health care provider) can serve multiple patients such as by screening patients by medical check-up and prescribing treatment with compression therapy systems 1000 (FIG. 1). For example, the provider may test a patient using a diagnostic process of a compression therapy system described herein and such testing data along with patient identification information may be uploaded to the portal system server application 44810. Clinical data and therapy information from continued use of the system 1000 by the patients can also be uploaded to the portal system 2028 as previously described. The clinician or provider, having access to the portal system 2028, can then use the portal to help customize care to the individual patient's needs via the portal system 2028. For example, body metrics (e.g., body composition, girth, etc.) collected using the system 1000 can be transferred to the portal system 2028, which when combined with medical data of the patient, can drive the system 1000 to change settings and therapy parameters to customize the patient's therapy regimen such as by the automated application of the system 1000 and/or by the guidance of the provider or clinician. Notification of care changes can be made to the patient within the portal system 2028, which in turn can communicate with the control device(s) (e.g. control device 1010) for changing settings of the CPG devices (e.g., CPG device 1002). In some examples, body metric data maintained by the system 1000 may include: body composition, skin density, skin composition, impedance, volume, girth, resistance, swelling, bioimpedance, temperature, etc., or any combination thereof.

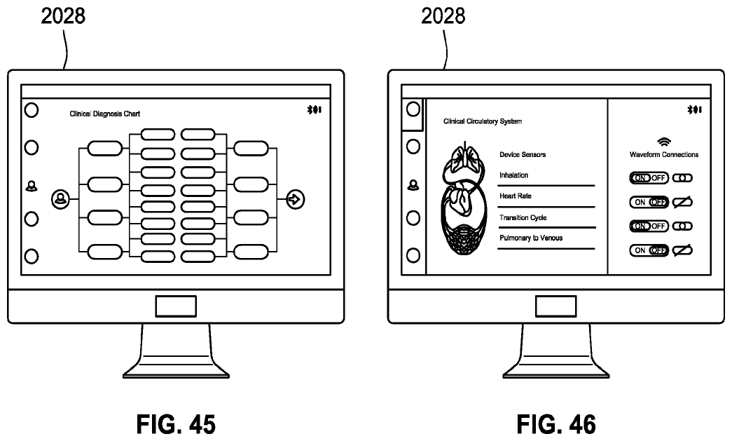

Referring to FIG. 45, the portal system 2028 can provide clinicians with a diagnosis chart (e.g., on the portal system server application 44810) to aid in guiding the clinician in the selection of a system 1000 for the patient so that the patient user can be fitted into the correct compression garment system and therapy type to suit their individual therapy needs (e.g., size and therapy protocol selection).

Referring to FIG. 46, the portal system 2028 can provide a user interface for monitoring circulation and over-all circulatory data of multiple patients, such as on a patient by patient basis, to help the clinician/provider track blood flow and patient pathology, and to see how the compression garments and CPG devices are functioning to deliver treatment and improve patient condition.

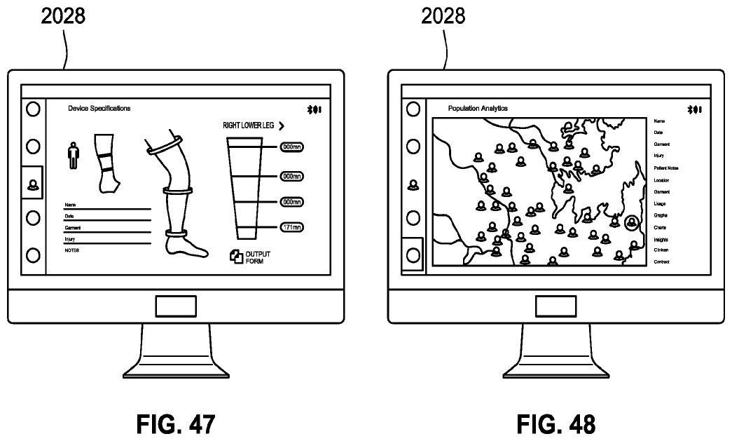

Referring to FIG. 47, since each user's specifications may be unique to the user, the portal system 2028 may maintain, such as in a secured database system, customized set up information in relation to the user's particular physiology, dimensions, CPG device and compression garment information.

Referring to FIG. 48, the portal system 2028 can provide analytics for the population of users managed by the system. For example, the users can be monitored within the portal system by categorizing each user according to similar injury or condition so that, with the categorization, the conditions can be tracked. Thus, medical benefits may be considered on a greater scale. Thus, the categorized data of the portal can serve as a basis for group evaluation to improve health outcomes.

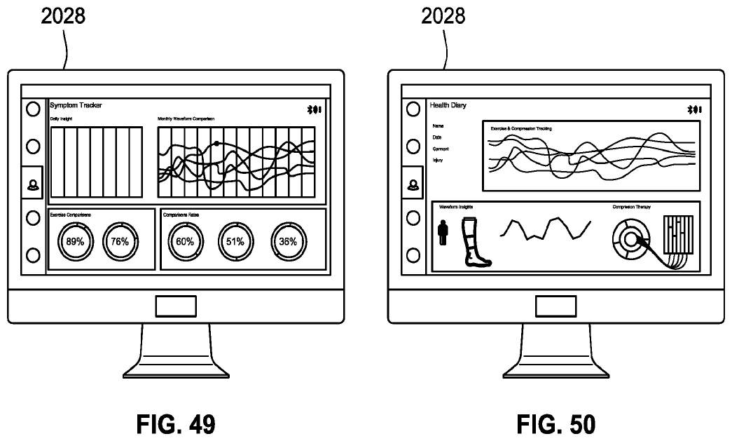

Referring to FIG. 49, the portal system 2028 can present a user interface for symptom tracking. Thus, the clients' symptoms and therapy data can be tracked and stored so that the clinician or system can provide instructional help with the use of a CPG device (e.g., the CPG device 1002) and compression garment (e.g., compression garment 1004) usage, efficacy, and future product therapy improvement.

Similarly, as illustrated in FIG. 50, the portal system 2028 can present the clinician or provider with an overview of each client's health data from exercise through to device use, clinical history and therapy, which may be recorded within a health diary managed by the portal system. This can help clinicians deliver better connected health care.

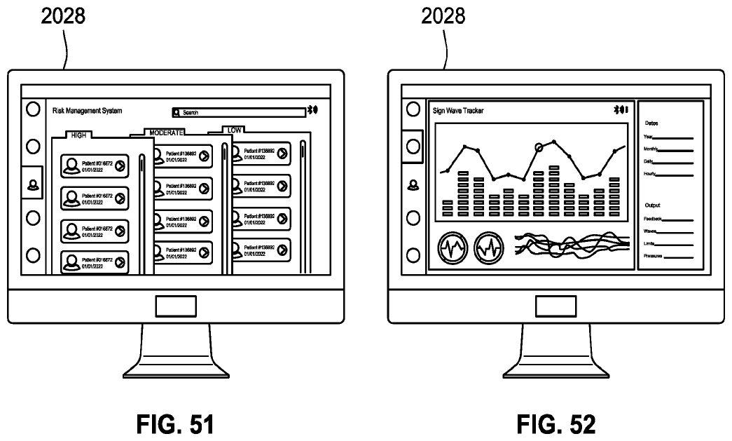

Referring to FIG. 51, the system 1000 can generate a management screen with actionable insights for managing Lymphedema patients with high to low risk priorities, such as based on an evaluation of data received by the portal system 2028. The system 1000 can also manage doctors' contact and consultations with users/patients according to the priorities, such as by generating messages to urge such contact and consultations. Such messages may be generated according to the system 1000 determined priorities.

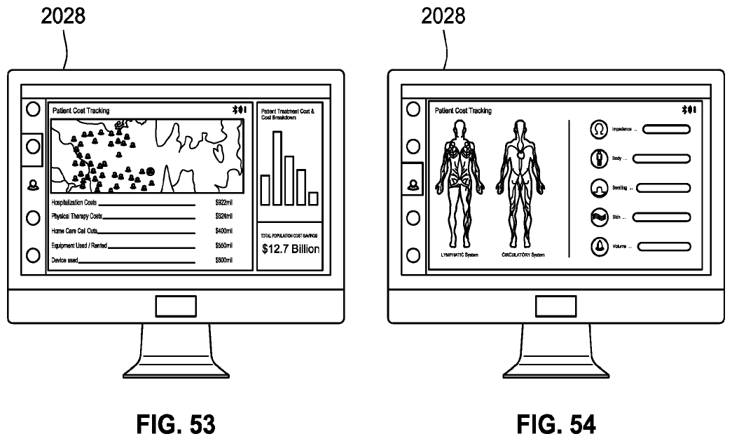

Referring to FIG. 52, results of a CPG device diagnostic process (e.g., waveform processes previously described) can be displayed over time such as to present trend information (e.g., impedance, resistance, etc.) in a graph. For example, wave scans such as on a monthly basis can be presented to the clinician or therapist to provide visual insight into how the therapy is changing the patient's Lymphedema condition. Optionally, as illustrated in FIG. 53, the portal system 2028 can be configured to visually track patient incident cost related to care to monitor health care costs across the managed population to provide an indication of cost savings made relative to hospitalization costs. As illustrated in FIG. 54, the portal system 2028 can present a body composition management graphic interface to show patient data body metrics collected by the system 1000.

The portal system 2028 may also utilise data analytics methods to personalize care plans. The portal could utilise patient history, therapy data and any diagnostic data to automatically recommend and/or adjust treatment plans. An example of this could be to incorporate data coming from an Indocyanine-Green (ICG) scan, which maps out the flow of fluid through the lymphatic networks. This data could provide information on how to personalize the compression waveform for a particular patient, such that applied direction of compression matches the natural flow of the lymphatic system (as seen in the scan). Following the initial setup in this manner, as the portal system 2028 may receive data from a CPG device over time, as well as clinical data entered from the physician, the portal system 2028 could continue to adapt therapy patterns accordingly. This is one example of how the portal system 2028 can personalize care plans for a patient. Apart from therapy, the portal system 2028 can also recommend changes to exercise patterns, diet, and lifestyle.

6.10 High-Resolution Compression Therapy Systems

The disclosed compression therapy systems, such as those illustrated in FIGS. 23A and 56A, are capable of emulating manual massage therapy by sequential pressurisation and depressurisation of chambers according to a predetermined pattern.

The resolution of such massage therapies may be further increased by partitioning each chamber (e.g., chambers 1.1, 1.2, 1.3 shown in FIG. 56A) into a plurality of micro-chambers. FIG. 13D illustrates this basic idea, showing a toroidal (e.g., peripheral or ring-shaped) chamber 13316-C partitioned into four micro-chambers 13304-7 to 13304-10. Micro-chamber 13304-7 is illustrated as directly controlled by an active valve and the remaining micro-chambers 13304-8 to 13304-10 are pressurised via interconnecting passive valves 13450A-D in a predetermined sequence. In one example of such a sequence, the micro-chamber 13304-7 is pressurised first in the sequence, the micro-chambers 13304-8 and 13304-9 are then pressurised at the same time or about the same time, and the micro-chamber 13304-10 is pressurised last in the sequence.

In some implementations of the present disclosure, the predetermined sequence of pressurization of micro-chambers provides a directional massage that, for example, starts at one end and moves towards another opposing end. For example, the massage starts at a distal end of a user's arm and moves towards a proximal end of the user's arm (or vice versa). For another example, the massage starts at a distal end of a user's leg (near the foot) and moves along a calf muscle and/or shin of the user towards a proximal end of the user's leg near the knee of the user (or vice versa).

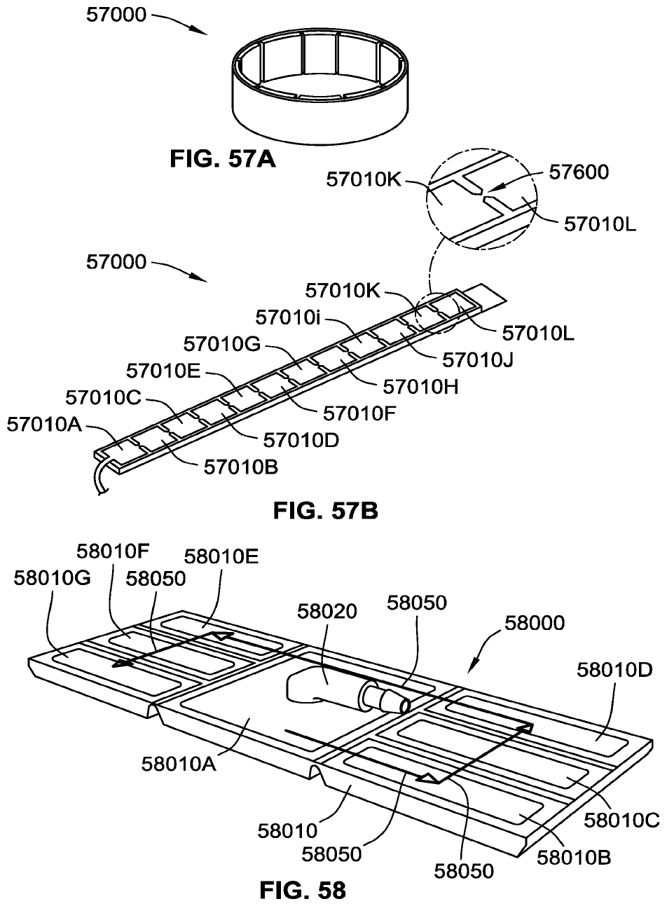

Referring to FIGS. 57A and 57B, a toroidal chamber 57000 is partitioned into 12 micro-chambers 57010A-L, in the same or similar fashion as the micro-chambers shown in FIG. 13D. The toroidal chamber 57000 is illustrated both in its configuration as worn (FIG. 57A) and in an unrolled or flattened configuration (FIG. 57B) for greater clarity. That is, toroidal refers to the generally toroidal shape of the toroidal chamber 57000 (FIG. 57A) when a garment, including the toroidal chamber 57000, is worn by a user. It is contemplated that a garment can include any number of the toroidal chambers 57000 (e.g., 1, 2, 5, 8, 10, 20, 32, 50, 100, 1000, 10,000, etc. or any number in-between) as a series of rows of the garment where each of the toroidal chambers 57000 is connected to its neighbours along corresponding edges. In some such garments, all of the toroidal chambers 57000 have the same general alignment (e.g., all generally horizontal when the garment is worn, all generally vertical when the garment is worn, etc.). In some other garments, some of the toroidal chambers 57000 have the same, or similar, alignment, and others of the toroidal chambers 57000 have different alignments. The arrangement of the toroidal chambers 57000 in a garment can be selected to provide specific and/or custom compression therapy sessions to a user of the garment. That is, in some implementations, the toroidal chambers 57000 are arranged in a garment to provide efficient massaging of the wearer, thereby resulting in aiding drainage for the user.

According to some implementations, a garment has between about 8 toroidal chambers (e.g., rows) and about 32 toroidal chambers (e.g., rows). In some such implementations, each of the toroidal chambers has about 10 micro-chambers. In some implementations, a garment according to the present disclosure includes between about 50 micro-chambers and about 100 micro-chambers. In some implementations, a garment includes about 80 micro-chambers. Various other garments with various other amounts of toroidal chambers/rows and various other amounts of micro-chambers are contemplated to provide compression therapy (e.g. massage emulation).

According to some implementations of the present disclosure, a chamber or macro-chamber is a chamber that is controlled with an active valve. In some such implementations, the macro-chamber is partitioned into smaller sub-chambers or micro-chambers, where each of the micro-chambers is connected with at least one other micro-chamber via passive valves and/or micro-conduits.

In some implementations, a macro-chamber of the present disclosure has a length/height between about 20 millimeters and about 120 millimeters, a width between about 10 millimeters and about 80 millimeters, and a depth/thickness between about 1 millimeter and about millimeters.

In some implementations, a micro-chamber of the present disclosure has a length/height between about between about 0.25 inches (6 mm) and about two inches (50 mm), a width between about 0.25 (6 mm) inches and about two inches (50 mm), and a depth/thickness between about 0.1 inches (0.25 mm) and about 0.5 inches (12.5 mm). In some implementations, a micro-chamber has a length of about 12.5 millimeters, a width of about 12.5 millimeters, and a depth/thickness of about 5 millimeters.

In FIGS. 57A and 57B, the micro-chambers 57010A-L are connected in sequence around the toroidal chamber 57000 via narrow-gauge “micro-conduits” (e.g. micro-conduits 57600) that act as passive valves. Pressurising the first micro-chamber 57010A causes each subsequent micro-chamber 57010B-L to be pressurised in a progressive sequence around the toroidal chamber 57000. In some implementations, each of the micro-conduits 57600 has a minimum diameter, which is between about 0.001 inches (25 microns) and about 0.25 inches (6 mm). In some implementations, the minimum diameter of each of the micro-conduits 57600 is about 5 millimeters.

According to some implementations, each toroidal chamber/row of a garment is separately pressurized via a separate and distinct active valve. Alternatively, one or more of the toroidal chambers/rows of a garment are fluidly connected to one or more other toroidal chambers/rows of the garment via one or more conduits. In some such implementations, the conduits connecting one toroidal chamber (e.g., macro-chamber) to another have a diameter of about 5 millimeters.

A compression therapy utilising a partitioned chamber such as the toroidal chamber 57000 is thus able to create a micro-massage on the wearer's skin. One aim of a micro-massage is to emulate the stretching effect of natural bodily movement. Lymphedema patients often lack normal mobility and thus their skin is deprived of this natural stretching effect. In addition, the micro-massage can increase pre-load of the lymphatic capillaries and greatly improve lymphatic and venous micro-circulation.

Referring to FIG. 58, a toroidal chamber 58000 includes multiple micro-chambers 58010A-G. Toroidal chamber 58000 is illustrated in a flattened configuration for greater clarity. Toroidal chamber 58000 is partitioned in two dimensions into a matrix pattern of the micro-chambers 58010A-G. Such a partitioning enables a two-dimensional aspect to be introduced to the micro-massage, in that the micro-massage can proceed along, for example, a vertical and/or a horizontal axis depending on the sequence of interconnection of the micro-chambers 58010A-G. The toroidal chamber 58000 also includes a pneumatic coupling 58020, that is fluidly connected with a first one of the micro-chambers 58010A to deliver pressurized gas (e.g., air), which leads to pressurisation of the other micro-chambers 58010B-G based on the sequence of interconnection of the micro-chambers 58010A-G.

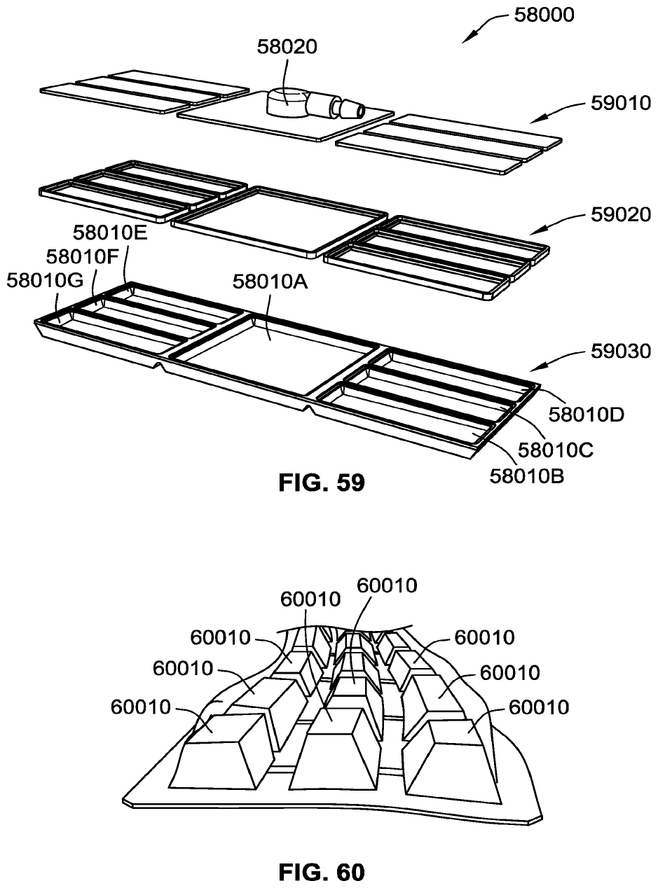

Referring to FIG. 59, an exploded view of the toroidal chamber 58000 is shown, which illustrates how the toroidal chamber 58000 is made up of three layers 59010, 59020, and 59030. The backing (outer surface) 59010 may be made from a rigid material. The micro-chambers 58010A-G are formed by an inner layer 59030 that may be moulded or formed from an elastic material (e.g. silicone, TPE, airtight textile). This allows for compressive forces to be directed inwards towards the surface of the skin. The micro-chambers 58010A-G can be moulded or formed into the final air-filled shape, allowing for a lightweight set of micro-chambers 58010A-G that are designed to be form-fitting and provide uniform compression. Moulding the inner layer 59030 from a tacky or sticky substance such as silicone increases the stretching effect of the micro-massage provided by the toroidal chamber 58000. The choice of materials and manufacturing process used to form the inner layer 59030 can introduce a third or depth dimension to the micro-massage. One example of this could be to thermoform (though other methods are contemplated) the micro-chambers 58010A-G to create different directions during inflation. An example of this is illustrated in FIG. 60, where the micro-chambers 60010 are thermoformed to inflate in a generally trapezoidal manner, as indicated by the generally trapezoidal shape. In FIG. 60, the micro-chambers 60010 are approximately 12.5 mm square. Various other dimensions for the micro-chambers 60010 are contemplated, such as, for example, approximately 5 mm square, approximately 7 mm square, approximately 10 mm square, approximately 20 mm square, approximately 25 mm square, etc., or any combination thereof (e.g., portions of the micro-chambers 60010 can have the same or different dimensions).

Another method for producing a third dimension of a micro-massage can involve having different knitting patterns in the textile to dictate the properties of the direction in which the material inflates and thereby have a three-dimensional effect. The third dimension may also be implemented via differing rates of inflation of the micro-chambers of a chamber, which in turn may be implemented via micro-conduits of different resistances to flow (e.g. different minimum diameters of the micro-conduits).

Referring back to FIG. 59, the middle layer 59020 of the toroidal chamber 58000 forms a seal for each of the micro-chambers 58010A-G. In some implementations, the middle layer 59020 contains micro-conduits that fluidly interconnect the micro-chambers 58010A-G. The configuration of the micro-conduits in the middle layer 59020 controls the sequence in which the micro-chambers 58010A-G are pressurised after the pressurisation of the first micro-chamber 58010A. In one example, the arrows 58050 shown in FIG. 58 illustrate a predetermined pressurisation sequence (e.g., counter clockwise) of the micro-chambers 58010A-G. Each of the arrows 58050 corresponds to a micro-conduit between the adjacent pair of micro-chambers interconnected by the arrow 58050. The diameter of each micro-conduit can be selected/formed to control a rate of inflation of the corresponding micro-chamber(s). Appropriate configuration of the micro-conduits in the middle layer 59020 therefore can lend a third dimension to the micro-massage implemented by the pressurisation of the toroidal chamber 58000.

The configuration of the micro-conduits, and therefore the character of the resulting micro-massage, may be personalized for a particular patient. As described above, an ICG scan of the affected areas of a user/patient could provide information on how to personalize the micro-massage for a particular user/patient, such that the direction of the micro-massage matches the natural flow of the lymphatic system (as determined from the scan). Alternatively, as mentioned above, information enabling personalization may be obtained from the patient's clinical history, e.g. the pattern of swelling.

Micro-chambers may also be partitioned from non-toroidal chambers which do not necessarily wrap around a limb. Such chambers could be localised chambers taking any shape, used to target specific areas of the body. One example is an anatomically shaped chamber such as the bicep zone 19410 in FIG. 19.

In some implementations, micro-chambers may be coated and/or have a surface finish applied to at least a portion thereof, so as to produce a textured surface to enhance skin stretching, improve comfort, and regulate skin environment. Silicone dot protrusions (e.g., generally circular dot protrusions) may present one particularly suitable option given silicone's natural high-friction surface properties. Alternatively, the micro-chamber surface may be brushed to create the same, or similar, effect.

6.10.1 Cyclic Pressurisation A more intricate control system for the micro-chambers may involve
a. Pre-inflating the micro-chambers to a pre-set therapy pressure.
b. Cycling the micro-chambers repeatedly between a (higher) target therapy pressure and the (lower) pre-set therapy pressure.
c. (Optionally) Altering the target therapy pressure and/or the duty cycle of the cyclic pressurisation (possibly in response to sensor data).

Cyclic pressurisation is similar to the oscillatory pressurisation waveforms described above in relation to FIG. 56A, in which the pre-set therapy pressure is illustrated as 25 mmHg and the target therapy pressure is illustrated as 30 mmHg. Micro-chambers are particularly suitable for cyclic pressurisation because their small volume allows high frequency cycling (e.g. up to 10 Hz) between substantially different pressures without overloading the CPG device 1002. Cyclic pressurisation emulates manual massage so as to break up gel-like tissue that forms at a more advanced stage of lymphedema.

6.11 Additional Compression Therapy System Implementations

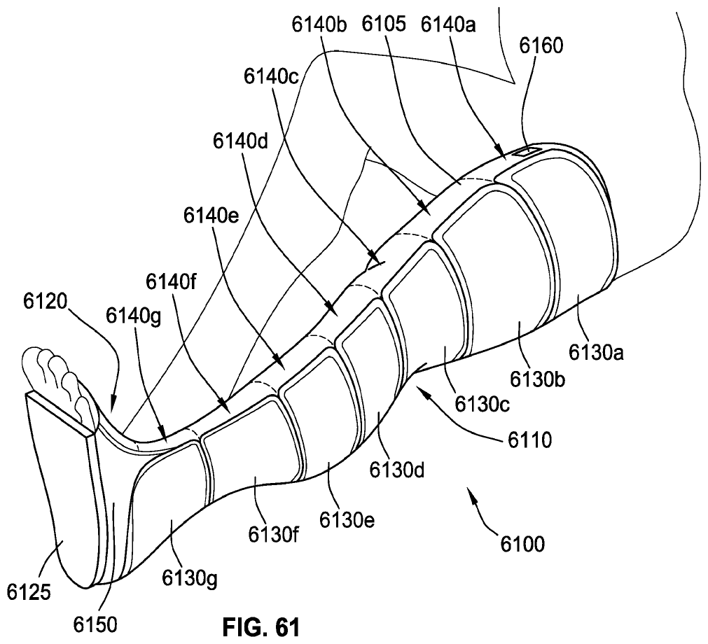

Referring now to FIGS. 61 to 71, exemplary non-limiting compression garment implementations are described for circulatory-related disorder therapy. The compression garment implementations include toroidal chambers that can be independently pressurized. The chambers are transverse to (i.e., circumscribing) a human limb that is subject to therapy and the chambers are stacked in rows one next to the other. One or more of the independently pressurized chambers of the garment are primary chambers partitioned into multiple transverse toroidal sub-chambers that are also stacked in rows within the primary chamber. The primary chambers are also referred to as macro-chambers and the sub-chambers are also referred to as micro-chambers. In some implementations, a compression garment may include one or more of the features described by FIGS. 61 to 71. In some implementations, a compression garment may include one or more of the features described above in FIGS. 1 to 60 in combination with one or more of the compression garment features described below for FIGS. 61 to 71.

In some implementations, it is also contemplated that a compression garment includes one or more longitudinal chambers that generally extend along the length of a human limb, such as a leg or arm, and effectively parallel the long axis of the limb. For a longitudinal chamber configuration, the chambers may be arranged as adjacent columns. One or more independently pressurized chambers of the garment can be primary chambers partitioned into multiple longitudinal sub-chambers that are also aligned in columns within the primary chamber. In some implementations, chambers of a compression garment may further be anatomically shaped to follow the orientation of core muscle groups of the user around the targeted limb or body part.

Examples of toroidal chambers are provided throughout the present disclosure, including in FIGS. 13D, 57A and B, 58, 59, 61, 62A, and 63-68, along with their related descriptions. Toroidal can include peripheral or ring-shaped chambers or series of chambers. It is further contemplated that toroidal refers to a generally toroidal shape of a chamber when a compression garment, including the toroidal chamber, is worn by a user, though many of the toroidal chambers illustrated in the present disclosure are shown in an unrolled or flattened configuration for improved clarity.

In some implementations for transverse chambers (e.g., circumscribing a limb of the user), a toroidal chamber is contemplated to be generally circular when the compression garment with the toroidal chamber is worn by the user. In some implementations, if a radial cross-section of a toroidal chamber that circumscribes a limb of the user were taken at any point relative to the limb, the geometric shape of each cross-section of the chamber would be expected to be generally the same, with similar cross-sectional dimensions. Some variation in shape could be expected to accommodate for the practicalities of a compression garment, including tapering of the chamber, fabrication considerations, and at cross-sections taken at air flow control points between chambers or sub-chambers.

As discussed above for exemplary FIG. 57, a compression garment, as contemplated in some aspects of the present disclosure, can include any number of toroidal chambers as a series of stacked rows where each of the toroidal chambers is physically connected to its neighbours along corresponding edges. In some such garments, all of the toroidal chambers have the same general alignment (e.g., all generally transverse or circumscribing a limb when the garment is worn). The arrangement of the toroidal chambers in a garment can be selected to provide specific and/or custom compression therapy sessions to a user of the garment. For example, toroidal chambers may be arranged in a garment to provide efficient massaging of the wearer, thereby resulting in aiding lymphatic drainage for the user.

In some implementations, one or more chambers may be, or may include, non-toroidal chambers which do not necessarily wrap around a user's body part. Such chambers could be localised chambers taking any shape, used to target specific areas of the body, such as a foot section or to follow certain muscles or physiology.

Turning now to FIG. 61, a perspective view of a compression garment 6100 is depicted as worn by a user, including a leg section 6110 and a foot section 6120. The compression garment 6100 wraps around the circumference of the user's limb, such as the depicted leg and foot, to form a low-profile, form fitting garment. The foot implementations include an open-toe configuration, though closed-toe implementations are also contemplated for a compression garment. The compression garment 6100 includes multiple tabs 6130a-6130g that each partially define a corresponding generally transverse (with respect to the underlying limb) macro-chamber that circumscribes the limb lying beneath an outer layer 6105 and is disposed within the layering of the compression garment 6100. That is, the macro-chambers are fabricated within the structure of the compression garment 6100. The tabs 6130a-6130b can be received into hook-and-loop (e.g., Velcro®) panels with the tabs wrapped around and affixed to an exterior surface of the outer layer 6105 of the compression garment 6100.

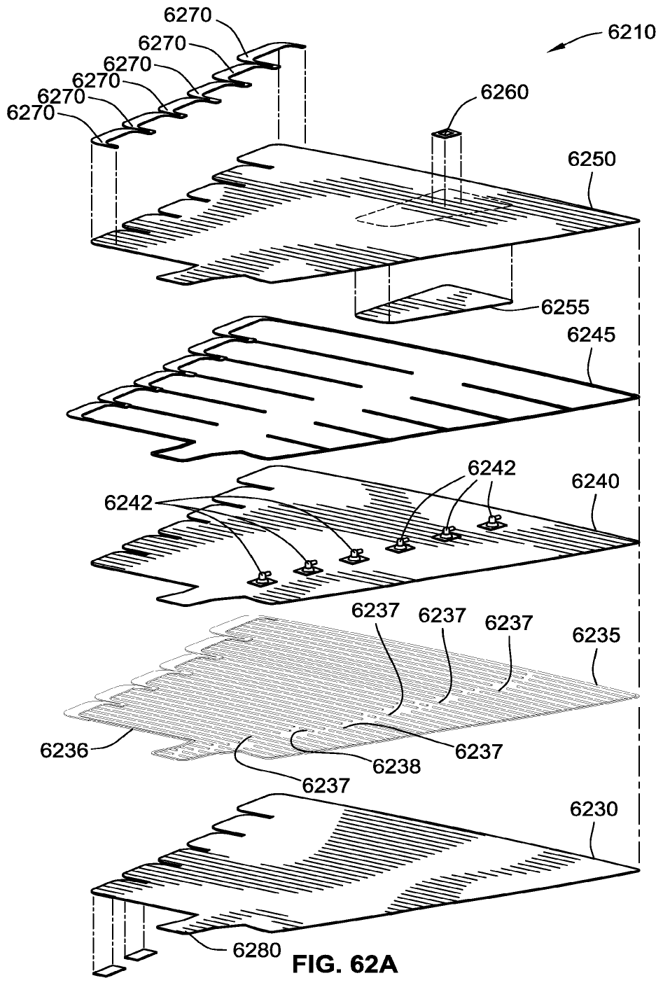

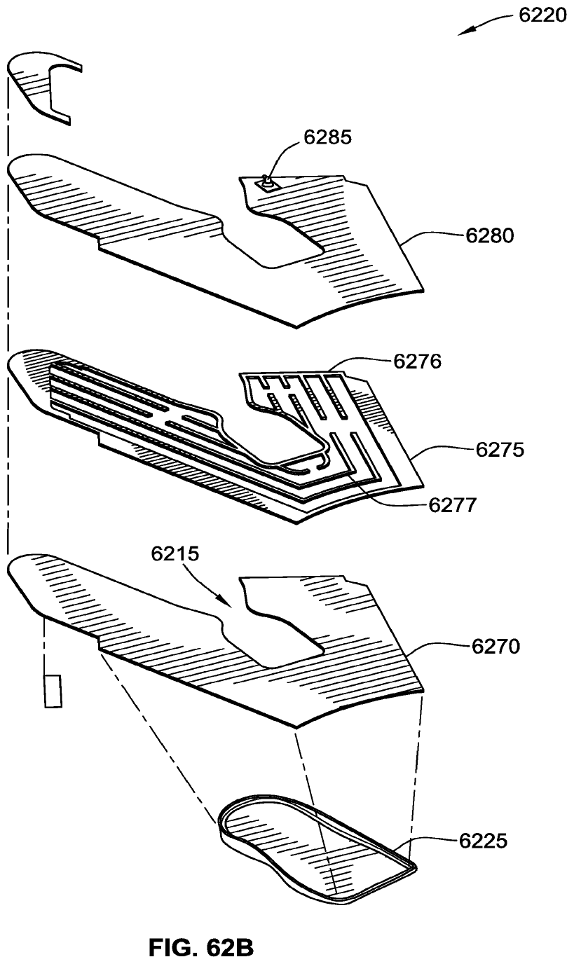

The general positions of the macro-chambers within the compression garment, as they extend from the multiple tabs 6130a-6130g around the leg, are indicated at macro-chamber sections 6140a-6140g of compression garment 6100. The broken lines identify a portion of the macro-chamber underlying the outer layer 6105 of the compression garment. The macro-chambers and tabs 6130a-6130g are stacked along the longitudinal axis of the limb. In some implementations, one or more macro-chamber sections, such as macro-chamber section 6140a, can be partitioned into a plurality of interconnected micro-chambers (not shown) disposed within the macro-chamber. Each micro-chamber may have one or more links to adjacent micro-chambers within a respective macro-chamber. The links may be in the form of passage(s) and/or opening(s) in the connection profile, (e.g., the disclosed welding patterns in for example FIGS. 62A to 65 and 71 to 73) between the two or more layers as a non-limiting example for forming the micro-chambers, the macro-chambers, and the garment). In some implementations, one or more of the macro-chambers may not be subdivided into micro-chambers, but rather be a single chamber without any partitioning that creates micro-chambers.

In some implementations, the foot section 6120 can include a separate macro-chamber 6150 that wraps around the foot section 6120. The foot section 6120 can include a sole piece 6125 that allows a user to walk during circulatory-related disorder therapy, such as lymphedema therapy.

In some implementations, it is also contemplated that the compression garment 6100 may include an interface patch 6160 for electronics and/or pneumatic components or systems to be connected to the compression garment.

Turning now to FIGS. 62A and 62B, exploded flattened perspective views are depicted of a leg compression garment 6210 and a foot compression garment 6220. One or both garments, when worn by a user, may be similar to aspects of compression garment 6100 depicted in FIG. 61.

Referring to FIG. 62A, exemplary leg compression garment 6210 includes three primary layers, including an inside skin contact layer 6230, a second layer 6240, and an outer layer 6250. In some implementations, the third or outer layer 6250 may be optional, such as where the second layer is also used as an outer layer. For example, in some implementations where the first layer and the second layer are airtight, a third layer may not be needed and the compression garment may be formed with the two layers only. In some aspects, a third layer may still be used for the compression garment for aesthetic purposes. However, in implementations where the second layer is not airtight, even when using, for example, a welding process to form the micro-chambers and macro-chambers between the first layer and the second layer, the micro-chambers and the macro-chambers will only be able to be pressurised if a third, airtight, layer is attached to the second layer to provide the air-proofing needed for the pressurization of the compression garment. The optional third layer may also provide convenience as it may be used as an aesthetic layer that covers the various structural elements of the garment, such as the connectors 6242.

In some implementations, each of the layers is fabricated to include material(s) that are flexible, durable, and preferably smooth to provide comfort to the user during therapy. One exemplary fabric material with such properties for the compression garment includes thermoplastic polyurethane materials (“TPU”), such as TPU films. Materials used to form boundaries of the chambers of a compression garment also include air-tight properties. In some implementations, other textures for materials of the various layers are contemplated depending on the objective of the therapy. For example, in some implementations, a rough surface may be desirable to aid in the breakdown of gel-like or fibrotic tissue in lymphedema patients. In some implementations, the fabrics used for the layers of a compression garment comprise a TPU film laminated to a textile layer.

The three layers 6230, 6240, and 6250 of the exemplary leg compression garment 6210 are coupled together through welding techniques for thermoplastics, such as ultrasonic or radiofrequency welding, that provide the ability to create air tight interfaces between any two layers of the compression garment 6210 and that are flexible and durable. Other coupling methods are contemplated for fabricating compression garments of the present technology that similarly provide air-tight, flexible, and durable properties, and in some implementations. For example, rather than welding, or in addition to welding, layers could alternatively be joined by gluing or otherwise chemically bonding the layers of a compression garment.

A chamber weld profile 6235 provides a specific coupling pattern implemented by a process, such as welding, to attach the skin contact layer 6230 and the second layer 6240 to define a plurality of independent macro-chambers between the skin contact layer 6230 and the second layer 6240. In some implementations, the chamber weld profile is not a layer, but rather a pattern along which the two layers (e.g., skin contacting layer and the second layer) are welded together, and effectively form a seam. The macro-chambers are themselves partitioned or sub-divided into a plurality of interconnected micro-chambers. The weld profile 6235 in the exemplary aspect of compression garment 6210 forms six air-tight transverse macro-chambers (though more or fewer chambers are contemplated including as few as one, between two and five, and more than six), that are fluidly independent of each other as a result of the transverse welds in between each adjacent macro-chamber and welds around the perimeter of the skin contact layer 6230 and the second layer 6240 which couple the layers together. These perimeter welds (e.g. 6236) have no gaps, which prevents or minimizes air from leaving the respective macro-chamber. The perimeter welds also define a maximum total area for a macro-chamber to be inflated. In some implementations, adjacent macro-chambers share a common continuous solid weld 6237 to separate the chambers.

As mentioned above, it is contemplated by the present disclosure that when referring to a “profile”, such as weld profiles 6235, 6245, 6275, use of the term “profile” refers to a pattern, outline or trace along which two layers are attached or connected to each other where the pattern, outline or trace is not necessarily a distinct or separate layer of appreciable thickness. When referring to a “weld profile”, the pattern, outline, or trace is created using welding techniques. Other implementations for creating a profile for attaching two layers can include thermo-stamping, gluing, fusing, or similar techniques. A weld profile, a thermo-stamping profile, a gluing profile, a fusing profile, or a profile created using related techniques can more generally be referred to as a layer attachment profile.

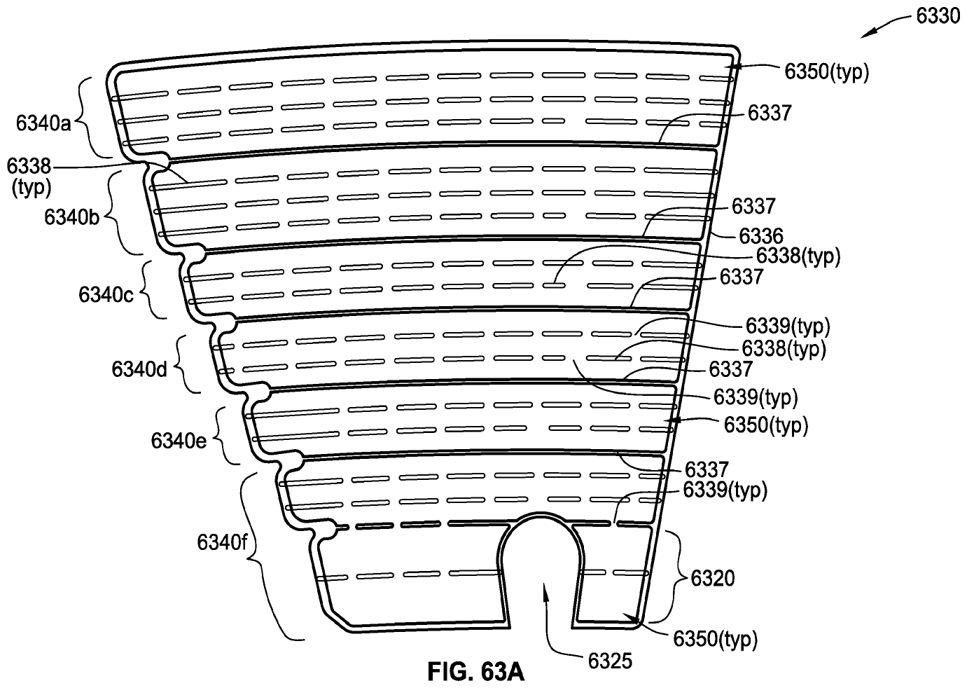

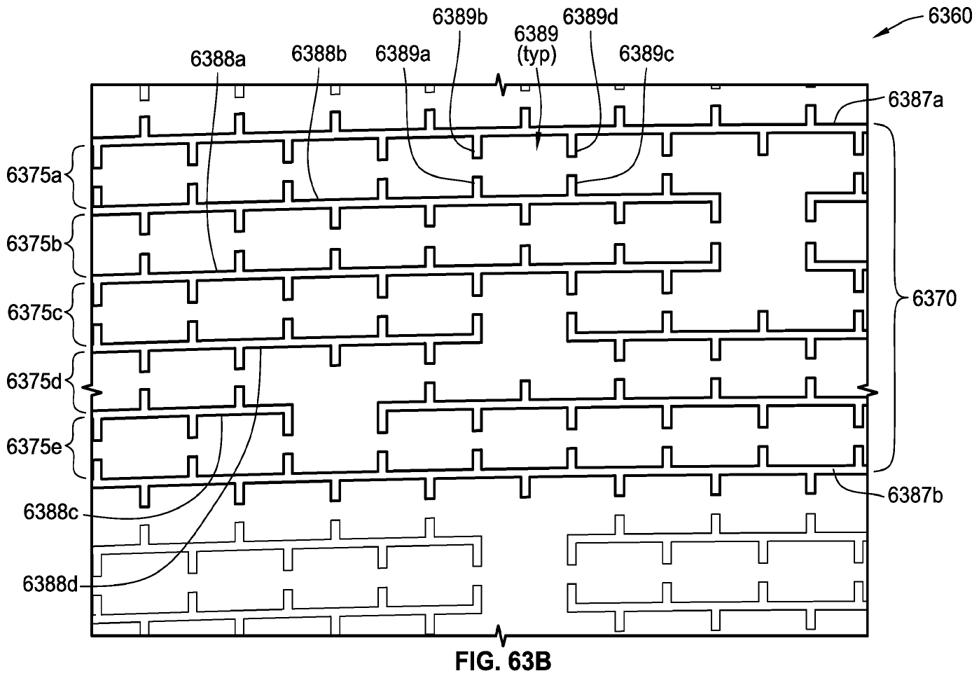

In the exemplary weld profile 6235, each of the plurality of transverse macro-chambers are subdivided into a plurality of transverse micro-chambers through additional welding of the skin contact layer 6230 and the second layer 6240 (or an outer layer). The micro-welds (e.g., welds that form the micro-chambers), may include discontinuous transverse and/or longitudinal welds 6238 to create the plurality of micro-chambers with openings or gaps between the welds that allow for air flow between the micro-chambers. In some implementations, apart from being in fluid communication with one or more adjacent micro-chambers, depending on the welding pattern a micro chamber may also be in fluid communication with one or more non-adjacent micro-chambers or may even be in fluid communication with all micro-chambers within a respective macro-chamber (e.g. see FIG. 63A). Each micro-chamber may be connected to adjacent or non-adjacent micro-chambers with one or more links (e.g., openings or passages).

The micro-welds of a weld profile can effectively operate like seams and define the size and location of each micro-chamber. The size of a micro-chamber varies based on the circulatory-related disorder therapy needed by a user. A desirable aspect of the present disclosure is that the weld profile can be adjusted so that the micro-weld layout and arrangement can be configured as a controllable pattern or array within each of the macro-chambers to accommodate an individual patient's needs. For example, prior to finalizing the fabrication of a compression garment, a weld profile can be digitally or mechanically arranged by systematically patterning the placement of each micro-weld within each macro-chamber of a compression garment. In some implementations, micro-weld width (e.g., the width of the effective seam created by the micro-weld) can range from about 1 mm to about 5 mm. The micro-weld length can also vary, and in some implementations, can range from about 10 mm in length to about 900 mm. The approximately dimensions of a micro-chamber can vary, and in some implementations, can range from about 10 mm by about 100 mm to about 30 mm by 900 mm.

In some implementations, the size of a micro-chamber, or further subdivision of a micro-chamber into micro-cell(s), can be determined based on the location of the welds on the compression garment, and thus, the desired treatment area of the body. For example, around the foot, the micro-chambers may be smaller and may include further subdivision into micro-cells. Around the thigh, the micro-chambers can be larger. Flexibility is desirable because adjusting a weld profile allows fluid gradients to be better mimicked and pressure gradients in the compression garment to be changed. In some implementations, the micro-welds for forming the micro-chambers are independent welds within the macro-chamber. In some implementations, the micro-welds are connected to other micro-welds or to welds defining the perimeter of a macro-chamber.

To allow pressurized air to enter a macro-chamber, the second layer 6240 has a plurality of connectors 6242 mounted or bonded to the second layer such that each macro-chamber is in fluid connection with a respective connector. The supply of pressurized air to a connector in turn causes the pressurized air to further be delivered to one or more micro-chambers and/or micro-cells within their corresponding macro-chambers. In some implementations, the pressurized air is delivered simultaneously to a plurality of micro-cells within a plurality of micro-chambers of a corresponding macro-chamber of the compression garment. The pressure for the supplied air entering a macro-chamber can range from about 15 mm Hg to about 120 mm Hg; and in some implementations between about 15 mm Hg to 100 mm Hg; and in other implementations between about 25 mm Hg to about 65 mm Hg; and in yet other implementations between about 35 mm Hg to about 55 mm Hg.

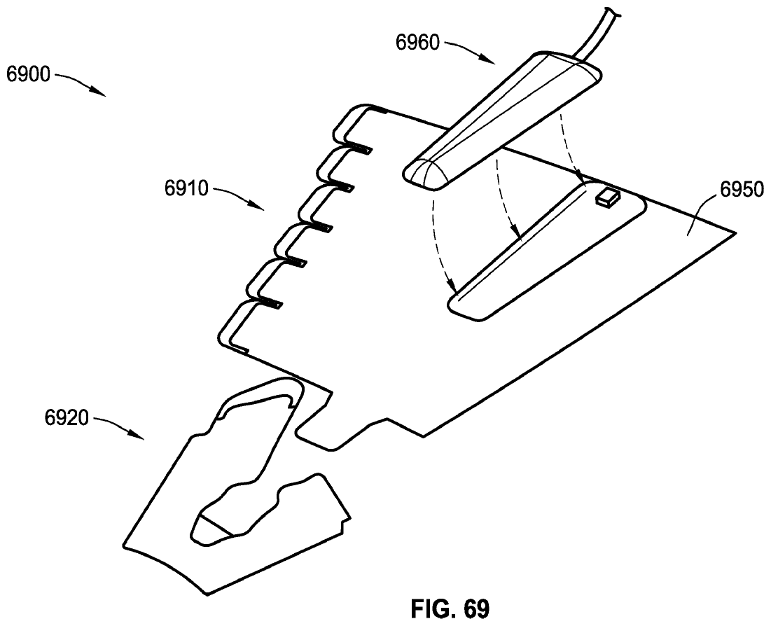

In some implementations, an outer layer 6250 is coupled to the second layer 6240 by welding or other comparable coupling techniques. Second weld profile 6245 depicts an exemplary weld pattern that includes perimeter welds without any gaps, along with transverse welds extending from the tabs that are generally parallel with the welds defining the macro-chambers in weld profile 6235. The coupling of the outer layer 6250 to the second layer 6240 may also provide a protective system for a pneumatic spine (see FIGS. 69 to 71) that may be used to deliver air to the connectors 6242. The pneumatic spine can be disposed on the second layer 6240, on the outer layer 6250, or on an internal pad 6255 disposed on the outer layer or between the outer layer 6250 and second layer 6240.

In some implementations, a garment interface patch 6260 is further disposed on the outer layer 6250. Furthermore, outside retention panels 6270 may be secured to each of a plurality of tabs formed in each of the primary layers for the compression garment.

Each of the macro-chambers of an assembled leg compression garment 6210 in the flattened view depicted in FIG. 62A can have dimensions of between about 100 millimeters and about 900 millimeters along the transverse axis (i.e., the dimension circumscribing the a limb when worn by a user), a width between about 70 millimeters and about 150 millimeters along the longitudinal axis (i.e., the dimension generally parallel to a limb of the body when worn by a user), and an deflated thickness between about 1 millimeter and about 20 millimeters. The overall dimensions of an assembled leg compression garment 6210 in the flattened view depicted in FIG. 62A can be between about 400 millimeters and about 1000 millimeters along the longest dimension of the macro-chamber transverse axes (i.e., the dimension circumscribing a limb when worn by a user) and between about 400 millimeters and about 1000 millimeters along the longitudinal axis (i.e., the dimension generally parallel to a limb of the body when worn by a user). Larger or smaller dimensions are contemplated to accommodate the size the of user. For example, the dimension along the transverse axis may be increased for a user with a larger thigh, or the dimension along the longitudinal axis may be higher, or more macro-chambers added, for taller users, or decreased for shorter users.

Referring now to FIG. 62B, the foot compression garment 6220 is depicted in an exploded flattened perspective view. The foot compression garment 6220 includes two primary layers including a foot skin contacting layer 6270 and a foot outside layer 6280 that are coupled together using welding, similar to the welding described for the leg compression garment 6210. An exemplary foot weld profile 6275 defines a single macro-chamber partitioned into multiple micro-chambers by typical perimeter weld 6276 and typical micro-welds 6277. The outside layer 6280 includes a connector 6285 that is used for supplying pressurized air into the macro-chamber which in turn delivers pressurized air to the micro-chambers. In some implementations, the foot compression garment 6220 has a single macro-chamber shaped to conform to the top of the foot, along with a plurality of micro-chambers and/or micro-cells.

In some implementations, the foot compression garment includes a sole piece 6225 mounted to the perimeter of the foot skin contacting layer 6270. The foot compression garment 6220 desirably provides a user a shoe-like foot section. The sole piece 6225 allows the user to be mobile while wearing the compression garment(s). The sole piece may be fabricated from foam and can be bonded to the base of the foot compression garment 6220 or attached separately like a shoe.

The overall dimensions of an assembled foot compression garment 6220 in the flattened view depicted in FIG. 62B, with the garment properly positioned relative to the foot prior to securing the garment, can include a length of between about 300 millimeters and about 500 millimeters along the longitudinal axis of the foot and between about 250 millimeters and about 400 millimeters perpendicular or transverse to the longitudinal axis of the foot. Larger or smaller dimensions are contemplated to accommodate the size the of user.

In some implementations, one or more of the skin contact layers 6230, 6270, the second layer 6240, and the outer layers 6250, 6280 can include one or more sublayers. For example, at least one of the skin contacting layer and second layer can include a textile layer laminated to a thermoplastic polyurethane film sublayer. The coupling of any adjacent layers (e.g., skin contacting layer and the second layer, skin contacting layer and outer layer, second layer and outer layer) can include joining all the layers that comprise the adjacent layers.

Turning now to FIG. 63A, a flattened top view of an exemplary weld profile 6325 (e.g., weld pattern) disposed on a skin contacting layer 6330 is depicted. The exemplary weld profile defines toroidal macro-chambers with toroidal micro-chambers. The term, toroidal, within the context of FIG. 63A and for other described toroidal chamber embodiments described elsewhere, refers to the shape of the respective micro-chamber or macro-chamber when the chamber is in use and is wrapped around the user's limb. For example, each micro-chamber and macro-chamber from FIG. 63A, would form a general toroidal shape when in their operational configuration. It is also contemplated that in the case when a compression formation (e.g., a micro-chamber or a micro-chamber) is not sufficiently long to form a toroid during operational use (e.g., when wrapped around the user's limb), the term, toroidal, can refer to having a number of such compression formations aligned sequentially so as to collectively form a general toroidal shape, when the garment is in use. The weld profile and skin contacting layer are analogous to weld profile 6235 and skin contacting layer 6230 in FIG. 62A. For example, similar to the compression garments 6210, 6220 in FIGS. 62A and 62B, the welds 6336, 6337 couple the skin contacting layer 6330 to a second layer (not shown) disposed above the skin contacting layer and together form air-tight boundaries of the transverse macro-chambers 6340a-6340f.

The leg compression garment skin contact layer 6330 includes exemplary welds, such as perimeter weld 6336 at the outermost boundary of the skin contact layer 6330 and shared transverse macro-chamber welds 6337 defining the boundary between any two adjacent independent macro-chambers 6340a-6340f. The perimeter welds 6336 and shared transverse macro-chamber welds 6337 are solid or continuous with no openings to prevent or minimize the passage of air outside of a welded macro-chamber or between macro-chambers. These continuous welds define the outer edge of each macro-chamber. The perimeter welds may further create the tab for the compression garment (not shown) that includes the depicted skin contacting layer 6330.

Varying layouts or arrangements of typical micro-welds 6338 are contemplated in each of the depicted macro-chambers 6340a-6340f. The micro-welds 6338 define separate interconnected transverse micro-chambers 6350 within the macro-chambers 6340a-6340f. The micro-welds 6338 can be modified in length to customize the dimensions of the micro-chambers, the pressure, and the treatment density for a particular circulatory-related disorder. Openings or gaps 6339 created by discontinuous micro-welds 6338 can be positioned to control the expansion and direction of air through the macro-chambers 6340a-6340f and their corresponding micro-chambers 6350. In some implementations, providing a more rigid outer layer and a flexible inner (e.g., skin contact) layer, on the other hand causes the skin contact layer to mostly be deformed by the pressurization of the respective micro-chamber or macro-chamber, which can improve the overall efficiency of the compression therapy.

In comparing the patterns of skin contacting layers 6230, 6270 (and the overall compression garments 6210, 6220) with the pattern of the skin contacting layer 6330, alternative implementations of the foot section are depicted for a compression garment. For example, skin contacting layer 6230 includes a tongue section 6280 that conforms with the pattern of the garment 6210. The tongue section 6280 attaches with garment 6220 at opening 6215 to provide a two-piece combined leg and foot compression garment. In contrast, the exemplary compression garment based on the pattern of skin contacting layer 6330 is one-piece where a foot section 6320 extends from the macro-chamber 6340f and includes an opening 6325 that allows the foot section 6320 to be wrapped about the user's foot.

Turning now to FIG. 63B, a planar view of a representative exemplary section 6360 through generally toroidal (e.g., during use) macro-chambers with generally toroidal (e.g., during use) micro-chambers is depicted, including longitudinal welds defining micro-cells within the micro-chambers. The section 6360 depicts another exemplary arrangement of welds that can be implemented in a weld profile on a skin contacting layer to implement any of the described weld arrangements for a compression garment. Section 6360 includes a generally toroidal macro-chamber section 6370 that is subdivided into five generally toroidal micro-chambers 6375a-6375e, though more or fewer micro-chambers are contemplated. The macro-chamber is bounded by boundary welds 6387a, 6387b.

One or more of the plurality of micro-chambers are subdivided by a series of discontinuous longitudinal micro-cell welds, such as micro-cell welds 6389a-6389d, extending between transverse welds 6387a, 6387b, 6388a-6388d that define the micro-chamber and macro-chamber boundaries. The series of discontinuous longitudinal welds (e.g., 6389a-6389d) define micro-cells, such as micro-cell 6389, within the micro-chamber (e.g., micro-chamber 6375a). The micro-cells (e.g. 6389) formed along the length of a micro-chamber may further control the air flow and pressures, as well as the timing of the pressurisation, along the length of the micro-chamber (e.g., 6375a).

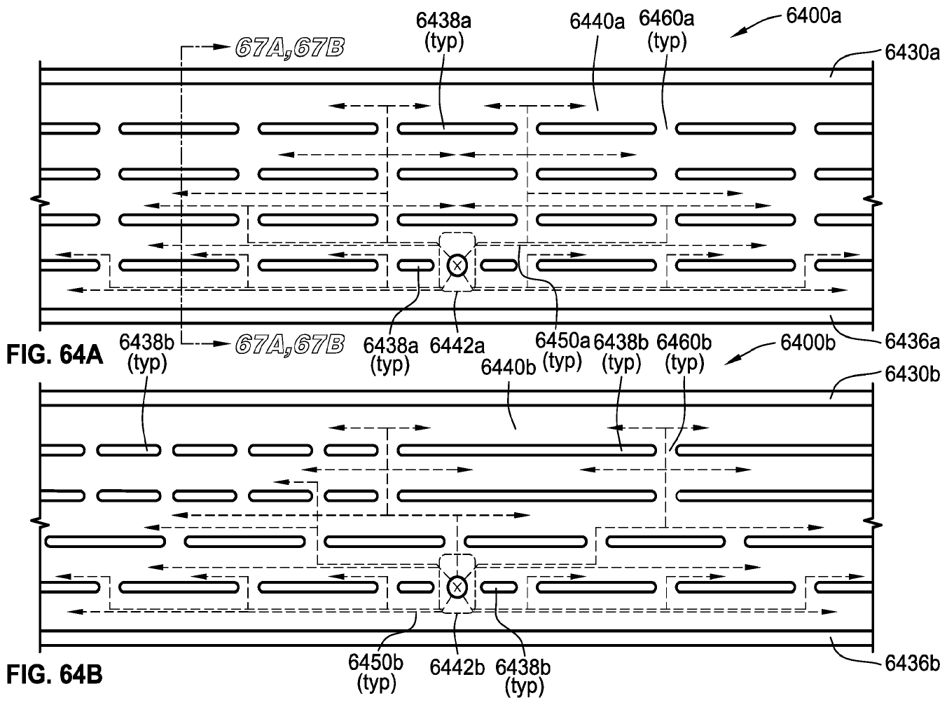

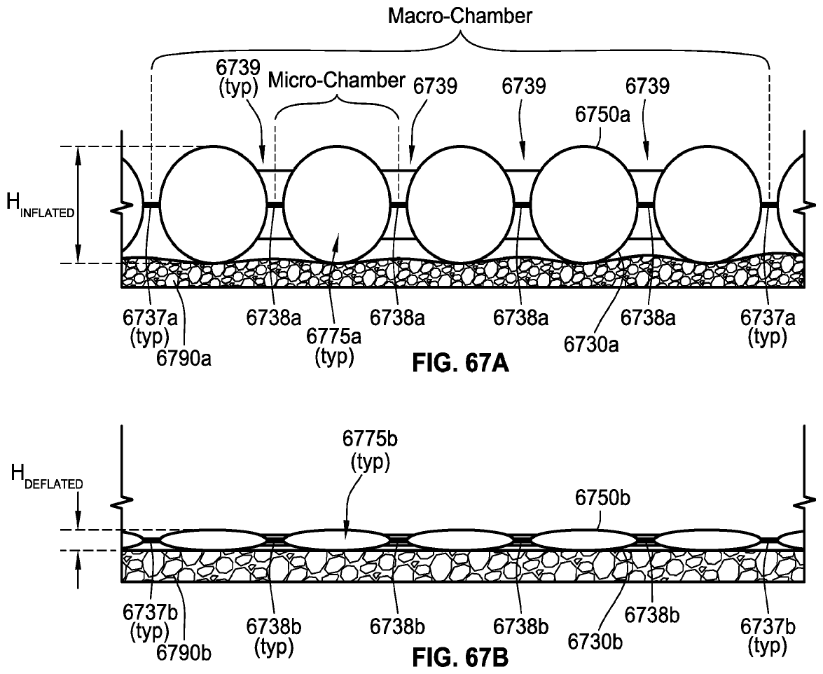

Turning now to FIGS. 64A and 64B, flattened top views of representative exemplary sections 6400a, 6400b through a generally toroidal (e.g., during use), macro-chamber with generally toroidal (e.g., during use), micro-chambers are illustrated with varying exemplary weld arrangements depicting air flow patterns. Sections 6400a, 6400b depict additional exemplary arrangements of welds that can be implemented in a weld profile between a skin contacting layer and a second layer or outer layer for a compression garment. Sections 6400a, 6400b are illustrated looking up from a skin contacting layer (not shown) toward a representative section of a second layer 6440a, 6440b. An exemplary cross-section through FIG. 64A is provided in FIGS. 67A and 67B, including the skin contact layer along with sections of an inflated and deflated state of exemplary toroidal chamber(s).

Section 6400a includes two macro-chamber welds 6430a, 6436a that define boundaries and are continuous with no openings. Similarly, section 6400b includes two macro-chamber welds 6430b, 6436b that are boundaries of another representative independent macro-chamber. Each section 6400a, 6400b further includes representative discontinuous transverse micro-welds 6438a, 6438b with representative openings 6460a, 6460b, that in combination, define a plurality of micro-chambers within the macro-chambers bounded by welds 6430a, 6436a and 6430b, 6436b. The openings in the discontinuous transverse micro-welds direct air flow within the macro-chamber.

Each of the representative sections of the second layer 6440a, 6440b can include a pneumatic connector 6442a, 6442b that is mounted or bonded to the second layer 6440a, 6440b such that the connector 6442a, 6442b penetrates the second layer with an air-tight seal about the connector at the penetration point. The connectors 6442a, 6442b allow pressurized air to enter the respective macro-chambers and disperse among the micro-chambers (or micro-cells, if present) as demonstrated by broken-line arrows showing exemplary air flow 6450a, 6450b within the sections 6400a, 6400b.

Openings along the discontinuous micro-welds are positioned to define compression zones for therapy during the operation of a compression garment, including the inflation and deflation of a particular micro-chamber or micro-cell within a macro-chamber. The micro-welds can be modified in length to customize the pressure and treatment density for a particular circulatory-related disorder. Furthermore, openings created by the discontinuous micro-welds can be positioned to control the movement and the timing of the movement of air through the chamber. For example, a specific change in the impedance of the openings between adjacent micro-chambers, or microcells within a micro-chamber, may create a desired pressure gradient and/or desired pressurizing sequence of the micro-chambers and the micro-cells. The different impedance (or resistance to flow) may be created by using connecting openings or channels of different dimensions (and/or of different shape, material, surface roughness, etc.) between chambers. A compression garment may have, for example, a similar chamber structure as depicted in FIGS. 64A and 64B with a series of adjacent macro-chambers, each comprising a series of elongated adjacent micro-chambers where each pair of adjacent micro-chambers are linked via a number of openings, for example along a weld boundary separating the adjacent micro-chambers. If a change (gradual or otherwise) is introduced in the size of the openings between each pair of adjacent micro-chambers within a macro-chamber, the change in the opening size may cause a gradual compression of the macro-chamber, starting from the micro-chamber where the pneumatic connector 6442b initially supplies the pressurized air, that gradually propagates through a series of progressively decreasing openings (e.g., at the border of each subsequent pair of micro-chambers) before reaching the other end of the macro-chamber.

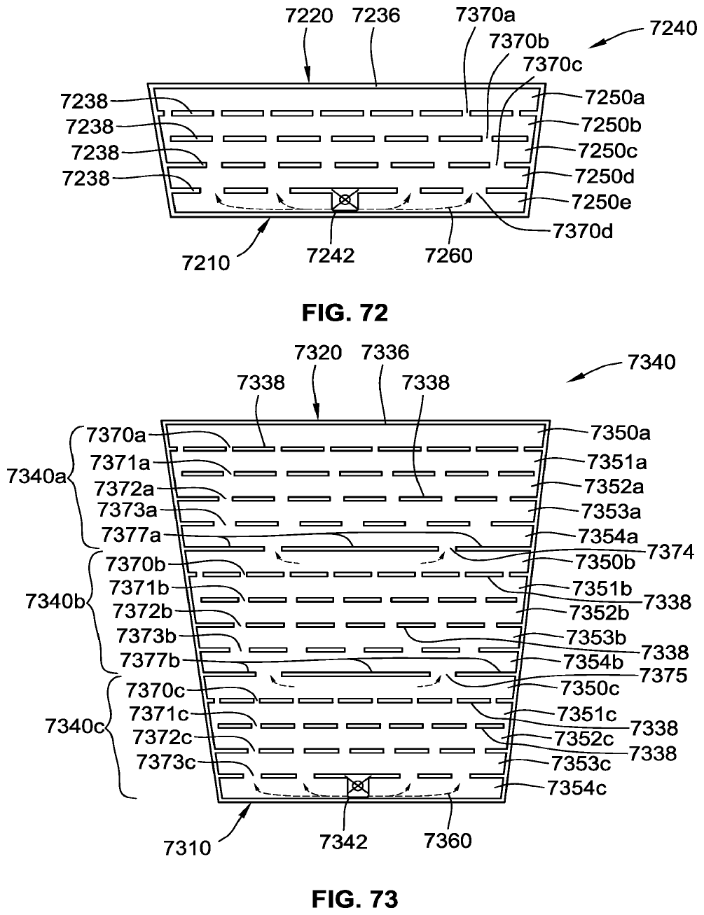

The progressively (or otherwise) decreasing opening arrangement may be extended to a series of adjacent micro-cells within a single micro-chamber (e.g., see FIG. 63B) or to adjacent macro-chambers. The result is a gradual compression of the entire garment, starting from a single pneumatic connector. It is contemplated that the change in impedance of the border openings may be profiled. For example, the openings can be continuously decreasing from the distal to the proximal end of the garment (e.g., see FIGS. 72 to 74). In some implementations, the profile may involve a step function—where the openings decrease at one given border, such as at a border between two adjacent macro-chambers), but then the openings may be maintained of the same size within at the border of adjacent pairs of micro-chambers throughout the macro-chamber. The openings may then be decrease in size again, such as at the next border between adjacent macro-chambers. It is contemplated that various arrangements of openings along borders between chambers can provide a wide range of compression therapy treatment options for a user.

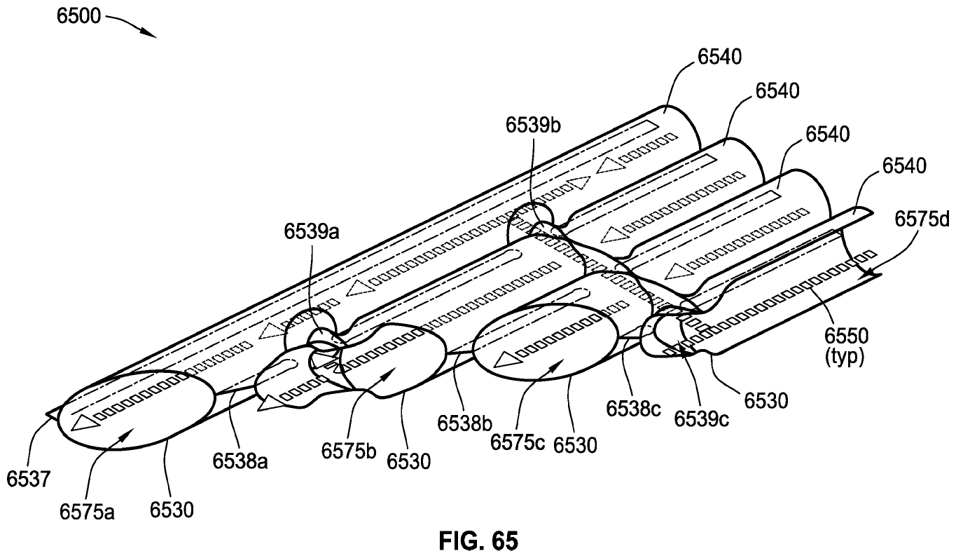

Turning now to FIG. 65, a perspective view of an exemplary inflated section 6500 of a generally toroidal macro-chamber with generally toroidal micro-chambers is illustrated including depictions of additional exemplary air flow patterns. The inflated generally toroidal macro-chamber section 6500 includes a perimeter weld 6537 that defines one boundary of the macro-chamber. The macro-chamber includes a plurality of toroidal micro-chambers, such as micro-chamber 6575a-6575d. Each of the micro-chambers are separated by discontinuous micro-welds, such as micro-welds 6538a, 6538b, 6538c. The discontinuous micro-welds include 6538a, 6538b, 6538c which define one or more openings between the toroidal micro-chambers, such as openings or conduits 6539a, 6539b, 6539c. The macro-chamber is formed by the coupling of a skin contact layer 6530 with a second layer 6540 via welding, such as transverse welds 6537, 6538a-6538c. The macro-chamber can be further formed by coupling the layers via any longitudinal welds that may be used, for example, to form micro-cells within the toroidal micro-chambers.

A typical air flow pattern 6550, within inflated section 6500, includes pressurized air flowing along larger chamber volumes and then into smaller chambers. Full expansion of a macro-chamber is achieved from the origin of the air entering the chamber, such as at a connector disposed in the second layer (see FIGS. 62A and 62B and 64A and 64B). From the connector or origin, the air entering a macro-chamber then disperses to the outer edges until all the micro-chambers and micro-cells within the macro-chamber are fully expanded. In some implementations, the dispersion may be substantially instantaneous, such as where a large number of interconnecting openings or channels are provided between the micro-chambers and micro-cells. In some implementations, the dispersion may be progressive with controlled timing, such as where a suitable distribution of changes of opening or channel dimensions provides a particular pressurization sequence.

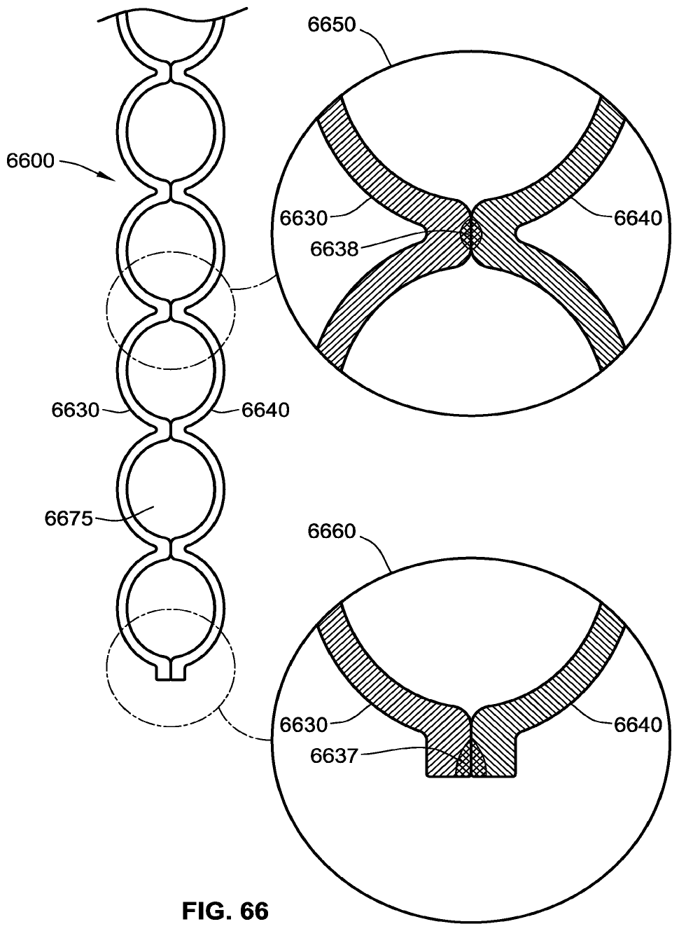

Turning now to FIG. 66, an exemplary longitudinal cross-section 6600 through a portion of a compression garment depicts weld details 6650, 6660 for forming chambers. The cross-section 6600 includes the skin contact layer 6630 and a second layer 6640 bonded together along transverse weld lines to form a plurality of toroidal chambers 6675, such as toroidal micro-chambers that are part of an independent air-tight toroidal macro-chamber. Weld detail 6650 includes an exemplary weld line 6638 that may be used for a micro-weld between two micro-chambers or for a weld between two adjacent macro-chambers. Weld detail 6660 includes an exemplary welded edge 6637 used to seal a perimeter of a compression garment thereby creating an air-tight seal along the perimeter boundaries of the macro-chamber(s).

Turning now to FIGS. 67A and 67B, exemplary longitudinal cross-sections through a portion of a compression garment are illustrated depicting an inflated profile (FIG. 67A) and a corresponding deflated profile (FIG. 67B) for an exemplary macro-chamber with a plurality of micro-chambers 6775a, 6775b. The garment profile extends from the top of an outer layer 6750a, 6750b to the bottom of a skin contact layer 6730a, 6730b. The garment profile in the inflated state, with the micro-chambers in the macro-chamber fully expanded, has a height, H_{INFLATED}, less than about 35 mm in some implementations, less than 25 mm in some implementation, between about 14 mm and 22 mm in some implementations, and less than 20 mm in some implementations. The garment profile in the deflated state, with the micro-chambers in the macro-chamber compressed, has a height, H_{DEFLATED}, that is approximately half or less than the inflated height. In some implementations the height, H_{DEFLATED}, is about 10 mm or less.

Each of the micro-chambers are formed by transverse micro-welds 6738a, 6738b coupling the second layer (e.g., in some implementations the second layer is disposed below the outer layer 6750a, 6750b) to the skin contact layer 6730a, 6730b. Shared transverse macro-chamber welds 6737a, 6737b on the ends of the macro-chamber form a boundary of the macro-chamber with another adjacent macro-chamber. In the deflated state of FIG. 67B, the compression garment rests loosely about the uncompressed skin layer 6790b. In the inflated state of FIG. 67A, the compression garment expands and compresses the skin layer to provide a wavy compressed skin layer 6790a. The centrelines for the points of compression of the skin layer 6790a by adjacent micro-chambers are separated by approximately the same distance as H_{INFLATED}. It is contemplated that during operation, the expansion of the compression garment, and of the individual chambers and cells, can be controlled by how tightly the garment is attached to a user's limb. Because of this, the specific location and configuration of the welds that connect the micro-chambers to each other can be particularly relevant. For example, in the arrangement of FIGS. 67A and 67B, the welds are formed around mid-height of the microcells (in their expanded configuration). As a result, the micro-chambers can generally expand in both directions (towards the user's skin, as well in the opposite direction).

In some implementations, gaps or openings between discontinuous transverse micro-welds create bridges 6739 between each micro-chamber 6775a. The bridges can increase the effective treatment surface area of the compression garment where the expanded micro-chambers depress the skin layer 6790a sufficiently to allow the bridges to apply pressure to the skin. These air flow gaps or openings between the discontinuous transverse micro-welds also minimize creasing or distortion of chambers when a compression garment is wrapped around a user's limb. This allows for a tailored fit when the user is wearing the garment.

An advantageous aspect of the present disclosure includes the low-profile nature (e.g., see FIG. 67B) of the disclosed compression garments associated, for example, with the two- or three-layer only structure of the compression garment. The arrangement of the micro-chambers is primarily formed and visible on the interior side (e.g., where the skin contact layer is located) of the compression garment, while the outside layer is relatively smooth or planar, providing an aesthetically pleasing clean finish. In addition, the introduction of micro-chambers within the macro-chambers and of micro-cells within the micro-chambers, provides an increased spatial resolution relative to the dimension of the skin contact areas. For example, the described compression garment can provide an approximate five-fold improvement in the number of compression points (e.g., the intersection of the inflated micro-chambers, such as chamber 6775a, with the surface of the skin layer 6790a) over prior systems. This allows for closer contouring to a user's body by reducing the distance of pivot points at the welds from the skin surface. This is beneficial for the efficacy of lymphatic therapy, along with the usability and portability of the compression garment by the user. For example, with the present technology, massage treatment to the underlying lymphatic system controls lymph fluid stimulation within the skin tissue and its release, along with directing the fluid to the lymphatic nodes for drainage and transportation from subcutaneous tissue back to the venous system. Advantageously, the micro-chambers and micro-cells of the present technology are contemplated to include sizes to mimic a fingerprint indentation into the skin during therapy.

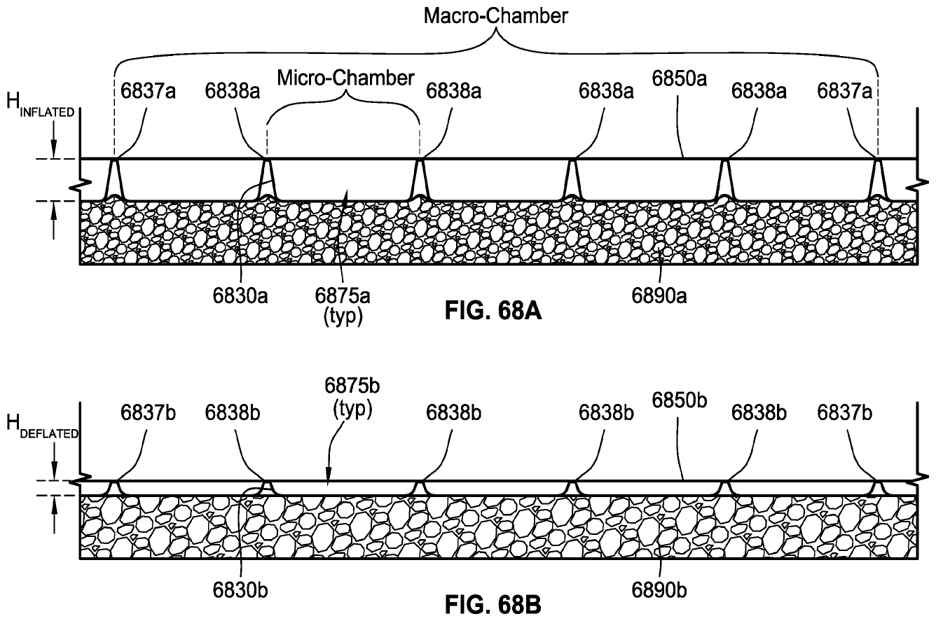

Turning now to FIGS. 68A and 68B, other exemplary longitudinal cross-sections through a portion of a compression garment are illustrated depicting an inflated profile (FIG. 68A) and a corresponding deflated profile (FIG. 68B) including a macro-chamber with a plurality of micro-chambers 6875a, 6875b. The garment profile extends from the top of an outer layer 6850a, 6850b to the bottom of a skin contact layer 6830a, 6830b. The garment profile in the inflated state, with the micro-chambers in the macro-chamber fully expanded, has a height, H_{INFLATED}, less than about 30 mm in some implementations, less than 25 mm in some implementation, between about 14 mm and 22 mm in some implementations, between about 10 mm and 18 mm in some implementations, and less than about 15 mm in some implementations. The garment profile in the deflated state, with the micro-chambers in the macro-chamber compressed, has a height, H_{DEFLATED}, that is approximately eighty to ninety percent or less than the inflated height. In some implementations the height, H_{DEFLATED}, is about 12 mm or less.

Each of the micro-chambers are formed by transverse micro-welds 6838a, 6838b coupling the second layer (e.g., in some implementations the second layer is disposed below the outer layer 6850a, 6850b) to the skin contact layer 6830a, 6830b. Shared transverse macro-chamber welds 6837a, 6837b on the ends of the macro-chamber form a boundary of the macro-chamber with another adjacent macro-chamber. In the deflated state of FIG. 68B, the compression garment rests loosely about the uncompressed skin layer 6890b. In the inflated state of FIG. 68A, the compression garment expands and compresses the skin layer to provide a more uniformly compressed skin layer 6890a than the section described for FIG. 67A.

In some implementations, the plurality of toroidal (e.g., during use) micro-chambers are welded, during fabrication, to include excess material to provide an expansion volume such that the skin contacting layer expands away from the second layer and toward a patient's skin during pressurization of the compression garment. For example, the skin contacting layer may be at least partially formed into cells before welding the skin contacting layer to the second or outer layer.

An advantageous aspect of the macro-chamber structure in FIGS. 68A and 68B is the low profile nature such a cross-section provides for the disclosed compression garments. Furthermore, the micro-welds in this case are formed close to one side of the microcells. As a result, upon compression, the micro-chambers inflate mostly inwards—e.g., towards the user's skin—rather than outwards. The desirable outcome is that most, or effectively all, of the pneumatic pressure applied via the volume of the micro-chamber is delivered into the skin layer and expands inwards toward the plane of the skin surface.

Turning now to FIG. 69, a flattened perspective view of a compression system 6900 is depicted including a spine 6960 that can be attached to the fully welded garment 6910. An advantageous aspect of the compression system 6900 is that is encapsulated in an air/water tight pneumatic spine housing. It is contemplated that reference to spine, refers at least in part to the integrity and the rigidity of the underlying layer needed to support the various components and configuration of the spine. In addition, the reference to spine, also refers to the centralised manner in which the valves are located proximate to each other in a confined spot, which provides easy assembly, inspections, maintenance, and protection of the valve arrangement. The use of a centralized valve system, that is separate from the CPG, can be desirable as it provides for a more streamlined, low profile compression garment 6910 that allows the fabrication of a compact and easy to use CPG system (e.g., including the compression garment, tube and CPG) with an improved user experience. As the spine houses the pneumatic “heart” of the garment (e.g., the valve configuration and its pneumatic connections to the main air supply line and the pressure lines feeding the macro-chambers), the spine is referred to as a pneumatic spine. In some implementations, the pneumatic link between the CPG and the garment includes a single pressurized line. The links between the main line and each of the valves are of minimal length and can be fitted within the spine enclosure.

Alternatively, a distributed valve system can be used where the valves are spread throughout the garment. The valves are still located on the garment and are separated from the CPG where the separation can provide a more pleasing, compact and easy to maintain design, as the pneumatic link between the CPG and the garment still includes a single pressurised line. The links between this main line and each of the valves can be concealed in the structure of the compression garment. In contrast, an alternative scenario can include the valves being in an arrangement separate from the compression garment. In this alternate scenario, each valve would be independently connected to a respective valve on the compressions garment. However, this results in a number of pressurized tubes extending from the valve arrangement (i.e. the valves may be enclosed with the CPG) to the garment, requiring special effort to secure them, to ensure their safe use and to conceal them for a better aesthetic appeal.

In some implementations, the pneumatic spine is about 20 cm to about 30 cm long and about 8 cm to about 10 cm wide. In some implementations, the pneumatic spine can be anywhere between about 5 cm to about 70 cm long and anywhere between about 5 cm to about 30 cm wide. It is contemplated that the spacing of valves in the pneumatic spine is approximately about 2 cm to 3 cm apart. In some implementations, the valve spacing can be anywhere from about 0 cm (i.e., adjacent) to about 10 cm apart.

Compression system 6900 includes an exemplary leg compression garment 6910 with an outer layer 6950. The exemplary system 6900 is a two-piece system with a foot compression garment 6920 that can be attached to the leg compression garment 6910. Other configurations of compression systems are contemplated including a one-piece system (e.g., extending from upper leg to foot or toes) or a multi-piece system (e.g., one for the thigh, one for the lower leg, one for the foot, one for the toes, or combinations thereof). A pneumatic spine 6960 is disposed underneath the outer layer 6950 near the top of the leg compression garment 6910, and provides pressurized air to both compression garments 6910, 6920. Valves controlling the pressurisation and evacuation of the chambers in the compression garments are located in a watertight pneumatic spine 6960.

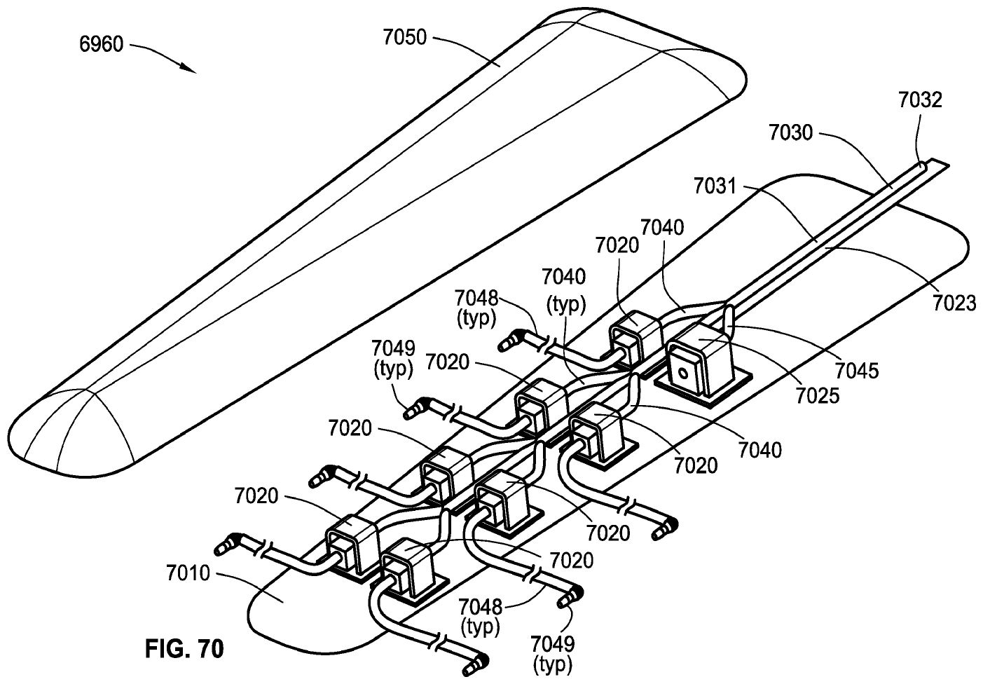

Turning now to FIG. 70, a partially exploded perspective view of the pneumatic spine 6960 is depicted. The pneumatic spine 6960 includes a bottom layer 7010 and a cover assembly 7050. The bottom layer 7010 may be formed by one or more of the chamber-forming layers of the garment, or may be an additional layer. The bottom layer 7010 and the cover assembly 7050 define an interior space to house one or more valve connectors 7020, and one or more secondary air connecting lines 7040 that connect the valves to a primary air connecting line 7030. Optionally, the spine may further include an exhaust valve connector 7025, an exhaust secondary line 7045, portions of one or more tertiary macro-chamber air lines 7048, and an electrical cable 7023, that together provide for a fluid connection with one or more macro-chambers in a compression garment. The specific arrangement shown also includes a portion 7031 of the primary air connecting line 7030, but this is also optional, as the line 7030 may plug into a socket on the boundary of the spine, to which each connecting line 7040 may be attached.

The valve connectors 7020 are mounted to the bottom layer 7010. A primary air connecting line 7030, via an interior portion 7031, is in fluid connection with one or more secondary air connecting lines 7040 that are each coupled to a corresponding one of the of valve connectors 7020. In some implementations, the pneumatic spine 6960 further includes the exhaust valve connector 7025 that may include a two-way valve for removing air from any one of the macro-chambers in a compression garment. The exhaust valve connector 7025 is connected to the exhaust secondary line 7045 that branches off the interior portion 7031 of the primary air connecting line 7030. The exhaust valve connector allows for chamber air to be exhausted to ambient pressure during depressurization of a chamber.

Separate tertiary macro-chamber air lines 7048 may be optionally included to extend from each of the valve connectors 7020 and penetrate the cover assembly 7050 or the bottom layer 7010 through a sealed opening (not shown) in the cover assembly 7050 or the bottom layer 7010. The valve connectors 7020 are pneumatically connectable to connectors 6242 on the second layer 6240 (FIG. 62A) and/or the connector 6285 on the outer layer 6280 (FIG. 62B) via the tertiary macro-chamber air lines 7048. Each of the tertiary macro-chamber air lines 7048 may be directly connectable to the connectors (e.g., 6242, 6285) or may be arranged to (e.g., via a fitting 7049) connect to another tertiary line (not shown) that is itself physically connectable to the connectors (e.g., 6242, 6285) directly attached to the macro-chambers. The described pneumatic spine 6960 configuration allows for independent pressurization and/or depressurization of each of the independent macro-chambers of a compression garment by selectively allowing and preventing air flow at the valve connectors 7020 and the exhaust valve connector 7025. At the same time, the valves and all connecting lines—primary, secondary and tertiary—are conveniently organised in a compact manner.

An opening (not shown) in the cover assembly 7050 or the bottom layer 7010 allows a second portion 7032 of the primary connecting line 7030 and the electrical cable 7023 to extend out of the interior space. The opening is sealed about the second portion 7032 of the primary connecting line 7030 and the electrical cable 7023.

In some implementations, the housing (comprising the bottom layer 7010 and the cover assembly 7050), along with the sealed opening(s), provides a water tight and/or air-tight seal around the valve arrangement, to minimize fluid entering the interior space. The bottom layer 7010 and the cover assembly 7050 may be fabricated to include thermoplastic polypropylene materials.

In some implementations, a controller for the pneumatic spine 6960 may be used to cycle the pressurization of the chambers in a compression garment between at least two different pressure levels to provide a massage to a body part of the user. In some implementations, the plurality of valve connectors 7020 are configured to selectively direct pressurized air received from the primary connecting line 7030 to respective chambers in a compression garment via the valve connectors 7020. The controller can be configured to selectively control operation of the valve connectors 7020 to correspond to chambers in different zones of the compression garment. Other valve connector operations by the controller are also contemplated to assist with the pressurization and depressurization of the chambers of a compression garment.

In some implementations, a controller for a compression garment can be divided into multiple zone for purposes of controlling air flow. Each zone can have one or more macro-chambers. For example, the controller operation can identify multiple macro-chambers (e.g., chambers 1, 2, and 3) as being a part of the same pressurization zone (e.g., zone 1) where the CPG can control zones rather than individual macro-chambers by turning on and off the valves necessary to pressurize and/or exhaust the macro-chambers (e.g., chambers 1, 2, and 3) within a controller-identified pressurization zone (e.g., zone 1).

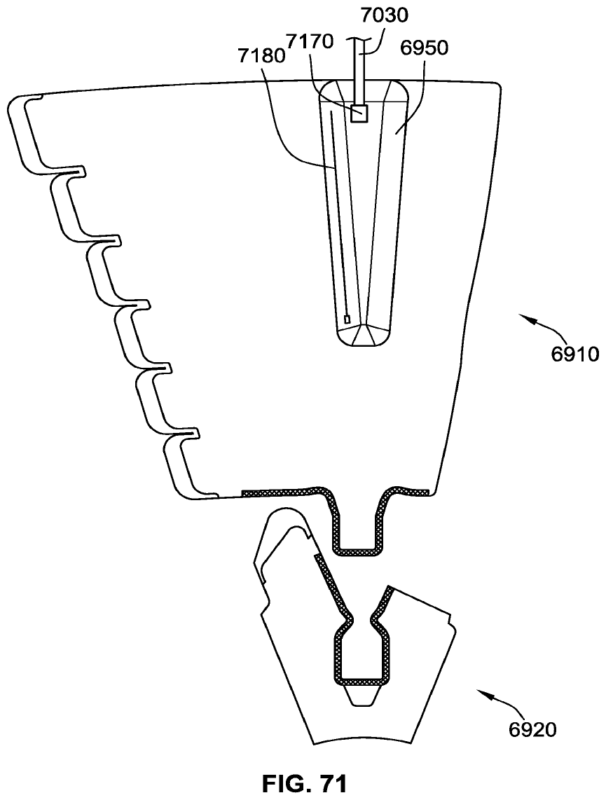

Turning now to FIG. 71, a top view of the compression system 6900 of FIG. 69 is depicted with the pneumatic spine 6960 inserted into the fully welded leg compression garment 6910. As described for FIG. 70, the pneumatic spine 6960 comprises a waterproof arrangement (e.g., bottom layer 7010 and cover assembly 7050). The pneumatic spine 6960 can be disposed underneath the outer layer 6950, as illustrated by outer layer 6950 taking the shape of the cover assembly 7050 of the inserted pneumatic spine 6960. The inserted pneumatic spine can extend from approximately a knee location to a thigh location of the leg compression garment 6910. Thus, the pneumatic spine 6960 is also sufficiently compact so that it does not cross or intersect a joint in the body of a user wearing the garment, making the experience of wearing the garment less disruptive and more comfortable for the user.

In some implementations, the pneumatic spine 6960 is accessible through the outer layer 6950 via a waterproof resealable mechanism 7180 (e.g., such as a waterproof zipper disposed on the outer layer 6950). In some implementations, for aesthetic reasons, an edge of the outer layer 6950 can include a hidden waterproof zipper than provides access for placing and repairing the pneumatic spine 6960. It is further contemplated that a garment interface patch 7170 may be bonded to the outer layer 6950 to receive the primary connecting line 7030 of the pneumatic spine 6960 and to further allow the pneumatic spine 6960 to interface with components external to the compression garment, such as air and electrical components.

Turning now to FIGS. 72 to 74, exemplary planar top views are depicted of sections through macro-chamber(s) of a compression garment subdivided into micro-chambers, including openings along chamber borders where the openings fluidly connect adjacent micro-chambers and/or adjacent macro-chambers. The illustrated implementations include a single connector for one or more macro-chambers connected to a single pressurized air supply line. Air propagates into and throughout the chambers as determined by a connection profile (e.g., a weld profile) used to create the chambers of the compression garment. For example, pressurized air can propagate along the limb from a distal end to a proximal end of a chamber or group of chambers of the compression garment.

Referring to FIG. 72, a macro-chamber 7240 is subdivided into a plurality of micro-chambers 7250a-7250e, with different sized openings 7370a-7370d connecting adjacent micro-chambers 7250a-7250e. The openings connecting each consecutive pair of adjacent micro-chambers can decrease progressively from the distal end 7210 to the proximal end 7220 of the compression garment. The macro-chamber 7240 is bounded laterally by the perimeter boundary 7236 that may be created via a welding process or other techniques describes elsewhere in the present disclosure.

The micro-chambers 7250a-7250e are similarly created by the exemplary micro-chamber boundaries 7238 within the interior of the macro-chamber 7240. As pressurized air enters the macro-chamber 7240 at the pneumatic coupling 7242, it propagates along pathways 7260 and through opening 7370d into micro-chamber 7250d and then through progressively smaller openings (e.g., 7370c, 7370b, 7370a) until the pressurized air reaches micro-chamber 7250a at the proximal end 7220 of the macro-chamber 7240.

Referring now to FIG. 73, three adjacent macro-chambers 7340a-7340c similar to macro-chamber 7240 are depicted, except that each of the macro-chambers 7340a-7340c are interconnected by a first set of openings 7374 and a second set of openings 7375 along the respective macro-border border seams 7377a, 7377b between macro-chambers 7340a-7340b and 7340b-7340c. The first and second sets of openings 7374, 7375 are of different sizes.

Macro-chamber 7340a is subdivided into a plurality of micro-chambers 7350a, 7351a, 7352a, 7353a, 7354a with different sized sets of openings 7370a, 7371a, 7372a, 7373a along the respective micro-chamber borders 7338 between the micro-chambers 7350a, 7351a, 7352a, 7353a, 7354a. Similarly, macro-chamber 7340b is subdivided into a plurality of micro-chambers 7350b, 7351b, 7352b, 7353b, 7354b with different sized sets of openings 7370b, 7371b, 7372b, 7373b along the respective micro-chamber borders 7338 between the micro-chambers 7350b, 7351b, 7352b, 7353b, 7354b. Likewise, macro-chamber 7340c is subdivided into a plurality of micro-chambers 7350c, 7351c, 7352c, 7353c, 7354c with different sized sets of openings 7370c, 7371c, 7372c, 7373c along the respective micro-chamber borders 7338 between the micro-chambers 7350c, 7351c, 7352c, 7353c 7354c.

The sets of openings 7374, 7375 connecting each consecutive pair of adjacent macro-chambers can decrease progressively from the distal end 7310 to the proximal end 7320 of the compression garment. Similarly, the sets of openings 7370a-c, 7371a-c, 7372a-c, 7373a-c connecting each consecutive pair of adjacent micro-chambers can also decrease progressively from the distal end 7310 to the proximal end 7320 of the compression garment. The group of three macro-chambers 7340a-7340c are constrained laterally by the perimeter boundary 7336 that may be created via a welding process or other techniques describes elsewhere in the present disclosure. The micro-chambers 7350a-c, 7351a-c, 7352a-c, 7353a-c, 7354a-c are similarly created by the exemplary micro-boundaries 7338 within the interior of their respective macro-chambers 7340a-7340c.

As pressurized air enters the first macro-chamber 7340c at the pneumatic coupling 7342, it propagates along pathways 7360 and through the first set of openings 7373c into micro-chamber 7353c and then through progressively smaller openings (e.g., 7372c, 7371c, 7370c) until the pressurized air reaches macro-chamber 7340b. The pressurized air similarly progresses through macro-chamber 7340b to macro-chamber 7340a until it reaches micro-chamber 7350a at the proximal end 7320 of the macro-chamber 7340a.

The implementation described for FIG. 73 can be advantageous because the entire compression garment can be inflated with a single pressurized air tube and a single pneumatic coupling 7342. The use of multiple interconnected macro-chambers can also provide a more segmented pressure transfer in a compression garment because the inflations of the chambers can be controlled by the opening between adjacent macro-chambers.

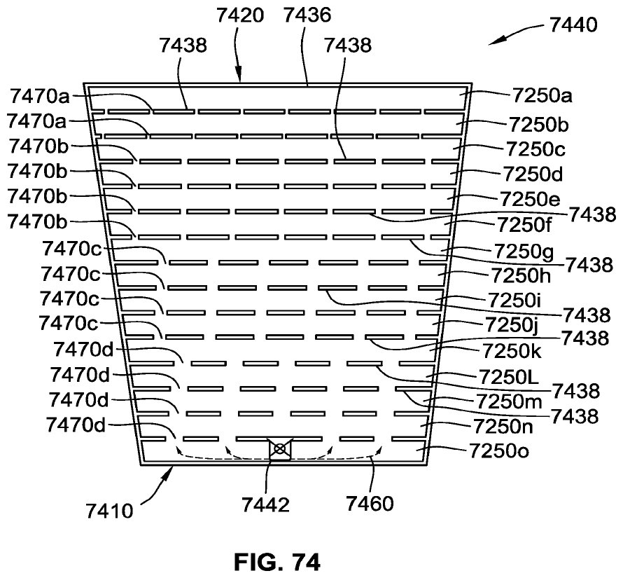

Referring now to FIG. 74, a single macro-chamber 7440 constrained laterally by a perimeter seam 7436 is depicted that is subdivided into a plurality of micro-chambers 7250a-7250o having sets of openings 7470a-7470d along the borders 7438 defining the plurality of micro-chambers 7250a-7250o. The sets of openings 7470a-7470d progressively decrease in size. For example, the set of openings 7470d connecting consecutive pairs of adjacent micro-chambers 7250k-7250o are the same size. However, there is a decrease in size between the sets of openings 7370d and 7370c when moving from micro-chambers 7250k-7250o to micro-chambers 7250g-7250j. Similarly, there is a decrease in size between the sets of openings 7370c and 7370b when moving from micro-chambers 7250g-7250j to micro-chambers 7250c-7250f. Likewise, there is a decrease in size between the sets of openings 7370b and 7370a when moving from micro-chambers 7250c-7250f to micro-chambers 7250a-7250b. The size of the sets of openings 7470a-7470d effectively decreases progressively when moving from the distal end 7410 to the proximal end 7420 of the compression garment.

The use of the single macro-chamber 7440 of a compression garment configured similar to FIG. 74, when similarly sized as the combined three macro-chamber 7340a-7340c compression garment configuration of FIG. 73, can provide a smoother, more continuous, pressure transfer profile than the segmented pressure transfer expected during the inflation of a compression garment with a FIG. 73 configuration.

The segmented vs. smooth approaches each have their advantages and can be tailored based on a user's condition. For example, if a user has severe lower leg venous disease related edema, a more gradual or smooth pressure transfer profile will be more desirable. In contrast, if a user has a fibrotic limb, a more segments pressure transfer profile would be desirable.

It is contemplated that opening sizes between macro-chambers, micro-chambers within macro-chambers, or micro-cells within micro-chambers will be different and include larger sizes, smaller sizes, or have some step function with various sequential sizes. The combination of opening sizes between chambers or cells will determine how quickly and how smoothly a compression garment will inflate from bottom to top or from side to side. For instance, if we have decreasing opening sizes from a bottom chamber to a top chamber of a compression garment, it is likely that the garment will quickly inflate its bottom part, but how quickly the top parts will inflate will depend on the specific function used for the sizes of the openings between adjacent interconnected micro-chambers and/or macro-chambers.

In some implementations, it is contemplated that some sizes of openings between chambers of cells may limit or even completely prevent inflation of a chamber or cell of a compression garment for a given low-flow of the CPG. Thus, it is contemplated that an interplay between the provided flow and the size of the opening can provide some level of timing- and/or spatial—control over the inflation of a compression garment.

According to certain aspects of the present disclosure, an Alternative Implementation A is a compression garment for circulatory-related disorder therapy. The compression garment includes a skin contacting layer, a second layer coupled to the skin contacting layer, and one or more connectors disposed on the second layer. The skin contacting layer and the second layer form one or more macro-chambers. Each macro-chamber is partitioned into a plurality of micro-chambers. Each of the plurality of micro-chambers is in direct fluid communication with at least one other of the plurality of micro-chambers. Each of the one or more connectors is configured to supply pressurized air directly into at least a corresponding one of the one or more macro-chambers such that the pressurized air is delivered to at least one of the plurality of micro-chambers within the macro chamber. The coupling of the skin contacting layer and the second layer is along a layer attachment profile that defines the one or more macro-chambers and the plurality of micro-chambers. At least one of the plurality of micro-chambers is linked to another of the plurality of micro-chambers by way of a plurality of openings.

An Alternative Implementation B includes the compression garment aspects of Alternative Implementation A and further includes the skin contacting layer and the second layer form one or more independent macro-chambers.

An Alternative Implementation C includes the compression garment aspects of any one of Alternative Implementations A or B and further includes that each macro-chamber is generally toroidal and is partitioned into a plurality of generally toroidal micro-chambers. The one or more macro-chambers and/or the plurality of micro-chambers are elongated and arranged such that in an operational configuration of the compression garment around a limb of a user. One or more of the macro-chambers and/or one or more of the plurality of micro-chambers form, individually or in combination, a generally toroidal shape.

An Alternative Implementation D includes the compression garment aspects of any one of Alternative Implementations A to C and further includes that at least one of the micro-chambers comprises a plurality of micro-cells and that the pressurized air is delivered substantially simultaneously to the plurality of micro-cells.

An Alternative Implementation E includes the compression garment aspects of any one of Alternative Implementations C or D and further includes that at least some of the plurality of openings between elongated adjacent micro-chambers are positioned along a border between the adjacent micro-chambers.

An Alternative Implementation F includes the compression garment aspects of any one of Alternative Implementations A to C and further includes that the plurality of micro-chambers within each macro-chamber are interlinked such that pressurized air provided to at least one of the micro-chambers can flow to others of the plurality of micro-chambers within a respective macro-chamber.

An Alternative Implementation G includes the compression garment aspects of any one of Alternative Implementations A to F and further includes that the layer attachment profile is formed by welding or fusing.

An Alternative Implementation H includes the compression garment aspects of any one of Alternative Implementations A to G and further includes that the layer attachment profile is formed by welding. A plurality of the one or more macro-chambers are disposed adjacent to each other and separated by welds. Each of the plurality of micro-chambers form at least a portion of a row of a corresponding macro-chamber.

An Alternative Implementation I includes the compression garment aspects of any one of Alternative Implementations B to H and further includes that at least one of the one or more macro-chambers is an independent macro-chamber having at least three rows of fluidly connected micro-chambers.

An Alternative Implementation J includes the compression garment aspects of any one of Alternative Implementations A to I and further includes that each of the one or more macro-chambers has a length, a width, and an uninflated thickness. The length is between about 100 millimeters and about 900 millimeters, the width is between about 70 millimeters and about 150 millimeters, and the uninflated thickness is between about 1 millimeter and about 20 millimeters.

An Alternative Implementation K includes the compression garment aspects of any one of Alternative Implementations A to J and further includes that the compression garment is configured for therapy treatment for a human limb. The layer attachment profile includes perimeter welds about the perimeters of the skin contacting layer and the second layer. A plurality of welds is aligned with the circumference of the limb during operational use of the compression garment. The welds define boundaries of the one or more macro-chambers and further define the boundaries between the plurality of micro-chambers.

An Alternative Implementation L includes the compression garment aspects of Alternative Implementation K and further includes that at least some of the welds defining the micro-chambers are discontinuous.

An Alternative Implementation M includes the compression garment aspects of Alternative Implementation L and further includes that one or more of the plurality of micro-chambers are subdivided by a series of discontinuous welds defining micro-cells within the micro-chamber. The micro-cells control air flow within respective ones of the one or more of the plurality of micro-chambers.

An Alternative Implementation N includes the compression garment aspects of any one of Alternative Implementations A to M and further includes that the plurality of micro-chambers are welded to include an expansion volume such that the skin contacting layer expands away from the second layer and toward a patient's skin during inflation of the compression garment.

An Alternative Implementation O includes the compression garment aspects of any one of Alternative Implementations A to M and further includes that an outer layer disposed on the second layer. The outer layer is a generally flat surface.

An Alternative Implementation P includes the compression garment aspects of Alternative Implementation O and further includes that the outer layer is less flexible than the skin contact layer causing expansion of the compression garment to be generally directed towards the skin contact layer.

An Alternative Implementation Q includes the compression garment aspects of any one of Alternative Implementations O or P and further includes that the thickness of the compression garment is of a low-profile with an uninflated outer layer to a skin contacting layer thickness of less than about 12 mm and an inflated outer layer to skin contacting layer thickness of about less than about 25 mm.

An Alternative Implementation R includes the compression garment aspects of any one of Alternative Implementations A to Q and further includes a pneumatic spine including one or more valves located proximally to each other. Each of the one or more valves are pneumatically connected to a corresponding one of the one or more connectors.

An Alternative Implementation S includes the compression garment aspects of Alternative Implementations R and further includes that the pneumatic spine is disposed underneath the outer layer and extends from approximately a knee location to a thigh location of the compression garment as worn by a user.

An Alternative Implementation T includes the compression garment aspects of any one of Alternative Implementations R or S and further includes that the pneumatic spine includes a primary connecting line connected to one or more secondary connecting lines that are each coupled to a corresponding one of the one or more valves to allow independent pressurization of each of the one or more macro-chambers.

An Alternative Implementation U includes the compression garment aspects of any one of Alternative Implementations R to T and further includes that the pneumatic spine comprises an exhaust valve configured to selectively fluidly connect the one or more macro-chambers to ambient pressure to allow independent depressurisation of each of the one or more macro-chambers.

An Alternative Implementation V includes the compression garment aspects of any one of Alternative Implementations A to U and further includes a controller configured to cycle the pressurization of the one or more macro-chambers between at least two different pressure levels to provide a massage to a user wearing the compression garment on a body part of the user.

An Alternative Implementation W includes the compression garment aspects of any one of Alternative Implementations R to V and further includes that the one or more valves are configured to selectively direct pressurized air received from the primary connecting line to respective ones of the one or more macro-chambers.

An Alternative Implementation X includes the compression garment aspects of any one of Alternative Implementations A to W and further includes that the controller is configured to selectively control operation of a plurality of the one or more valves to correspond to a plurality of the one or more macro-chambers in different zones of the compression garment.

An Alternative Implementation Y includes the compression garment aspects of any one of Alternative Implementations A to X and further includes that the compression garment is an integral one-piece garment configured to extend from the foot to the thigh.

An Alternative Implementation Z includes the compression garment aspects of any one of Alternative Implementations A to Y and further includes that the compression garment is configured for both a human leg and foot. The compression garment is a multiple-piece system for different sections of the leg and foot.

An Alternative Implementation AA includes the compression garment aspects of Alternative Implementation Z and further includes that one section of the compression garment includes a sole piece.

An Alternative Implementation AB includes the compression garment aspects of any one of Alternative Implementations A to AA and further includes that the compression garment includes a leg garment and a foot garment welded to the leg garment.

An Alternative Implementation AC includes the compression garment aspects of any one of Alternative Implementations A to Y and AA and further includes that the compression garment includes a leg garment and a foot garment. The foot garment includes a separate macro-chamber with a plurality of micro-chambers.

An Alternative Implementation AD includes the compression garment aspects of any one of Alternative Implementations R to AC and further includes that the pneumatic spine is disposed within a waterproof arrangement and is accessible from underneath the outer layer via a waterproof closure mechanism.

An Alternative Implementation AE includes the compression garment aspects of any one of Alternative Implementations A to AD and further includes that at least one of the skin contacting layer and the second layer includes one or more sublayers and the coupling of the skin contacting layer and the second layer includes joining all sublayers of the skin contacting layer and the second layer.

An Alternative Implementation AF includes the compression garment aspects of any one of Alternative Implementations A to AE and further includes that at least one of the skin contacting layer and second layer includes a textile layer laminated to a thermoplastic polyurethane film sublayer.

An Alternative Implementation AG includes the compression garment aspects of any one of Alternative Implementations A to AF and further includes that at least some of the one or more macro-chambers or the plurality of micro-chambers are connected via passive valves to control the sequencing of air pressurization of the macro-chambers and micro-chambers.

An Alternative Implementation AH includes the compression garment aspects of Alternative Implementation AG and further includes that the passive valves cause a difference in impedance of one or more openings at the border of adjacent pairs of macro-chambers, micro-chambers or micro-cells.

An Alternative Implementation AI includes the compression garment aspects of any one of Alternative Implementations A to AH and further includes that the passive valves include openings of different dimensions at different locations between adjacent chambers.

An Alternative Implementation AJ includes the compression garment aspects of any one of Alternative Implementations AG to AI and further includes that the one or more macro-chambers comprise a plurality of interconnected macro-chambers. Each of the plurality of macro-chambers includes a plurality of interconnected micro-chambers. A single connector provides pressurized air to one of the plurality of macro-chambers such that the pressurized air further flows, sequentially or in parallel, to others of the plurality of macro-chambers and to the plurality of interconnected micro-chambers.

An Alternative Implementation AK includes the compression garment aspects of any one of Alternative Implementations A to AJ and further includes that at least some openings between adjacent micro-chambers, between adjacent macro-chambers, or between adjacent microcells, are smaller in a direction from the distal to the proximal end of the limb to provide, during use, a fast compression at the garment portions at the distal end of a limb and slower compression of the garment portions at the proximal end of the limb.

An Alternative Implementation AL includes the compression garment aspects of any one of Alternative Implementations A to AK and further includes that the openings between adjacent micro-chambers, between adjacent macro-chambers, or between adjacent micro-cells, are progressively smaller in a direction from the distal to the proximal end of the limb.

An Alternative Implementation AM includes the compression garment aspects of any one of Alternative Implementations A to AL and further includes that the one or more macro-chambers and/or the plurality of micro-chambers within at least one of the one or more macro-chambers, are pressurized in a predetermined sequence.

An Alternative Implementation AN includes the compression garment aspects of any one of Alternative Implementations A to AM and further includes that the skin contacting layer is more flexible than the second layer.

An Alternative Implementation AO includes the compression garment aspects of any one of Alternative Implementations A to AN and further includes that the plurality of micro-chambers have a pre-inflation expansion volume. In response to inflation of the plurality of micro-chambers, the plurality of micro-chambers expand away from the second layer and into finger-like shapes arranged to contact the skin of the user.

According to certain aspects of the present disclosure, an Alternative Implementation BA is a method of fabricating a compression garment for circulatory-related disorder therapy. The method includes forming a fabric first layer having a first geometric shape generally defining at least a portion of the overall shape of the compression garment. A skin contacting layer is formed having a second geometric shape generally conformable to the first geometric shape. The skin contacting layer is welded to the fabric first layer according to a connection profile. The connection profile defines a plurality of macro-chambers between the skin contacting layer and the fabric first layer and a plurality of interconnected micro-chambers within one or more of the plurality of macro-chambers. A plurality of connectors is disposed in the fabric first layer. Each of the plurality of connectors allows pressurized air to be supplied directly into one or more micro-chambers of a respective one of the plurality of macro-chambers.

An Alternative Implementation BB includes the method of fabricating a compression garment aspects of Alternative Implementation BA and further includes that the skin contacting layer and the second layer are welded to form one or more independent generally toroidal macro-chambers. Each macro-chamber is partitioned into a plurality of independent generally toroidal micro-chambers. The one or more macro-chambers and/or the plurality of micro-chambers are elongated and arranged such that in an operational configuration of the compression garment around a limb of a user, at least one of the one or more macro-chambers and/or at least one of the plurality of micro-chambers form, individually or in combination, a generally toroidal shape.

An Alternative Implementation BC includes the method of fabricating the compression garment aspects of Alternative Implementations BA or BB and further includes that the connectors allow the pressurized air to be supplied simultaneous to a plurality of micro-cells within at least one of the plurality of micro-chambers.

An Alternative Implementation BD includes the method of fabricating the compression garment aspects of Alternative Implementations BA to BC and further includes that least some of the plurality of micro-chambers are adjacent to each other and interlinked such that air can be transferred from one micro-chamber to an adjacent micro-chamber via a plurality of openings.

An Alternative Implementation BE includes the method of fabricating the compression garment aspects of Alternative Implementations BA to BD and further includes that the plurality of micro-chambers within each macro-chamber are interlinked to allow pressurized air provided to at least one of the micro-chambers to flow to others of the plurality of micro-chambers within a macro-chamber.

An Alternative Implementation BF includes the method of fabricating the compression garment aspects of Alternative Implementations BA to BE and further includes that the welding of the skin contacting layer to the fabric first layer comprises welding a series of discontinuous welds perpendicular to two adjacent boundaries of one or more of the plurality of micro-chambers, the series of discontinuous welds subdividing the micro-chambers into a plurality of micro-cells.

An Alternative Implementation BG includes the method of fabricating the compression garment aspects of Alternative Implementations BA to BF and further includes that the forming of the skin contacting layer and the welding of the skin contacting layer to the fabric first layer comprises creating the plurality of micro-chambers to have a pre-inflation expansion volume. In response to inflation of the plurality of micro-chambers, the plurality of micro-chambers expand away from the fabric first layer and into finger-like shapes arranged to contact the skin of the user.

According to certain aspects of the present disclosure, an Alternative Implementation CA is a valve arrangement for a compression garment. The compression garment including a plurality of independent air chambers connectable to a pressure generator for implementing circulatory-related disorder therapy. The valve arrangement comprises a plurality of valves configured to be pneumatically and electrically connected to the compression pressure generator. Each valve is connectable to one of the plurality of independent air chambers and is in a fluid connection with a primary connecting line to allow pressurization of each of the plurality of independent air chambers. Each of the plurality of valves are located on the compression garment.

According to certain aspects of the present disclosure, an Alternative Implementation DA is a pneumatic spine for a compression garment. The compression garment includes a plurality of independent air chambers connectable to a pressure generator for implementing circulatory-related disorder therapy. The pneumatic spine comprises the valve arrangement of Alternative Implementation CA where the plurality of valves are located in proximity to each other. A cover assembly with an interior space includes the plurality of valves.

An Alternative Implementation DB includes the pneumatic spine aspects of Alternative Implementation DA and further includes a bottom layer for supporting the plurality of valves.

An Alternative Implementation DC includes the pneumatic spine aspects of Alternative Implementation DB and further includes that the cover assembly is sealingly mounted to the bottom layer to define a housing.

An Alternative Implementation DD includes the pneumatic spine aspects of Alternative Implementation DC and further includes a primary connecting line and one or more secondary connecting lines. Each secondary line pneumatically links a corresponding one of the plurality of valves to the primary line to allow independent pressurization of each of the independent air chambers.

An Alternative Implementation DE includes the pneumatic spine aspects of Alternative Implementation DD and further includes an opening in the housing to allow a portion of the primary connecting line to penetrate the housing and extend out of the interior space. The opening is sealed about the primary connecting line.

An Alternative Implementation DF includes the pneumatic spine aspects of Alternative Implementation DE and further includes that the housing and the sealed opening provide a water tight seal to prevent water from entering the interior space.

An Alternative Implementation DG includes the pneumatic spine aspects of any one of Alternative Implementations DA to DF and further includes a link to an exhaust valve, or an exhaust valve configured to selectively fluidly connect each of the plurality of independent air chambers to ambient pressure to allow independent depressurisation of each of the plurality of independent air chambers.

An Alternative Implementation DH includes the pneumatic spine aspects of any one of Alternative Implementations DB to DG and further includes that the bottom layer and cover assembly have an elongated configuration.

An Alternative Implementation DI includes the pneumatic spine aspects of any one of Alternative Implementations DA to DH and further includes that the plurality of valves is configured to be operated by a controller for selectively directing pressurized air from the primary connecting line to respective air chambers of the compression garment.

An Alternative Implementation DJ includes the pneumatic spine aspects of any one of Alternative Implementations DA to DI and further includes that the plurality of valves is configured to be operated by the controller to cycle pressurization of the plurality of air chambers between at least two different pressure levels to provide a massage to a user wearing the compression garment on a body part.

An Alternative Implementation DK includes the pneumatic spine aspects of any one of Alternative Implementations DA to DJ and further includes that the pneumatic spine is about cm to about 30 cm long and about 8 cm to 10 cm wide.

An Alternative Implementation DL includes the pneumatic spine aspects of any one of Alternative Implementations DA to DK and further includes that the plurality of valves are spaced about 2 cm to about 3 cm apart.

According to certain aspects of the present disclosure, an Alternative Implementation EA is the valve arrangement of Alternative Implementation CA and further includes that the plurality of valves is arranged in at least two groups of valves disposed on the compression garment. At least some of the plurality of valves are disposed at a first area on the compression garment and at least one of the plurality of valves is disposed at a second area that is different from the first area.

An Alternative Implementation FA includes a compression garment including the valve arrangement of any one of Alternative Implementations DA to EA.

According to certain aspects of the present disclosure, an Alternative Implementation GA is a compression garment for circulatory-related disorder therapy. The compression garment includes a skin contacting layer. A second layer is coupled to the skin contacting layer such that the skin contacting layer and the second layer form one or more independent generally toroidal macro-chambers. Each macro-chamber is partitioned into a plurality of generally toroidal micro-chambers. Each of the plurality of micro-chambers is in direct fluid communication with at least one other of the plurality of micro-chambers. One or more connectors are disposed on the second layer. Each of the one or more connectors is configured to supply pressurized air directly into a corresponding one of the one or more macro-chambers such that the pressurized air is delivered to the plurality of micro-chambers. The coupling of the skin contacting layer and the second layer includes a weld profile that defines the one or more macro-chambers and the plurality of micro-chambers.

An Alternative Implementation GB includes the compression garment aspects of Alternative Implementation GA and further includes that a plurality of the one or more macro-chambers are disposed adjacent to each other and separated by respective welds. Each of the plurality of one or more macro-chambers form a row of the compression garment.

An Alternative Implementation GC includes the compression garment aspects of any one of Alternative Implementations GA or GB and further includes that the compression garment comprises one of the one or more independent macro-chambers having at least three rows of fluidly connected micro-chambers.

An Alternative Implementation GD includes the compression garment aspects of any one of Alternative Implementations GA to GC and further includes that each of the one or more macro-chambers has a length, a width, and an uninflated thickness. The length is between about 100 millimeters and about 900 millimeters, the width is between about 70 millimeters and about 150 millimeters, and the uninflated thickness is between about 1 millimeter and about 20 millimeters.

An Alternative Implementation GE includes the compression garment aspects of any one of Alternative Implementations GA to GD and further includes that the compression garment is configured for therapy treatment for a human limb. The weld profile includes perimeter welds about the perimeters of the skin contacting layer and the second layer. A plurality of transverse welds is aligned with the circumference of the limb during operational use of the compression garment. The transverse welds define boundaries of the one or more macro-chambers and further define the boundaries between the plurality of micro-chambers.

An Alternative Implementation GF includes the compression garment aspects of any one of Alternative Implementations GA to GE and further includes that at least some of the transverse welds defining the micro-chambers are discontinuous.

An Alternative Implementation GF includes the compression garment aspects of any one of Alternative Implementations GA to GE and further includes that one or more of the plurality of micro-chambers are subdivided by a series of discontinuous longitudinal welds between transverse welds defining a micro-chamber boundary. The series of discontinuous longitudinal welds define micro-cells within the micro-chamber. The micro-cells control air flow within the one or more of the plurality of micro-chambers.

An Alternative Implementation GG includes the compression garment aspects of any one of Alternative Implementations GA to GF and further includes that the plurality of micro-chambers is welded to include an expansion volume such that the skin contacting layer expands away from the second layer and toward a patient's skin during inflation of the compression garment.

An Alternative Implementation GH includes the compression garment aspects of any one of Alternative Implementations GA to GG and further includes an outer layer disposed on the second layer. The outer layer is a generally flat surface.

An Alternative Implementation GI includes the compression garment aspects of any one of Alternative Implementations GA to GH and further includes that the thickness of the compression garment is of a low-profile with an uninflated outer layer to a skin contacting layer thickness of less than about 12 mm and an inflated outer layer to skin contacting layer thickness of about less than about 25 mm.

An Alternative Implementation GJ includes the compression garment aspects of any one of Alternative Implementations GA to GI and further includes a pneumatic spine comprising one or more valves. Each of the one or more valves is pneumatically connected to a corresponding one of the one or more connectors.

An Alternative Implementation GK includes the compression garment aspects of Alternative Implementation GJ and further includes that the pneumatic spine is disposed underneath the outer layer and extends from approximately a knee location to a thigh location of the compression garment as worn by a user.

An Alternative Implementation GL includes the compression garment aspects of any one of Alternative Implementations GJ or GK and further includes that the pneumatic spine comprises a primary connecting line connected to one or more secondary connecting lines that are each coupled to a corresponding one of the one or more valves to allow independent pressurization of each of the one or more macro-chambers.

An Alternative Implementation GM includes the compression garment aspects of any one of Alternative Implementations GJ to GL and further includes that the pneumatic spine further comprises an exhaust valve configured to selectively fluidly connect the one or more macro-chambers to ambient pressure to allow independent depressurisation of each of the one or more macro-chamber.

An Alternative Implementation GN includes the compression garment aspects of any one of Alternative Implementations GA to GM and further includes a controller configured to cycle the pressurization of the one or more macro-chambers between at least two different pressure levels to provide a massage to a user wearing the compression garment on a body part of the user.

An Alternative Implementation GO includes the compression garment aspects of any one of Alternative Implementations GA to GN and further includes that the one or more valves are configured to selectively direct pressurized air received from the primary connecting line to respective ones of the one or more macro-chambers.

An Alternative Implementation GP includes the compression garment aspects of any one of Alternative Implementations GN or GO and further includes that the controller is further configured to selectively control operation of a plurality of the one or more valves to correspond to a plurality of the one or more macro-chambers in different zones of the compression garment.

An Alternative Implementation GQ includes the compression garment aspects of any one of Alternative Implementations GA to GP and further includes that the compression garment is an integral one-piece garment configured to extend from the foot to the thigh.

An Alternative Implementation GR includes the compression garment aspects of any one of Alternative Implementations GA to GQ and further includes that the compression garment is configured for both a human leg and foot. The compression garment is a multiple-piece system for different sections of the leg and foot.

An Alternative Implementation GS includes the compression garment aspects of any one of Alternative Implementations GA to GR and further includes that one section of the compression garment includes a sole piece.

An Alternative Implementation GT includes the compression garment aspects of any one of Alternative Implementations GA to GS and further includes that the compression garment comprises a leg garment and a foot garment welded to the leg garment.

An Alternative Implementation GU includes the compression garment aspects of any one of Alternative Implementations GA to GT and further includes that compression garment comprises a leg garment and a foot garment. The foot garment includes a separate macro-chamber with a plurality of micro-chambers.

An Alternative Implementation GV includes the compression garment aspects of any one of Alternative Implementations GJ to GU and further includes that the pneumatic spine is disposed within a waterproof capsule.

An Alternative Implementation GW includes the compression garment aspects of any one of Alternative Implementations GJ to GV and further includes that the pneumatic spine is accessible from underneath the outer layer via a waterproof closure mechanism.

An Alternative Implementation GX includes the compression garment aspects of any one of Alternative Implementations GA to GW and further includes that at least one of the skin contacting layer and the second layer includes one or more sublayers.

An Alternative Implementation GY includes the compression garment aspects of any one of Alternative Implementations GA to GX and further includes that the coupling of the skin contacting layer and the second layer includes joining all layers of the skin contacting layer and the second layer.

An Alternative Implementation GZ includes the compression garment aspects of any one of Alternative Implementations GA to GY and further includes that at least one of the skin contacting layer and second layer includes a textile layer laminated to a thermoplastic polyurethane film sublayer.

According to certain aspects of the present disclosure, an Alternative Implementation HA is a method of fabricating a compression garment for circulatory-related disorder therapy. The method includes forming a fabric first layer having a first geometric shape generally defining the overall shape of the compression garment. A skin contacting layer is formed having a second geometric shape conformable to the first geometric shape. The skin contacting layer is welded to the fabric first layer according to a weld profile. The weld profile defines a plurality of independent generally toroidal macro-chambers between the skin contacting layer and the fabric first layer and a plurality of interconnected generally toroidal micro-chambers within one or more of the plurality of macro-chambers. A plurality of connectors is disposed in the fabric first layer. The plurality of connectors allows pressurized air to be supplied directly into the plurality of macro-chambers including the plurality of interconnected micro-chambers.

An Alternative Implementation HB includes the method of fabricating a compression garment aspects of Alternative Implementation HA and further includes that the welding of the skin contacting layer to the fabric first layer comprises welding a series of discontinuous welds perpendicular to two adjacent boundaries of one or more of the plurality of micro-chambers. The series of discontinuous welds subdivides the micro-chambers into a plurality of micro-cells.

An Alternative Implementation HC includes the method of fabricating a compression garment aspects of any one of Alternative Implementations HA or HB and further includes that the forming of the skin contacting layer and the welding of the skin contacting layer to the fabric first layer comprises creating the plurality of micro-chambers to have a pre-inflation expansion volume with a generally toroidal cross-sectional shape. The plurality of micro-chambers are configured to expand away from the fabric first layer during pressurization of the expansion volume.

According to certain aspects of the present disclosure, an Alternative Implementation IA is a pneumatic spine for a compression garment having a plurality of independent air chambers for implementing circulatory-related disorder therapy. The pneumatic spine includes a bottom layer. A plurality of valves is mounted to the bottom layer. Each valve is connectable to one of the plurality of independent air chambers. A primary connecting line is in fluid connection with one or more secondary connecting lines that are each coupled to one of the plurality of valves to allow independent pressurization of each of the independent air chambers. A cover assembly is sealingly mounted to the bottom layer to define a housing with an interior space that includes the plurality of valves, the one or more secondary lines, and a first portion of the primary connecting line. An opening in the housing allows a second portion of the primary connecting line to penetrate the housing and extend out of the interior space. The opening is sealed about the second portion of the primary connecting line. The housing and sealed opening provide a water tight seal to prevent water from entering the interior space.

An Alternative Implementation TB includes the pneumatic spine aspects of Alternative Implementation IA and further includes an exhaust valve configured to selectively fluidly connect the plurality of independent air chambers to ambient pressure to allow independent depressurisation of each of the plurality of independent air chambers.

An Alternative Implementation IC includes the pneumatic spine aspects of any one of Alternative Implementations IA or IB and further includes that the bottom layer and cover assembly have an elongated configuration.

An Alternative Implementation ID includes the pneumatic spine aspects of any one of Alternative Implementations IA to IC and further includes that the plurality of valves is configured to be operated by a controller for selectively directing pressurized air from the primary connecting line to respective air chambers of the compression garment.

An Alternative Implementation IE includes the pneumatic spine aspects of any one of Alternative Implementations IA to ID and further includes that the plurality of valves is further configured to be operated by the controller to cycle pressurization of the plurality of air chambers between at least two different pressure levels to provide a massage to a user wearing the compression garment on a body part.

### 7. GLOSSARY

For the purposes of the present disclosure, in certain forms of the present technology, one or more of the following definitions may apply. In other forms of the present disclosure, alternative definitions may apply.

7.1 Aspects of CPG Devices

Blower or flow generator: a device that produces a flow of air at a pressure above ambient pressure. Such a device may be reversed (e.g., by reversing a motor direction) to draw (evacuate) a flow of air at a negative pressure below ambient pressure.

Controller: a device or portion of a device that adjusts an output based on an input. For example, one form of controller has a variable that is under control—the control variable—that constitutes the input to the device. The output of the device is a function of the current value of the control variable, and a set point for the variable. A CPG device (e.g., CPG device 1002) may include a controller that has pressure as an input, a target pressure as the set point, a level of pressure as an output, or any combination thereof. Another form of input may be a flow rate from a flow rate sensor. The set point of the controller may be one or more of fixed, variable or learned. A pressure controller may be configured to control a blower or pump to deliver air at a particular pressure. A valve controller may be configured to open or close one or more valves selectively according to a programmed protocol such as in response to a measure such as time and/or any of the signals provided by one or more sensors. A controller may include or be one or more microcontrollers, one or more microprocessors, one or more processors, or any combination thereof.

Therapy: therapy in the present context may be one or more of compression therapy, such as static compression therapy, sequential compression therapy, including massage therapy, as well as the therapies described in more detail herein, or any combination thereof.

Motor: a device for converting electrical energy into rotary movement of a member. In the present context the rotating member can include an impeller, which rotates in place around a fixed axis so as to impart a pressure increase or decrease to air moving along the axis of rotation.

Transducers: a device for converting one form of energy or signal into another. A transducer may be a sensor or detector for converting mechanical energy (such as movement) into an electrical signal. Examples of transducers include pressure sensors, flow rate sensors, and temperature sensors.

Volute: the casing of the centrifugal pump that directs the air being pumped by the impeller, such as slowing down the flow rate of air and increasing the pressure. The cross-section of the volute increases in area towards the discharge port.

7.2 CPG Device Parameters

Flow rate: the instantaneous volume (or mass) of air delivered or drawn per unit time. In some cases, a reference to flow rate will be a reference to a scalar quantity, namely a quantity having magnitude only. In other cases, a reference to flow rate will be a reference to a vector quantity, namely a quantity having both magnitude and direction (e.g., out of the CPG device or into the CPG device). Flow rate is given the symbol Q.

Pressure: force per unit area. Pressure may be measured in a range of units, including cmH₂O, g-f/cm², and hectopascals. One (1) cmH₂O is equal to 1 g-f/cm² and is approximately hectopascal. In this specification, unless otherwise stated, pressure is given in units of cmH₂O.

### 8. OTHER REMARKS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being preferably used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated by reference to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular embodiments, it is to be understood that these embodiments are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative embodiments and that other arrangements may be devised without departing from the spirit and scope of the technology.

1. A compression garment for circulatory-related disorder therapy, the compression garment comprising:
a skin contacting layer;
a second layer coupled to the skin contacting layer such that the skin contacting layer and the second layer form one or more macro-chambers, each macro-chamber being partitioned into a plurality of micro-chambers, each of the plurality of micro-chambers being in direct fluid communication with at least one other of the plurality of micro-chambers; and
one or more connectors disposed on the second layer, each of the one or more connectors configured to supply pressurized air directly into at least a corresponding one of the one or more macro-chambers such that the pressurized air is delivered to at least one of the plurality of micro-chambers within the macro chamber,
wherein the coupling of the skin contacting layer and the second layer is along a layer attachment profile that defines the one or more macro-chambers and the plurality of micro-chambers, and
wherein at least one of the plurality of micro-chambers is directly linked to each of a plurality of adjacent micro-chambers by way of a plurality of openings.

2. The compression garment of claim 1, wherein the skin contacting layer and the second layer form one or more independent macro-chambers.

3. The compression garment of claim 1,
wherein at least one macro-chamber is generally toroidal and is partitioned into a plurality of generally toroidal micro-chambers, and
wherein one or more of the generally toroidal micro-chambers are elongated and arranged such that in an operational configuration of the compression garment around a limb of a user the one or more plurality of micro-chambers extend generally transverse to the limb so as to form a generally toroidal shape.

4. The compression garment of claim 1, wherein at least one of the micro-chambers comprises a plurality of micro-cells.

5-10. (canceled)

11. The compression garment of claim 1, wherein the compression garment is configured for therapy treatment for a human limb, the layer attachment profile including:
perimeter welds about the perimeters of the skin contacting layer and the second layer, and
a plurality of welds aligned with the circumference of the limb during operational use of the compression garment, the welds defining boundaries of the one or more macro-chambers and further defining the boundaries between the plurality of micro-chambers.

12. (canceled)

13. The compression garment of claim 11, wherein one or more of the plurality of micro-chambers are subdivided by a series of discontinuous welds defining micro-cells within the micro-chamber, the micro-cells controlling air flow within respective ones of the one or more of the plurality of micro-chambers.

14-35. (canceled)

36. The compression garment of claim 1,
wherein at least some of the one or more macro-chambers or the plurality of micro-chambers are connected via passive valves to control the sequencing of air pressurization of the macro-chambers and micro-chambers,
wherein the one or more macro-chambers includes a plurality of interconnected macro-chambers, each of the plurality of macro-chambers including a plurality of interconnected micro-chambers, and
wherein a single connector provides pressurized air to one of the plurality of macro-chambers such that the pressurized air further flows, sequentially or in parallel, to others of the plurality of macro-chambers and to the plurality of interconnected micro-chambers.

37. The compression garment of claim 1, wherein at least some openings between adjacent micro-chambers, between adjacent macro-chambers, or between adjacent microcells, are smaller in a direction from the distal to the proximal end of the limb to provide, during use, a fast compression at the garment portions at the distal end of a limb and slower compression of the garment portions at the proximal end of the limb.

38. The compression garment of claim 1, wherein the openings between adjacent micro-chambers, between adjacent macro-chambers, or between adjacent micro-cells, are progressively smaller in a direction from the distal to the proximal end of the limb.

39-41. (canceled)

42. A method of fabricating a compression garment for circulatory-related disorder therapy, the method comprising:
forming a fabric first layer having a first geometric shape generally defining at least a portion of the overall shape of the compression garment;
forming a skin contacting layer having a second geometric shape generally conformable to the first geometric shape;
welding the skin contacting layer to the fabric first layer according to a connection profile, the connection profile defining a plurality of macro-chambers between the skin contacting layer and the fabric first layer and a plurality of interconnected micro-chambers within one or more of the plurality of macro-chambers; and
disposing a plurality of connectors in the fabric first layer, each of the plurality of connectors allowing pressurized air to be supplied directly into one or more micro-chambers of a respective one of the plurality of macro-chambers.

43. The method of claim 42,
wherein the skin contacting layer and the second layer are welded to form one or more independent generally toroidal macro-chambers, each macro-chamber being partitioned into a plurality of independent generally toroidal micro-chambers, and
wherein the one or more macro-chambers and/or the plurality of micro-chambers are elongated and arranged such that in an operational configuration of the compression garment around a limb of a user, at least one of the one or more macro-chambers and/or at least one of the plurality of micro-chambers form, individually or in combination, a generally toroidal shape.

44. The method of claim 42, wherein the connectors allow the pressurized air to be supplied simultaneous to a plurality of micro-cells within at least one of the plurality of micro-chambers.

45. The method of claim 42, wherein at least some of the plurality of micro-chambers are adjacent to each other and interlinked such that air can be directly transferred from at least one of the plurality of micro-chambers to each of a plurality of adjacent micro-chambers via a plurality of openings.

46-48. (canceled)

49. A pneumatic spine for a compression garment, the garment including a plurality of independent air chambers connectable to a pressure generator for implementing circulatory-related disorder therapy, the pneumatic spine comprising:
a valve arrangement including a plurality of valves configured to be pneumatically and electrically connected to the compression pressure generator, each valve connectable to one of the plurality of independent air chambers and configured to be in a fluid connection with a primary connecting line to allow pressurization of each of the plurality of independent air chambers; and
a cover assembly with an interior space that includes the plurality of valves,
wherein each of the plurality of valves are configured to be positioned on the compression garment in proximity to each other.

50-52. (canceled)

53. The pneumatic spine of claim 49, further comprising;
a bottom layer for supporting a plurality of valves, wherein the cover assembly is sealingly mounted to the bottom layer to define a housing;
a primary connecting line; and
one or more secondary connecting lines, each secondary line pneumatically linking a corresponding one of the plurality of valves to the primary line, thereby allowing independent pressurization of each of the independent air chambers.

54. The pneumatic spine of claim 53, further comprising an opening in the housing allowing a portion of the primary connecting line to penetrate the housing and extend out of the interior space, the opening being sealed about the primary connecting line, and the housing and the sealed opening providing a water tight seal to prevent water from entering the interior space.

55-59. (canceled)

60. The pneumatic spine of claim 49, wherein the pneumatic spine is about 20 cm to about 30 cm long and about 8 cm to 10 cm wide.

61. The pneumatic spine of claim 49, wherein the plurality of valves are spaced about 2 cm to about 3 cm apart.

62. The pneumatic spine of claim 49, wherein the plurality of valves is arranged in at least two groups of valves disposed on the compression garment such that at least some of the plurality of valves are disposed at a first area on the compression garment and at least one of the plurality of valves is disposed at a second area that is different from the first area.

63. (canceled)

64. The compression garment of claim 1, wherein the pressurized air is delivered substantially simultaneously to the plurality of micro-cells.
